(19) United States
(12) Patent Application Publication
(10) Pub. No.: US 2023/0345258 A1
(43) Pub. Date: Oct. 26, 2023

(54) SOFTWARE TOOLS FOR FACILITATING DEPLOYMENT OF MESH-BASED COMMUNICATION SYSTEMS

(71) Applicant: L3VEL, LLC, Wilmington, DE (US)

(72) Inventors: Bryce Barrand, Lehi, UT (US); Chris O'Toole, Chattanooga, TN (US); Clinton Andrews, Norcross, GA (US); Julius Zaromskis, Kaunas (LT); Brianna Carver, Pikeville, NC (US); Chad Dewey, Omaha, NE (US); Hal Bledsoe, Miramar Beach, FL (US); Muhammad Ahsan Naim, Irving, TX (US)

(21) Appl. No.: 18/303,895

(22) Filed: Apr. 20, 2023

Related U.S. Application Data
(60) Provisional application No. 63/333,051, filed on Apr. 20, 2022.

(51) Int. Cl. H04W 16/18

(52) U.S. Cl. CPC H04W 16/18; H04W 84/18

(57) ABSTRACT

A computing platform is configured to: (i) receive input data identifying (a) planned infrastructure sites at which to install wireless communication nodes for a wireless mesh network, wherein each planned infrastructure site is associated with a respective wireless communication node to be installed at the planned infrastructure site and (b) planned interconnections between the planned infrastructure sites that specify a manner in which the wireless communication nodes of the planned infrastructure sites are to be interconnected together via wireless links; (ii) receive template data for defining a deployment plan for wireless communication nodes and wireless communication links; and (iii) based at least on the input data and the template data, generate a deployment plan for the planned infrastructure sites that comprises, for each planned infrastructure site, a respective set of configuration data for the respective wireless communication node to be installed at the planned infrastructure site.

### CROSS-REFERENCE TO RELATED APPLICATIONS

This application claims priority to U.S. Provisional Application No. 63/333,051, filed Apr. 20, 2022 and entitled “SOFTWARE TOOLS FOR FACILITATING DEPLOYMENT OF MESH-BASED COMMUNICATION SYSTEMS,” the contents of which are incorporated herein by reference in their entirety.

### BACKGROUND

In today's world, the demand for network-based services that are delivered to end users in a fast and reliable way continues to grow. This includes the demand for high-speed internet service that is capable of delivering upload and download speeds of several hundreds of Megabits per second (Mbps) or perhaps even 1 Gigabit per second (Gbps) or more.

### OVERVIEW

Disclosed herein are example architectures for communication systems that are based on fixed wireless mesh networks and are configured to provide any of various types of services to end users, including but not limited to telecommunication services such as high-speed internet that has speeds of several Gigabits per second (Gbps) or more. At times, these communication systems are referred to herein as “mesh-based communication systems.”

The task of deploying a mesh-based communication system such as this may present a number of challenges. For example, once a plan for the mesh-based communication system has been created, technicians must go on site and install the wireless communication nodes at the infrastructure sites. For each such wireless communication node, this involves installing all of the necessary equipment at the node's infrastructure site, including the node's wireless radios, each of which will need to be physically positioned and aligned in way that will ensure that the wireless radio is pointed in a desired direction and has sufficient line-of-site (LOS) to other desired wireless radios in the mesh-based communication system. Additionally, along with physically installing all of the necessary equipment at the node's infrastructure site, a technician typically needs to configure certain pieces of equipment at the site, including wireless mesh equipment, the networking equipment, and/or the power equipment. These tasks associated with deploying the wireless communication nodes of a mesh-based communication system can be time consuming and labor intensive.

Disclosed herein are various software tools that help to facilitate the task of deploying a mesh-based communication system. In accordance with the present disclosure, the software tools for facilitating deployment of a mesh-based communication system may include any one of (i) a first software tool for generating configuration data for a communication node, (ii) a second software tool for provisioning communication node with configuration data, (iii) a third software tool for guiding installation of a communication node, (iv) a fourth software tool for determining direction of ptmp radio, and (v) a fifth software tool for determining channel of wireless links.

The foregoing has outlined rather broadly the features and technical advantages of examples according to this disclosure so that the following detailed description may be better understood. Additional features and advantages will be described below. It should be understood that the specific examples disclosed herein may be readily utilized as a basis for modifying or designing other structures for carrying out the same operations disclosed herein. Characteristics of the concepts disclosed herein including their organization and method of operation together with associated advantages will be better understood from the following description when considered in connection with the accompanying figures. It should be understood that the figures are provided for the purpose of illustration and description only.

In one aspect, disclosed herein is a method that involves a computing platform: (i) receiving input data identifying (a) planned infrastructure sites at which to install wireless communication nodes for a wireless mesh network, wherein each planned infrastructure site is associated with a respective wireless communication node to be installed at the planned infrastructure site and (b) planned interconnections between the planned infrastructure sites that specify a manner in which the wireless communication nodes of the planned infrastructure sites are to be interconnected together via wireless links; (ii) receiving template data for defining a deployment plan for wireless communication nodes and wireless communication links; and (iii) based at least on the input data and the template data, generating a deployment plan for the planned infrastructure sites that comprises, for each planned infrastructure site, a respective set of configuration data for the respective wireless communication node to be installed at the planned infrastructure site.

In an example, the method further comprises, prior to generating the deployment plan for the planned infrastructure sites, performing one or more validation tests to verify that the input data complies with one or more constraints for the wireless mesh network.

In an example, the one or more constraints for the wireless mesh network comprises a maximum number of wireless links allowed at a given wireless communication node and performing one or more validation tests to verify that the input data complies with one or more constraints for the wireless mesh network comprises identifying one or more infrastructure sites that exceed the constrained maximum number. Further, the method further comprises: (i) for each of the identified one or more infrastructure sites, removing one or more of the infrastructure site's planned interconnections; and (ii) adding or reconfiguring one or more other planned interconnections between other infrastructure sites to compensate for the removed infrastructure sites' planned interconnections.

In an example, based at least on the input data and the template data, generating a deployment plan for the planned infrastructure sites that comprises, for each planned infrastructure site, a respective set of configuration data for the respective wireless communication node to be installed at the planned infrastructure site comprises: for each planned infrastructure site, (i) identifying a role within the mesh-based communication system of the respective wireless communication node to be installed at the planned infrastructure site and (ii) generating configuration data identifying at least one of (a) a type of wireless mesh equipment for supporting the identified role, (b) a type of networking equipment for supporting the identified role, and (c) a type of power equipment for supporting the identified role.

In an example, based at least on the input data and the template data, generating a deployment plan for the planned infrastructure sites that comprises, for each planned infrastructure site, a respective set of configuration data for the respective wireless communication node to be installed at the planned infrastructure site comprises: for each planned infrastructure site, (i) identifying pieces of equipment of the respective wireless communication node to be installed at the planned infrastructure site, (ii) determining a set of connections that are to be established between the identified pieces of equipment, wherein each connection of the set of connections is associated with a pair of the identified equipment pieces, (iii) determining available communication interfaces of the identified pieces of equipment, and (iv) for each connection in the set of connections, assigning to the connection a respective available communication interface on each piece of equipment of the pair of equipment pieces associated with the connection.

In an example, the method further comprises: (i) receiving, via an out-of-band communication path, an identifier associated with one of the respective wireless communication nodes; (ii) determining a set of configuration data from among the sets of configuration data that corresponds to the identifier; and (iii) sending, via the out-of-band communication path, the determined set of configuration data to the respective wireless communication node.

In an example, the out-of-band communication path comprises (i) a local communication link between equipment of the respective wireless communication node and a network-enabled device at the planned infrastructure site associated with the respective wireless communication node and (ii) a communication link between the network-enabled device and the computing platform.

In an example, the respective set of configuration data for the respective wireless communication node to be installed at the planned infrastructure site comprises one or more of the following: (i) configuration data identifying quantity and type of equipment at the respective wireless communication node, (ii) configuration data specifying how equipment at the respective wireless communication node is to be interconnected together, and (iii) configuration data for operating as part of a given wireless mesh network.

In an example, the respective set of configuration data for the respective wireless communication node to be installed at the planned infrastructure site comprises configuration data for operating as part of a given wireless mesh network, and wherein the configuration data for operating as part of the given wireless mesh network comprises (i) node-level data for the respective wireless communication node that applies to the entire respective wireless communication node and (ii) link-level data that applies to a given wireless link to be established by the respective wireless communication node.

In an example, the method further comprises, after generating the deployment plan, transmit, to a client station, a communication related to one or more of the planned infrastructure sites and thereby cause an indication of at least some of the configuration data from the respective sets of configuration data for the one or more planned infrastructure site to be presented at a user interface of the client station.

In an example, the method further comprises, for a given respective wireless communication node, causing, based at least in part on the respective set of configuration data for the given respective wireless communication node to be installed at the planned infrastructure site, a client station associated with an installer to present guidance for installing the given respective wireless communication node at the planned infrastructure site.

In an example, the method further comprises: (i) receiving second input data identifying (a) wireless communication nodes that are to be deployed, (b) location data for infrastructure sites at which the wireless communication nodes are to be installed, and (c) wireless links that are to be established between the wireless communication nodes; (ii) based on the second input data, identifying one or more wireless communication nodes that are to include a point-to-multipoint (ptmp) radio for establishing a ptmp wireless link with one or more other downstream wireless communication nodes; and (iii) for each of the identified one or more wireless communication nodes, utilizing the location data for the identified node's infrastructure site and the location data for infrastructure sites of downstream nodes with which the identified node is to establish a ptmp wireless link in order to determine an azimuthal direction for a ptmp radio to be installed at the identified node.

In an example, the method further comprises: (i) receiving second input data identifying (a) wireless communication nodes that are to be deployed, (b) location data for infrastructure sites at which the wireless communication nodes are to be installed, and (c) wireless links that are to be established between the wireless communication nodes; and (ii) based on the second input data, for at least a subset of the wireless links, determine and assign a particular channel for each wireless link of the subset of wireless links so as to reduce channel-based interference between the wireless links of the subset of wireless link.

In another aspect, disclosed herein is a computing system that includes at least one processor, a non-transitory computer-readable medium, and program instructions stored on the non-transitory computer-readable medium that are executable by the at least one processor to cause the computing platform to carry out the functions disclosed herein, including but not limited to the functions of the foregoing method.

For instance, in an example, a computing platform comprises: a network interface; at least one processor; a non-transitory computer-readable medium; and program instructions stored on the non-transitory computer-readable medium that are executable by the at least one processor such that the computing platform is configured to: (i) receive input data identifying (a) planned infrastructure sites at which to install wireless communication nodes for a wireless mesh network, wherein each planned infrastructure site is associated with a respective wireless communication node to be installed at the planned infrastructure site and (b) planned interconnections between the planned infrastructure sites that specify a manner in which the wireless communication nodes of the planned infrastructure sites are to be interconnected together via wireless links; (ii) receive template data for defining a deployment plan for wireless communication nodes and wireless communication links; and (iii) based at least on the input data and the template data, generate a deployment plan for the planned infrastructure sites that comprises, for each planned infrastructure site, a respective set of configuration data for the respective wireless communication node to be installed at the planned infrastructure site.

In an example, the respective set of configuration data for the respective wireless communication node to be installed at the planned infrastructure site comprises one or more of the following: (i) configuration data identifying quantity and type of equipment at the respective wireless communication node, (ii) configuration data specifying how equipment at the respective wireless communication node is to be interconnected together, and (iii) configuration data for operating as part of a given wireless mesh network.

In an example, the respective set of configuration data for the respective wireless communication node to be installed at the planned infrastructure site comprises configuration data for operating as part of a given wireless mesh network, and wherein the configuration data for operating as part of the given wireless mesh network comprises (i) node-level data for the respective wireless communication node that applies to the entire respective wireless communication node and (ii) link-level data that applies to a given wireless link to be established by the respective wireless communication node.

In an example, the computing platform further comprises program instructions stored on the non-transitory computer-readable medium that are executable by the at least one processor such that the computing platform is configured to: prior to generating the deployment plan for the planned infrastructure sites, perform one or more validation tests to verify that the input data complies with one or more constraints for the wireless mesh network.

In an example, the one or more constraints for the wireless mesh network comprises a maximum number of wireless links allowed at a given wireless communication node and performing one or more validation tests to verify that the input data complies with one or more constraints for the wireless mesh network comprises identifying one or more infrastructure sites that exceed the constrained maximum number. Further, the computing platform further comprises program instructions stored on the non-transitory computer-readable medium that are executable by the at least one processor such that the computing platform is configured to: (i) for each of the identified one or more infrastructure sites, remove one or more of the infrastructure site's planned interconnections; and (ii) add or reconfigure one or more other planned interconnections between other infrastructure sites to compensate for the removed infrastructure sites' planned interconnections.

In an example, the program instructions that are executable by the at least one processor such that the computing platform is configured to, based at least on the input data and the template data, generate a deployment plan for the planned infrastructure sites that comprises, for each planned infrastructure site, a respective set of configuration data for the respective wireless communication node to be installed at the planned infrastructure site comprise program instructions that are executable by the at least one processor such that the computing platform is configured to: for each planned infrastructure site, (i) identify a role within the mesh-based communication system of the respective wireless communication node to be installed at the planned infrastructure site and (ii) generate configuration data identifying at least one of (a) a type of wireless mesh equipment for supporting the identified role, (b) a type of networking equipment for supporting the identified role, and (c) a type of power equipment for supporting the identified role.

In an example, the program instructions that are executable by the at least one processor such that the computing platform is configured to, based at least on the input data and the template data, generate a deployment plan for the planned infrastructure sites that comprises, for each planned infrastructure site, a respective set of configuration data for the respective wireless communication node to be installed at the planned infrastructure site comprise program instructions that are executable by the at least one processor such that the computing platform is configured to: for each planned infrastructure site, (i) identify pieces of equipment of the respective wireless communication node to be installed at the planned infrastructure site, (ii) determine a set of connections that are to be established between the identified pieces of equipment, wherein each connection of the set of connections is associated with a pair of the identified equipment pieces, (iii) determine available communication interfaces of the identified pieces of equipment, and (iv) for each connection in the set of connections, assign to the connection a respective available communication interface on each piece of equipment of the pair of equipment pieces associated with the connection.

In an example, the computing platform further comprises program instructions stored on the non-transitory computer-readable medium that are executable by the at least one processor such that the computing platform is configured to: after generating the deployment plan, transmit, to a client station, a communication related to one or more of the planned infrastructure sites and thereby cause an indication of at least some of the configuration data from the respective sets of configuration data for the one or more planned infrastructure site to be presented at a user interface of the client station.

In an example, the computing platform further comprises program instructions stored on the non-transitory computer-readable medium that are executable by the at least one processor such that the computing platform is configured to: (i) receive, via an out-of-band communication path, an identifier associated with one of the respective wireless communication nodes; (ii) determine a set of configuration data from among the sets of configuration data that corresponds to the identifier; and (iii) send, via the out-of-band communication path, the determined set of configuration data to the respective wireless communication node.

In an example, the out-of-band communication path comprises (i) a local communication link between equipment of the respective wireless communication node and a network-enabled device at the planned infrastructure site associated with the respective wireless communication node and (ii) a communication link between the network-enabled device and the computing platform.

In an example, the computing platform further comprises program instructions stored on the non-transitory computer-readable medium that are executable by the at least one processor such that the computing platform is configured to: for a given respective wireless communication node, causing, based at least in part on the respective set of configuration data for the given respective wireless communication node to be installed at the planned infrastructure site, a client station associated with an installer to present guidance for installing the given respective wireless communication node at the planned infrastructure site.

In an example, the computing platform further comprises program instructions stored on the non-transitory computer-readable medium that are executable by the at least one processor such that the computing platform is configured to: (i) receive second input data identifying (a) wireless communication nodes that are to be deployed, (b) location data for infrastructure sites at which the wireless communication nodes are to be installed, and (c) wireless links that are to be established between the wireless communication nodes; (ii) based on the second input data, identify one or more wireless communication nodes that are to include a point-to-multipoint (ptmp) radio for establishing a ptmp wireless link with one or more other downstream wireless communication nodes; and (iii) for each of the identified one or more wireless communication nodes, utilize the location data for the identified node's infrastructure site and the location data for infrastructure sites of downstream nodes with which the identified node is to establish a ptmp wireless link in order to determine an azimuthal direction for a ptmp radio to be installed at the identified node.

In an example, the computing platform further comprises program instructions stored on the non-transitory computer-readable medium that are executable by the at least one processor such that the computing platform is configured to: (i) receive second input data identifying (a) wireless communication nodes that are to be deployed, (b) location data for infrastructure sites at which the wireless communication nodes are to be installed, and (c) wireless links that are to be established between the wireless communication nodes; and (ii) based on the second input data, for at least a subset of the wireless links, determine and assign a particular channel for each wireless link of the subset of wireless links so as to reduce channel-based interference between the wireless links of the subset of wireless links.

In yet another aspect, disclosed herein is a non-transitory computer-readable medium comprising program instructions that are executable to cause a computing platform to carry out the functions disclosed herein, including but not limited to the functions of the foregoing method.

For instance, in an example, the non-transitory computer-readable medium is provisioned with program instructions that, when executed by at least one processor, cause a computing platform to: (i) receive input data identifying (a) planned infrastructure sites at which to install wireless communication nodes for a wireless mesh network, wherein each planned infrastructure site is associated with a respective wireless communication node to be installed at the planned infrastructure site and (b) planned interconnections between the planned infrastructure sites that specify a manner in which the wireless communication nodes of the planned infrastructure sites are to be interconnected together via wireless links; (ii) receive template data for defining a deployment plan for wireless communication nodes and wireless communication links; and (iii) based at least on the input data and the template data, generate a deployment plan for the planned infrastructure sites that comprises, for each planned infrastructure site, a respective set of configuration data for the respective wireless communication node to be installed at the planned infrastructure site.

One of ordinary skill in the art will appreciate these as well as numerous other aspects in reading the following disclosure.

### BRIEF DESCRIPTION OF THE DRAWINGS

A further understanding of the nature and advantages the present disclosure may be realized by reference to the following drawings.

FIG. 1A depicts a simplified illustrative diagram of an example portion of an example mesh-based communication system that may be designed, implemented, and deployed in accordance with aspects of the disclosed technology.

FIG. 1B depicts a simplified illustrative diagram of another example portion of an example mesh-based communication system that may be designed, implemented, and deployed in accordance with aspects of the disclosed technology.

FIG. 1C depicts a simplified illustrative diagram of yet another example portion of an example mesh-based communication system that may be designed, implemented, and deployed in accordance with aspects of the disclosed technology.

FIG. 1D depicts a simplified illustrative diagram of another example portion of an example mesh-based communication system that may be designed, implemented, and deployed in accordance with aspects of the disclosed technology.

FIG. 2A depicts an example wireless communication node of an example mesh-based communication system in accordance with aspects of the disclosed technology.

FIG. 2B depicts a block diagram of example wireless mesh equipment that may be included in the example wireless communication node of FIG. 2A in accordance with aspects of the disclosed technology.

FIG. 2C depicts a block diagram of an example network processing unit of the example wireless communication node of FIG. 2A in accordance with aspects of the disclosed technology.

FIG. 2D depicts a block diagram of example components that may be included in an example point-to-point radio of the example wireless communication node of FIG. 2A in accordance with aspects of the disclosed technology.

FIG. 2E depicts a block diagram of example components that may be included in an example point-to-multipoint radio of the example wireless communication node of FIG. 2A in accordance with aspects of the disclosed technology.

FIG. 3 depicts an example computing environment that includes a mesh-based communication system that is configured to operate in accordance with aspects of the disclosed technology.

FIG. 4 depicts an example display of a software tool for generating configuration data for the example wireless communication node of FIG. 2A in accordance with aspects of the disclosed technology.

FIG. 5 depicts another example display of a software tool for generating configuration data for the example wireless communication node of FIG. 2A in accordance with aspects of the disclosed technology.

FIG. 6A depicts an example display of a software tool for guiding installation of the example wireless communication node of FIG. 2A in accordance with aspects of the disclosed technology.

FIG. 6B depicts another example display of a software tool for guiding installation of the example wireless communication node of FIG. 2A in accordance with aspects of the disclosed technology.

FIG. 7 depicts an example graphical representation of wireless communication nodes and wireless links between such nodes in an example mesh-based communication system that may be designed, implemented, and deployed in accordance with aspects of the disclosed technology.

FIG. 8 depicts an example display of a software tool for determining the direction of a point-to-point radio of the example wireless communication node of FIG. 2A in accordance with aspects of the disclosed technology.

FIG. 9 depicts another example display of a software tool for determining the direction of a point-to-point radio of the example wireless communication node of FIG. 2A in accordance with aspects of the disclosed technology.

FIG. 10 depicts another example graphical representation of wireless communication nodes and wireless links between such nodes in an example mesh-based communication system that may be designed, implemented, and deployed in accordance with aspects of the disclosed technology.

FIG. 11 depicts a structural diagram of an example computing platform that may be configured to carry out one or more of the functions according to the disclosed software technology.

FIG. 12 depicts a structural diagram of an example end-user device that may be configured to communicate with the example computing platform of FIG. 11 and also carry out one or more functions in accordance with aspects of the disclosed technology.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawing.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. Mesh-Based Communication System Architectures

Disclosed herein are example architectures for communication systems that are based on fixed wireless mesh networks and are configured to provide any of various types of services to end users, including but not limited to telecommunication services such as high-speed internet that has speeds of several Gigabits per second (Gbps) or more. At times, these communication systems are referred to herein as “mesh-based communication systems.”

In accordance with the example architectures disclosed herein, a mesh-based communication system may comprise a plurality of wireless communication nodes that are interconnected together via bi-directional point-to-point (ptp) and/or point-to-multipoint (ptmp) wireless links in order to form a wireless mesh network, where each such wireless communication node comprises respective equipment for operating as part of the wireless mesh network (e.g., equipment for establishing and communicating over one or more bi-directional ptp and/or ptmp wireless links) that has been installed at a respective infrastructure site. Further, in at least some embodiments, the plurality of wireless communication nodes may comprise multiple different “tiers” of wireless communication nodes, where the wireless communication nodes in the different “tiers” serve different roles within the wireless mesh network, such as by performing different functionality within the wireless mesh network and/or establishing and communicating over different types of ptp and/or ptmp wireless links within the wireless mesh network, and may thus be installed with different kinds of equipment for operating as part of the wireless mesh network (e.g., different hardware and/or software).

For instance, in such a mesh-based communication system, the wireless mesh network may include (i) a first tier of wireless communication nodes (which may be referred to herein as “first-tier nodes”) that are each installed at a respective infrastructure site that serves as a Point of Presence (“PoP”) (or sometimes referred to as an access point) that has high-capacity access to a core network, (ii) a second tier of wireless communication nodes (which may be referred to herein as “second-tier nodes”) that are each installed at a respective infrastructure site and primarily serve to extend the high-capacity access to the core network from the first-tier nodes to other geographic locations by forming a high-capacity pathway (e.g., in the range of 10 Gbps) for routing aggregated network traffic that originated from or is destined to the core network, (iii) a third tier of wireless communication nodes (which may be referred to herein as “third-tier nodes”) that are each installed at a respective infrastructure site and primarily serve to form discrete sub-meshes extending from second-tier nodes that are to route aggregated network traffic to and from endpoints within a particular geographic area, and (iv) a fourth tier of wireless communication nodes (which may be referred to herein as “fourth-tier nodes”) that are each installed at a respective infrastructure site and primarily serve to extend the discrete sub-meshes formed by the second-tier and third-tier nodes to other endpoints by exchanging individual (i.e., endpoint-specific) network traffic to and from the third-tier nodes.

However, it should be understood that the tiers of wireless communication nodes could take various other forms as well, including but not limited to the possibility that a mesh-based communication system may have not have all four of the tiers described above and/or that a mesh-based communication system may have one or more other tiers of wireless communication nodes that serve other roles within the wireless mesh network. Further, it should be understood that each tier of wireless communication nodes could include any number of wireless communication nodes, including but not limited to the possibility that in some implementations, one of more of the tiers could include as little as a single wireless communication node (e.g., a wireless mesh network deployed in a sparsely-populated area), while in other implementations, one of more of the tiers could include many thousands of nodes (e.g., a wireless mesh network deployed in a densely-populated area or a wireless mesh network that spans a large geographic area).

The wireless communication nodes in each of the foregoing tiers will now be described in further detail.

Beginning with the mesh-based communication system's first tier of wireless communication nodes, in line with the discussion above, each first-tier node is installed at an infrastructure site equipped to serve as a PoP that provides high-capacity access to a core network, and may also be directly connected downstream to one or more other wireless communication nodes in another tier of the wireless mesh network via one or more bi-directional ptp or ptmp wireless links. In this respect, each first-tier node may function to (i) exchange bi-directional network traffic with the core network via a high-capacity fiber connection (e.g., dark or lit fiber) between the infrastructure site and the core network, such as a fiber link having a capacity in the range of tens or even hundreds of Gbps, and (ii) exchange bi-directional network traffic with one or more other wireless communication node in another tier of the wireless mesh network via one or more ptp or ptmp wireless links, such as one or more second-tier node that serve to extend the first-tier node's high-capacity access the core network to other geographic locations. Further, in at least some implementations, a first-tier node may function to deliver the service being provided by the mesh-based communication system (e.g., a high-speed internet service) to the first-tier node's infrastructure site, such that individuals present at the first-tier node's infrastructure site can utilize that service. A first-tier node may perform other functions as well.

The infrastructure site at which each first-tier node is installed may take any of various forms. For instance, as one possibility, a first-tier node's infrastructure site could be a commercial building that has fiber connectivity to a core network and also provides a suitable location for installation of equipment for establishing and communicating over wireless links with other wireless communication nodes (e.g., a location that has sufficient line-of-sight (LOS) to other infrastructure sites), such as a particular section of the building's rooftop or a particular spot along the side of the building. In such an implementation, in addition to exchanging bi-directional network traffic with the core network and other nodes of the wireless mesh network, the first-tier node installed at the commercial building may also function to deliver the service being provided by the mesh-based communication system (e.g., a high-speed internet service) to the commercial building such that individuals in the commercial building can make use of that service. As another possibility, a first-tier node's infrastructure site could be a support structure such as a tower (e.g., a cell tower) or a pole that has fiber connectivity to a core network and provides a suitable location for installation of equipment for operating as part of the wireless mesh network. A first-tier node's infrastructure site could take some other form as well, including but not limited to the possibility that a first-tier node's infrastructure site could be a residential building to the extent that the residential building has fiber connectivity to a core network and provides a suitable location for installation of equipment for operating as part of the wireless mesh network.

The equipment for each first-tier node may also take any of various forms. To begin, a first-tier node's equipment may include wireless mesh equipment for establishing a wireless connection with one or more second-tier nodes. For instance, a first-tier node's wireless mesh equipment may be configured to establish and communicate over either (i) a respective bi-directional ptp wireless link with each of the one or more wireless communication nodes in another tier or (ii) a bi-directional ptmp wireless link (or perhaps multiple bi-directional ptmp wireless links) with the one or more wireless communication nodes in another tier. Other implementations of a first-tier node's wireless mesh equipment are possible as well, including but not limited to the possibility that a first-tier node's wireless mesh equipment may be configured to establish and communicate with the one or more wireless communication nodes in another tier over a combination of ptp and ptmp wireless links (e.g., a ptp wireless link with one particular node and a ptmp wireless link with one or more other nodes) and/or that a first-tier node's wireless mesh equipment may additionally be configured to interface and communicate with a core network via the PoP's high-capacity fiber connection. Additionally, a first-tier node's equipment may include networking equipment (e.g., one or more modems, routers, switches, or the like) that facilitates communication between the first-tier node's wireless mesh equipment and other devices or systems located at the first-tier node's infrastructure site, and perhaps also facilitates communication between the first-tier node's wireless mesh equipment and the core network via the PoP's high-capacity fiber connection (to the extent that the such communication is not handled directly by the wireless mesh equipment). Additionally yet, a first-tier node's equipment may include power equipment for supplying power to the wireless mesh equipment and/or the networking equipment, such as power and/or battery units. A first-tier node's equipment may take various other forms as well.

A first-tier node of the wireless mesh network may take various other forms as well.

Turning to the mesh-based communication system's second tier of wireless communication nodes, as noted above, each second-tier node is installed at a respective infrastructure site and primarily serves to extend the high-capacity access to the core network from the first-tier nodes to other geographic locations by forming a high-capacity pathway (e.g., in the range of 10 Gbps) for routing aggregated network traffic that originated from or is destined to the core network. In this respect, such a high-capacity pathway extending from a first-tier node could take various forms. As one possibility, a high-capacity pathway extending from a given first-tier node could be a single-hop pathway comprising a single high-capacity wireless link that is established between the given first-tier node and one given second-tier node. As another possibility, a high-capacity pathway extending from a given first-tier node could be a multi-hop pathway comprising a chain of multiple high-capacity wireless links (which may also referred to herein as a “spine”) that includes a first high-capacity wireless link established between the given first-tier node and a first second-tier node as well as one or more additional high-capacity wireless links that are each established between a successive pair of second-tier nodes (e.g., a second high-capacity wireless link established between the first second-tier node and a second second-tier node, a third high-capacity wireless link established between the second second-tier node and a third second-tier node, and so on). Further, in some implementations, such a multi-hop pathway could be connected to one first-tier node a first end of the multi-hop pathway (e.g., via a first high-capacity wireless link between first-tier and second-tier nodes) and be connected to another first-tier node on a second end of the multi-hop pathway (e.g., via a first high-capacity wireless link between first-tier and second-tier nodes). Further yet, in some implementations, a given first-tier node's high-capacity access to the core network could be extended via multiple different high-capacity pathways formed by second-tier nodes, where each respective high-capacity pathway could either be a single-hop pathway or a multi-hop pathway.

Thus, depending on where a second-tier node is situated within such a pathway, the second-tier node could either be (i) directly connected to a first-tier node via a bi-directional ptp or ptmp wireless link but not directly connected to any other second-tier node (e.g., if the high-capacity pathway is a single-hop pathway), (ii) directly connected to a first-tier node via a first bi-directional ptp or ptmp wireless link and also directly connected to another second-tier node via a second bi-directional ptp or ptmp wireless link, or (iii) directly connected to two other second-tier nodes via respective bi-directional ptp or ptmp wireless links. And relatedly, depending on where a second-tier node is situated within such a pathway, the second-tier node may function to exchange bi-directional network traffic along the high-capacity pathway either (i) with a single other node (e.g., a single first-tier node or a single other second-tier node) or (ii) with each of two other nodes (e.g., one first-tier node and one other second-tier node or two other second-tier nodes).

Further, in addition to each second-tier node's role in forming the one or more high-capacity pathways that extend from the one or more first-tier nodes, each of at least a subset of the second-tier nodes may also be directly connected downstream to one or more third-tier nodes via one or more bi-directional ptp or ptmp wireless links, in which case each such second-tier node may additionally function to exchange bi-directional network traffic with one or more third-tier nodes as part of a discrete sub-mesh that is configured to route aggregated network traffic to and from endpoints within a particular geographic area.

Further yet, in at least some implementations, a second-tier node may function to deliver the service being provided by the mesh-based communication system (e.g., a high-speed internet service) to the second-tier node's infrastructure site, such that individuals present at the second-tier node's infrastructure site can utilize that service. In this way, a second-tier node can serve as both a “relay” for bi-directional network traffic and also as an “access point” for the service provided by the mesh-based communication system. A second-tier node may perform other functions as well.

The infrastructure sites at which the second-tier nodes are installed may take any of various forms, and in at least some implementations, a second-tier node's infrastructure site may comprise private property associated with a respective customer of the service being provided by the mesh-based communication system. For instance, as one possibility, a second-tier node's infrastructure site could be a residential building that is associated with a customer of the service being provided by the mesh-based communication system and provides a suitable location for installation of equipment for establishing and communicating over wireless links with other wireless communication nodes (e.g., a location that has sufficient LOS to other infrastructure sites), such as a particular section of the residential building's rooftop or a particular spot along the side of the residential building. For example, such a residential building could take the form of a detached single-family home, a townhouse, or a multi-dwelling unit (MDU) where a customer of the service being provided by the mesh-based communication system resides, among other examples. In such an implementation, in addition to exchanging bi-directional network traffic with other nodes of the wireless mesh network, the second-tier node installed at the residential building may also function to deliver the service being provided by the mesh-based communication system (e.g., a high-speed internet service) to the residential building such that the customer (and/or other individuals at the residential building) can make use of that service.

As another possibility, a second-tier node's infrastructure site could be a commercial building that is associated with a customer of the service being provided by the mesh-based communication system and provides a suitable location for establishing and communicating over wireless links with other wireless communication nodes (e.g., a location that has sufficient LOS to other infrastructure sites), such as a particular section of the commercial building's rooftop or a particular spot along the side of the commercial building. For example, such a commercial building could take the form of an office building where a customer of the service being provided by the mesh-based communication system owns or leases office space, among other examples. In such an implementation, in addition to exchanging bi-directional network traffic with other nodes of the wireless mesh network, the second-tier node installed at the commercial building may also function to deliver the service being provided by the mesh-based communication system (e.g., a high-speed internet service) to the commercial building such that the customer (and/or other individuals at the commercial building) can make use of that service.

A second-tier node's infrastructure site could take some other form as well, including but not limited to the possibility that a second-tier node's infrastructure site could be a support structure such as a tower or pole that is located on private property owned or occupied by a customer of the service being provided by the mesh-based communication system.

The equipment for each second-tier node may take any of various forms. To begin, a second-tier node's equipment may include wireless mesh equipment for establishing a wireless connection with one or more other nodes of the wireless mesh network, which may take various forms depending on where the second-tier node sits within the network arrangement. For instance, if a second-tier node is of a type that is to establish a wireless connection with a first-tier node as part of forming a high-capacity pathway to that first-tier node, the second-tier node's wireless mesh equipment may be configured to establish and communicate over either (i) a high-capacity bi-directional ptp wireless link with the first-tier node or (ii) a high-capacity bi-directional ptmp wireless link with the first-tier node, among other possibilities. Further, if a second-tier node is of a type that is to establish a wireless connection with either one or two peer second-tier nodes as part of forming a high-capacity pathway to a first-tier node, the second-tier node's wireless mesh equipment may be configured to establish and communicate over either (i) a respective bi-directional ptp wireless link with each peer second-tier node or (ii) a bi-directional ptmp wireless link (or perhaps multiple bi-directional ptmp wireless links) with the one or two peer second-tier nodes, among other possibilities. Further yet, if a second-tier node is of a type that is to establish a wireless connection with one or more third-tier nodes, the second-tier node's wireless mesh equipment may be configured to establish and communicate over either (i) a respective bi-directional ptp wireless link with each of the one or more third-tier nodes or (ii) a bi-directional ptmp wireless link (or perhaps multiple bi-directional ptmp wireless links) with the one or more third-tier nodes, among other possibilities. Other implementations of a second-tier node's wireless mesh equipment are possible as well. Additionally, a second-tier node's equipment may include networking equipment (e.g., one or more modems, routers, switches, or the like) that facilitates communication between the second-tier node's wireless mesh equipment and other devices or systems located at the second-tier node's infrastructure site. Additionally yet, a second-tier node's equipment may include power equipment for supplying power to the wireless mesh equipment and/or the networking equipment, such as power and/or battery units. A second-tier node's equipment may take various other forms as well.

A second-tier node of the wireless mesh network may take various other forms as well.

Turning next to mesh-based communication system's third tier of wireless communication nodes, as noted above, each third-tier node is installed at a respective infrastructure site and primarily serves to form a discrete sub-mesh that extends from at least one second-tier node and functions to route aggregated network traffic to and from endpoints within a particular geographic area. In this respect, each third-tier node may be directly connected to one or more other nodes within the second and/or third tiers via one or more bi-directional ptp or ptmp wireless links.

For instance, as one possibility, a third-tier node could be directly connected to (i) a second-tier node via a bi-directional ptp or ptmp wireless link as well as (ii) one or more peer third-tier nodes via one or more bi-directional ptp or ptmp wireless links, in which case the third-tier node may function to exchange bi-directional network traffic with the second-tier node and each of the one or more peer third-tier nodes as part of a discrete sub-mesh. As another possibility, a third-tier node could be directly connected to one or more peer third-tier nodes via one or more bi-directional ptp or ptmp wireless links, but not be directly connected to any second-tier node, in which case the third-tier node may function to exchange bi-directional network traffic with each of the one or more peer third-tier nodes as part of a discrete sub-mesh. As yet another possibility, a third-tier node could be directly connected to a second-tier node via a bi-directional ptp or ptmp wireless link, but not be directly connected to any peer third-tier node, in which case the third-tier node may function to exchange bi-directional network traffic with the second-tier node of a discrete sub-mesh. Other configurations are possible as well.

Further, each of at least a subset of the third-tier nodes may also be directly connected downstream to one or more fourth-tier nodes via one or more bi-directional ptp or ptmp wireless links, in which case each such third-tier node may additionally function to exchange individual network traffic to and from each of the one or more fourth-tier nodes.

Further yet, in at least some implementations, a third-tier node may function to deliver the service being provided by the mesh-based communication system (e.g., a high-speed internet service) to the third-tier node's infrastructure site, such that individuals present at the third-tier node's infrastructure site can utilize that service. In this way, certain of the third-tier nodes (e.g., third-tier nodes that are connected to at least two other wireless communication nodes) can serve as both a “relay” for bi-directional network traffic and also as an “access point” for the service provided by the mesh-based communication system, while others of the third-tier nodes (e.g., third-tier nodes that are only connected to a single other wireless communication node) may only serve as an “access point” for the service provided by the mesh-based communication system. A third-tier node may perform other functions as well.

As with the second-tier nodes, the infrastructure sites at which the third-tier nodes are installed may take any of various forms, and in at least some implementations, a third-tier node's infrastructure site may comprise private property associated with a respective customer of the service being provided by the mesh-based communication system. For instance, as one possibility, a third-tier node's infrastructure site could be a residential building that is associated with a customer of the service being provided by the mesh-based communication system and provides a suitable location for installation of equipment for establishing and communicating over wireless links with other wireless communication nodes (e.g., a location that has sufficient LOS to other infrastructure sites), such as a particular section of the residential building's rooftop or a particular spot along the side of the residential building. For example, such a residential building could take the form of a detached single-family home, a townhouse, or an MDU where a customer of the service being provided by the mesh-based communication system resides, among other examples. In such an implementation, in addition to exchanging bi-directional network traffic with other nodes of the wireless mesh network, the third-tier node installed at the residential building may also function to deliver the service being provided by the mesh-based communication system (e.g., a high-speed internet service) to the residential building such that the customer (and/or other individuals at the residential building) can make use of that service.

As another possibility, a third-tier node's infrastructure site could be a commercial building that is associated with a customer of the service being provided by the mesh-based communication system and provides a suitable location for installation of equipment for establishing and communicating over wireless links with other wireless communication nodes (e.g., a location that has sufficient LOS to other infrastructure sites), such as a particular section of the commercial building's rooftop or a particular spot along the side of the commercial building. For example, such a commercial building could take the form of an office building where a customer of the service being provided by the mesh-based communication system owns or leases office space, among other examples. In such an implementation, in addition to exchanging bi-directional network traffic with other nodes of the wireless mesh network, the third-tier node installed at the commercial building may also function to deliver the service being provided by the mesh-based communication system (e.g., a high-speed internet service) to the commercial building such that the customer (and/or other individuals at the commercial building) can make use of that service.

A third-tier node's infrastructure site could take some other form as well, including but not limited to the possibility that a third-tier node's infrastructure site could be a support structure such as a tower or pole that is located on private property owned or occupied by a customer of the service delivered by the mesh-based communication system.

The equipment for each third-tier node may also take any of various forms. To begin, a third-tier node's equipment may include wireless mesh equipment for establishing a wireless connection with one or more other nodes of the wireless mesh network, which may take various forms depending on where the third-tier node sits within the network arrangement. For instance, if a third-tier node is of a type that is to establish a wireless connection with at least one second-tier node, the third-tier node's wireless mesh equipment may be configured to establish and communicate over either (i) a bi-directional ptp wireless link with the at least one second-tier node or (ii) a bi-directional ptmp wireless link with the at least one second-tier node, among other possibilities. Further, if a third-tier node is of a type that is to establish a wireless connection with one or more peer third-tier nodes, the third-tier node's wireless mesh equipment may be configured to establish and communicate over either (i) a respective bi-directional ptp wireless link with each of the one or more peer third-tier nodes or (ii) a bi-directional ptmp wireless link (or perhaps multiple bi-directional ptmp wireless links) with the one or more peer third-tier nodes, among other possibilities. Further yet, if a third-tier node is of a type that is to establish a wireless connection with one or more fourth-tier nodes, the third-tier node's wireless mesh equipment may be configured to establish and communicate over either (i) a respective bi-directional ptp wireless link with each of the one or more fourth-tier nodes or (ii) a bi-directional ptmp wireless link (or perhaps multiple bi-directional ptmp wireless links) with the one or more fourth-tier nodes, among other possibilities. Other implementations of a third-tier node's wireless mesh equipment are possible as well. Additionally, a third-tier node's equipment may include networking equipment (e.g., one or more modems, routers, switches, or the like) that facilitates communication between the third-tier node's wireless mesh equipment and other devices or systems located at the third-tier node's infrastructure site. Additionally yet, a third-tier node's equipment may include power equipment for supplying power to the wireless mesh equipment and/or the networking equipment, such as power and/or battery units. A third-tier node's equipment may take various other forms as well.

A third-tier node of the wireless mesh network may take various other forms as well.

Turning lastly to the wireless mesh network's fourth tier of “fourth-tier nodes,” as noted above, each fourth-tier node is installed at a respective infrastructure site and primarily serves to extend a discrete sub-mesh formed by other wireless communication nodes (e.g., third-tier nodes together with one or more second-tier nodes) to another endpoint by exchanging individual network traffic to and from one of the nodes within the discrete sub-mesh. In this respect, each fourth-tier node may be directly connected upstream to at least one third-tier node via at least one bi-directional ptp or ptmp wireless link, and may function to exchange bi-directional network traffic with the at least one third-tier node. Further, in most implementations, a fourth-tier node may function to deliver the service being provided by the mesh-based communication system (e.g., a high-speed internet service) to the fourth-tier node's infrastructure site, such that individuals present at the fourth-tier node's infrastructure site can utilize that service. In this way, a fourth-tier node can serve as an “access point” for the service provided by the mesh-based communication system, but unlike the second-tier and third-tier nodes, may not necessarily serve as a “relay” for bi-directional network traffic. A fourth-tier node may perform other functions as well.

The infrastructure sites at which the fourth-tier nodes are installed may take any of various forms, and in at least some implementations, a fourth-tier node's infrastructure site may comprise private property associated with a respective customer of the service being provided by the mesh-based communication system. For instance, as one possibility, a fourth-tier node's infrastructure site could be a residential building that is associated with a customer of the service being provided by the mesh-based communication system and provides a suitable location for installation of equipment for establishing and communicating over wireless links with other wireless communication nodes (e.g., a location that has sufficient LOS to other infrastructure sites), such as a particular section of the residential building's rooftop or a particular spot along the side of the residential building. For example, such a residential building could take the form of a detached single-family home, a townhouse, or a MDU where a customer of the service being provided by the mesh-based communication system resides, among other examples. In such an implementation, in addition to exchanging bi-directional network traffic with other nodes of the wireless mesh network, the fourth-tier node installed at the residential building may also function to deliver the service being provided by the mesh-based communication system (e.g., a high-speed internet service) to the residential building such that the customer (and/or other individuals at the residential building) can make use of that service.

As another possibility, a fourth-tier node's infrastructure site could be a commercial building that is associated with a customer of the service being provided by the mesh-based communication system and provides a suitable location for installation of equipment for establishing and communicating over wireless links with other wireless communication nodes (e.g., a location that has sufficient LOS to other infrastructure sites), such as a particular section of the commercial building's rooftop or a particular spot along the side of the commercial building. For example, such a commercial building could take the form of an office building where a customer of the service being provided by the mesh-based communication system owns or leases office space, among other examples. In such an implementation, in addition to exchanging bi-directional network traffic with other nodes of the wireless mesh network, the fourth-tier node installed at the commercial building may also function to deliver the service being provided by the mesh-based communication system (e.g., a high-speed internet service) to the commercial building such that the customer (and/or other individuals at the commercial building) can make use of that service.

A fourth-tier node's infrastructure site could take some other form as well, including but not limited to the possibility that a fourth-tier node's infrastructure site could be a support structure such as a tower or pole that is located on private property owned or occupied by a customer of the service being provided by the mesh-based communication system.

The equipment for each fourth-tier node may take any of various forms. To begin, a fourth-tier node's equipment may include wireless mesh equipment for establishing a wireless connection with at least one third-tier node. For instance, a fourth-tier node's wireless mesh equipment may be configured to establish and communicate over either (i) a bi-directional ptp wireless link with the at least one third-tier node or (ii) a bi-directional ptmp wireless link with the at least one third-tier node. Other implementations of a fourth-tier node's wireless mesh equipment are possible as well. Additionally, a fourth-tier node's equipment may include networking equipment (e.g., one or more modems, routers, switches, or the like) that facilitates communication between the fourth-tier node's wireless mesh equipment and other devices or systems located at the fourth-tier node's infrastructure site. Additionally yet, a fourth-tier node's equipment may include power equipment for supplying power to the wireless mesh equipment and/or the networking equipment, such as power and/or battery units. A fourth-tier node's equipment may take various other forms as well.

A fourth-tier node of the wireless mesh network may take various other forms as well.

As noted above, the wireless mesh network's tiers of wireless communication nodes may take various other forms as well. For instance, as one possibility, the wireless mesh network designed in accordance with the present disclosure may include first-tier nodes, second-tier nodes, and third-tier nodes, but not fourth-tier nodes for extending the discrete sub-meshes to other endpoints. As another possibility, the wireless mesh network designed in accordance with the present disclosure may include first-tier nodes, third-tier nodes, and fourth-tier nodes, but not second-tier nodes—in which case there may be no high-capacity pathway that extends from the first-tier nodes and discrete sub-meshes formed by third-tier nodes may extend directly from the first-tier nodes rather than extending from second-tier nodes. As yet another possibility, the wireless mesh network designed in accordance with the present disclosure may include a fifth tier of nodes that are each directly connected upstream to a respective fourth-tier node via a bi-directional ptp or ptmp wireless link. The wireless mesh network's tiers of wireless communication nodes may take various other forms as well.

As discussed above, the wireless communication nodes of the wireless mesh network may be interconnected via bi-directional wireless links that could take the form of bi-directional ptp wireless links, bi-directional ptmp wireless links, or some combination thereof. These bi-directional ptp and/or ptmp wireless links may take any of various forms.

Beginning with the bi-directional ptp wireless links, each bi-directional ptp wireless link that is established between two wireless communication nodes of the wireless mesh network may have any of various different beamwidths. For instance, as one possibility, a bi-directional ptp wireless link that is established between two wireless communication nodes of the wireless mesh network may have a 3 dB-beamwidth in both the horizontal and vertical directions that is less than 5 degrees—or in some cases, even less than 1 degree—which would generally be classified as an “extremely-narrow” beamwidth. As another possibility, a bi-directional ptp wireless link that is established between two wireless communication nodes of the wireless mesh network may have a 3 dB-beamwidth in both the horizontal and vertical directions that is within a range of 5 degrees and 10 degrees, which would generally be classified as a “narrow” beamwidth but not necessarily an “extremely-narrow” beamwidth. As yet another possibility, a bi-directional ptp wireless link that is established between two wireless communication nodes of the wireless mesh network may have a 3 dB-beamwidth that is greater than 10 degrees. A bi-directional ptp wireless link having some other beamwidth could be utilized as well.

Further, each bi-directional ptp wireless link that is established between two wireless communication nodes of the wireless mesh network may operate and carry traffic at frequencies in any of various different frequency bands. For instance, in a preferred embodiment, each bi-directional ptp wireless link established between two wireless communication nodes of the wireless mesh network may take the form of a millimeter-wave ptp wireless link (or an “MMWave wireless link” for short) that operates and carries traffic at frequencies in a frequency band within the millimeter-wave spectrum (e.g., between 6 gigahertz (GHz) and 300 GHz), such as the 26 GHz band, the 28 GHz band, the 39 GHz band, the 37/42 GHz band, the V band (e.g., between 57 GHz and 66 GHz), or the E Band (e.g., between 70 GHz and 90 GHz), among other possibilities. In practice, millimeter-wave ptp wireless links such as this may have a high capacity (e.g., 1 Gbps or more) and a low latency (e.g., less than 1 millisecond), which may provide an advantage over ptp wireless links operating in other frequency spectrums. However, millimeter-wave ptp wireless links such as this may also have certain limitations as compared to wireless links operating in other frequency spectrums, including a shorter maximum link length and a requirement that there be at least partial line-of-sight (LOS) between the wireless communication nodes establishing the millimeter-wave ptp wireless link in order for the link to operate properly, which may impose restrictions on which infrastructure sites can be used to host the wireless communication nodes and how the wireless mesh equipment of the wireless communication nodes must be positioned and aligned at the infrastructure sites, among other considerations that typically need to be addressed when utilizing millimeter-wave ptp wireless links.

In another embodiment, each bi-directional ptp wireless link established between two wireless communication nodes of the wireless mesh network may take the form of a sub-6 GHz ptp wireless link that operates and carries traffic at frequencies in a frequency band within the sub-6 GHz spectrum. In practice, sub-6 GHz ptp wireless links such as this may have a lower capacity (e.g., less than 1 Gbps) and perhaps also a higher latency than millimeter-wave ptp links, which may make sub-6 GHz ptp wireless links less desirable for use in at least some kinds of mesh-based communication systems (e.g., mesh-based communication systems for providing high-speed internet service). However, sub-6 GHz ptp wireless links such as this may also provide certain advantages over millimeter-wave ptp links, including a longer maximum link length and an ability to operate in environments that do not have sufficient LOS, which may make sub-6 GHz ptp wireless links more suitable for certain kinds of mesh-based communication systems and/or certain segments of mesh-based communication systems.

In yet another embodiment, some of the bi-directional ptp wireless links established between wireless communication nodes of the wireless mesh network may take the form of millimeter-wave ptp wireless links, while other of the bi-directional ptp wireless links established between wireless communication nodes of the wireless mesh network may take the form of sub-6 GHz ptp wireless links. The bi-directional ptp wireless links established between wireless communication nodes of the wireless mesh network may operate and carry traffic at frequencies in other frequency bands as well.

Further yet, each bi-directional ptp wireless link that is established between two wireless communication nodes of the wireless mesh network may utilize any of various duplexing schemes to carry bi-directional network traffic between the two wireless communication nodes, including but not limited to time division duplexing (TDD) and/or frequency division duplexing (FDD), among other possibilities, and network traffic may be exchanged over each bi-directional ptp wireless link using any of various digital transmission schemes, including but not limited to amplitude modulation (AM), phase modulation (PM), pulse amplitude modulation/quadrature amplitude modulation (PAM/QAM), ultra-wide band (UWB) pulse modulation (e.g., using pulses on the order of pico-seconds, such as pulses of 5-10 pico-seconds), multiple input multiple output (MIMO), and/or orbital angular momentum (OAM) multiplexing, and/or among other possibilities.

Still further, each bi-directional ptp wireless link that is established between two wireless communication nodes of the wireless mesh network may have any of various capacities, which may depend in part on certain of the other attributes described above (e.g., the ptp wireless link's beamwidth, frequency band, etc.) and/or the particular equipment used to establish the ptp wireless link. For instance, in a preferred embodiment, each bi-directional ptp wireless link that is established between two wireless communication nodes may have a capacity of at least 1 Gbps, which is generally considered to be a “high-capacity” ptp wireless link in the context of the present disclosure. Within this class of “high-capacity” ptp wireless links, each ptp wireless link may have a capacity level that falls within any of various ranges, examples of which may include a capacity between 1 and 5 Gbps, a capacity between 5 and 10 Gbps, a capacity between 10 and 20 Gbps, a capacity that exceeds 20 Gbps, or perhaps even a capacity that exceeds 100 Gbps (which may be referred to as an “ultra-high-capacity” ptp wireless link), among other possible examples of capacity ranges. Further, in other embodiments, some or all of the bi-directional ptp wireless links may have a capacity that is less than 1 Gbps. It some implementations, ptp wireless links having differing levels of high capacity may also be utilized at different points within the wireless mesh network (e.g., utilizing ptp wireless links having a first capacity level between first-tier and second-tier nodes and between peer second-tier nodes and utilizing ptp wireless links having a second capacity level between second-tier and third-tier nodes and between peer third-tier nodes). The capacities of the bi-directional ptp wireless links may take other forms as well.

Each bi-directional ptp wireless link that is established between two wireless communication nodes of the wireless mesh network may also have any of various lengths, which may depend on the location of the two wireless communication nodes, but the maximum link length of each such wireless link may also depend in part on certain of the other attributes described above (e.g., the ptp wireless link's beamwidth, frequency band, etc.) and/or the particular equipment used to establish the ptp wireless link. As examples, a bi-directional ptp wireless link that is established between two wireless communication nodes of the wireless mesh network could have a shorter maximum link length (e.g., less than 100 meters), an intermediate maximum link length (e.g., between 100 meters and 500 meters), a longer maximum link length (e.g., between 500 meters and 1000 meters), or a very long maximum link length (e.g., more than 1000 meters), among other possibilities. It some implementations, ptp wireless links having differing maximum lengths may also be utilized at different points within the wireless mesh network (e.g., utilizing ptp wireless links having a first maximum length between first-tier and second-tier nodes and between peer second-tier nodes and utilizing ptp wireless links having a second maximum length between second-tier and third-tier nodes and between peer third-tier nodes). The lengths of the bi-directional ptp wireless links may take other forms as well.

Each bi-directional ptp wireless link that is established between two wireless communication nodes of the wireless mesh network may take various other forms as well.

Turning to the bi-directional ptmp wireless links, each bi-directional ptmp wireless link that originates from a given wireless communication node of the wireless mesh network and is established with one or more other wireless communication nodes may have any of various different beamwidths, which may define a “ptmp coverage area” of the originating wireless communication node. For instance, as one possibility, a bi-directional ptmp wireless link that originates from a given wireless communication node of the wireless mesh network may have a beamwidth in the horizontal direction that is within a range of 60 degrees to 180 degrees (e.g., 120 degrees). As another possibility, a bi-directional ptmp wireless link that originates from a given wireless communication node of the wireless mesh network may have a beamwidth in the horizontal direction that is either less than 60 degrees (in which case the wireless communication node's ptmp coverage area would be smaller) or greater than 180 degrees (in which case the wireless communication node's ptmp coverage area would be larger). A bi-directional ptmp wireless link having some other beamwidth could be utilized as well.

Further, each bi-directional ptmp wireless link that originates from a given wireless communication node of the wireless mesh network and is established with one or more other wireless communication nodes may operate and carry traffic at frequencies in any of various different frequency bands. For instance, in a preferred embodiment, each bi-directional ptmp wireless link that originates from a given wireless communication node of the wireless mesh network may take the form of a millimeter-wave wireless link that operates and carries traffic at frequencies in a frequency band within the millimeter-wave spectrum, such as the 26 GHz band, the 28 GHz band, the 39 GHz band, the 37/42 GHz band, the V band, or the E Band, among other possibilities. Millimeter-wave ptmp wireless links such as this may have a high capacity (e.g., at least 1 Gbps) and a low latency (e.g., less than 4 milliseconds), which may provide an advantage over wireless links operating in other frequency spectrums, but may also have certain limitations as compared to ptmp wireless links operating in other frequency spectrums, including a shorter maximum link length and a need for sufficient LOS between wireless communication nodes, which may impose restrictions on which infrastructure sites can be used to host the wireless communication nodes and how the wireless mesh equipment of the wireless communication nodes must be positioned and aligned at the infrastructure sites, among other considerations that typically need to be addressed when utilizing millimeter-wave wireless links.

In another embodiment, each bi-directional ptmp wireless link that originates from a given wireless communication node of the wireless mesh network may take the form of a sub-6 GHz wireless link that operates and carries traffic at frequencies in a frequency band within the sub-6 GHz spectrum. Sub-6 GHz ptmp wireless links such as this may have a lower capacity (e.g., less than 1 Gbps) and perhaps also a higher latency than millimeter-wave ptmp wireless links, which may make sub-6 GHz ptmp wireless links less desirable for use in at least some kinds of mesh-based communication systems, but sub-6 GHz ptmp wireless links such as this may also provide certain advantages over millimeter-wave ptmp links, including a longer maximum link length and an ability to operate in environments that do not have sufficient LOS, which may make sub-6 GHz ptmp wireless links more suitable for certain kinds of mesh-based communication systems and/or certain segments of mesh-based communication systems.

In yet another embodiment, some of the bi-directional ptmp wireless links established between wireless communication nodes of the wireless mesh network may take the form of millimeter-wave ptmp wireless links while other of the bi-directional ptmp wireless links established between wireless communication nodes of the wireless mesh network may take the form of sub-6 GHz ptmp wireless links. The bi-directional ptmp wireless links established between wireless communication nodes of the wireless mesh network may operate and carry traffic at frequencies in other frequency bands as well.

Further yet, each bi-directional ptmp wireless link that originates from a given wireless communication node of the wireless mesh network and is established with one or more other wireless communication nodes may utilize any of various duplexing schemes to carry bi-directional network traffic between the given wireless node and one of the other wireless communication nodes, including but not limited to TDD and/or FDD, as well as any of various multiple access schemes to enable the bi-directional ptmp wireless link originating from the given wireless communication node to be shared between the one or one or more other wireless communication nodes, including but not limited to frequency division multiple access (FDMA), time division multiple access (TDMA), single carrier FDMA (SC-FDMA), single carrier TDMA (SC-TDMA), code division multiple access (CDMA), orthogonal frequency division multiple access (OFDMA), non-orthogonal multiple access (NOMA), and/or Multiuser Superposition Transmission (MUST), among other possibilities. Further, as with the bi-directional ptp wireless links, network traffic may be exchanged over each bi-directional ptp wireless link using any of various digital transmission schemes, including but not limited to AM, PM, PAM/QAM, UWB pulse modulation, MIMO, and/or OAM multiplexing, among other possibilities.

Still further, each bi-directional ptmp wireless link that originates from a given wireless communication node of the wireless mesh network and is established with one or more other wireless communication nodes may have any of various capacities, which may depend in part on certain of the other attributes described above (e.g., the ptmp wireless link's beamwidth, frequency band, etc.) and/or the particular equipment used to establish the ptmp wireless link. For instance, in a preferred embodiment, each bi-directional ptmp wireless link that originates from a given wireless communication node of the wireless mesh network and is established with one or more other wireless communication nodes may have a capacity of at least 1 Gbps, which is generally considered to be a “high-capacity” ptmp wireless link in the context of the present disclosure. Within this class of “high-capacity” ptmp wireless links, each ptmp wireless link may have a capacity level that falls within any of various ranges, examples of which may include a capacity between 1 and 5 Gbps, a capacity between 5 and 10 Gbps, a capacity between 10 and 20 Gbps, a capacity that exceeds 20 Gbps, or perhaps even a capacity that exceeds 100 Gbps (which may be referred to as an “ultra-high-capacity” ptp wireless link), among other possible examples of capacity ranges. Further, in other embodiments, some or all of the bi-directional ptmp wireless links may have a capacity that is less than 1 Gbps. It some implementations, ptmp wireless links having differing levels of high capacity may also be utilized at different points within the wireless mesh network. The capacities of the ptmp wireless links may take other forms as well.

Each bi-directional ptmp wireless link that originates from a given wireless communication node of the wireless mesh network and is established with one or more other wireless communication nodes may also have any of various lengths, which may depend on the location of the wireless communication nodes, but the maximum link length of each such wireless link may also depend in part on certain of the other attributes described above (e.g., the ptmp wireless link's beamwidth, frequency band, etc.) and/or the particular equipment used to establish the ptmp wireless link. As examples, each bi-directional ptmp wireless link that originates from a given wireless communication node could have a shorter maximum link length (e.g., less than 100 meters), an intermediate maximum link length (e.g., between 100 meters and 500 meters), a longer maximum link length (e.g., between 500 meters and 1000 meters), or a very long maximum link length (e.g., more than 1000 meters), among other possibilities. It some implementations, ptmp wireless links having differing maximum lengths may also be utilized at different points within the wireless mesh network. The lengths of the ptmp wireless links may take other forms as well.

Each bi-directional ptmp wireless link that originates from a given wireless communication node of the wireless mesh network and is established with one or more other wireless communication nodes may take various other forms as well.

In practice, bi-directional ptp wireless links and bi-directional ptmp wireless links of the type described above typically provide different respective advantages and disadvantages that can be considered when implementing a mesh-based communication system in accordance with the example architecture disclosed herein. For instance, bi-directional ptp wireless links are typically less susceptible to interference than bi-directional ptmp wireless links, and in most cases, bi-directional ptp wireless links are unlikely to cause interference with one another once established even if such ptp wireless links do not have an extremely-narrow beamwidth. Conversely, the process of installing and configuring equipment for establishing a bi-directional ptp wireless link between two wireless communication nodes tends to be more time consuming and labor intensive than the process of installing and configuring equipment for establishing a bi-directional ptmp wireless link, as it generally requires the ptp radios at both of the wireless communication nodes to be carefully positioned and aligned with one another in a manner that provides sufficient LOS between the ptp radios. This is particularly the case for bi-directional ptp wireless links having narrower beamwidths, which increases the level of precision needed for the positioning and alignment of the ptp radios. As such, bi-directional ptp wireless links are typically better suited for establishing wireless connections between wireless communication nodes that have pre-planned, fixed locations and are expected to require minimal coordination after the initial deployment of the wireless mesh network, which typically is the case for first-tier nodes, second-tier nodes, and most third-tier nodes.

On the other hand, because a bi-directional ptmp wireless link originating from a given wireless communication node typically has a wider beamwidth (e.g., within a range of 120 degrees to 180 degrees) and can be established with one or more other wireless communication nodes in a wider coverage area, the process of installing and configuring equipment for establishing a bi-directional ptmp wireless link tends to be less time consuming or labor intensive—the ptmp radio of the given wireless communication node can be positioned and aligned to point in a general direction where other ptmp radios are expected to be located as opposed to a more precise direction of one specific ptp radio. As such, bi-directional ptmp wireless links are typically better suited for establishing wireless connections with wireless communication nodes that do not have pre-planned locations, which may be the case for fourth-tier nodes (and perhaps some third-tier nodes) because those nodes may not be added until after the initial deployment of the wireless mesh network. However, because bi-directional ptmp wireless links are generally more susceptible to interference, the use of bi-directional ptmp wireless links typically imposes an ongoing need to engage in coordination for frequency planning, interference mitigation, or the like after the initial deployment of the wireless mesh network. In this respect, the coordination that may be required for ptmp wireless links may involve intra-link coordination between multiple wireless communication nodes that are communicating over the same ptmp wireless link and/or inter-link coordination between multiple ptmp wireless links operating on the same frequency, among other possibilities.

These differences in the respective interference profiles of ptp and ptmp wireless links, the respective amount of time and effort required to install and configure equipment for establishing ptp and ptmp wireless links, and the respective amount of time and effort required to maintain the ptp and ptmp links may all be factors that can be considered when implementing a mesh-based communication system in accordance with the example architecture disclosed herein. Additionally, in practice, equipment for establishing bi-directional ptp wireless links tends to be more expensive than equipment for establishing bi-directional ptmp wireless links (e.g., due to the fact that multiple ptp radios are required when there is a need to communicate with multiple other wireless communication nodes via respective ptp wireless links whereas only a single ptmp radio is typically required to communicate with multiple other wireless communication nodes via a ptmp wireless link), which is another factor that can be considered when implementing a mesh-based communication system in accordance with the example architecture disclosed herein.

Based on these (and other) factors, a designer of a mesh-based communication system having the example architecture disclosed herein could choose to interconnect the wireless communication nodes of the wireless mesh network using bi-directional ptp wireless links exclusively, bi-directional ptmp wireless links exclusively, or some combination of bi-directional ptp wireless links and bi-directional ptmp wireless links.

For instance, in one embodiment, every wireless link that is established between and among the wireless communication nodes in the different tiers of the wireless mesh network—which may include wireless links between first-tier and second-tier nodes, wireless links between peer second-tier nodes, wireless links between second-tier and third-tier nodes, wireless links between peer third-tier nodes, and wireless links between third-tier and fourth-tier nodes, among others—may take the form of a bi-directional ptp wireless link that is established between two wireless communication nodes' ptp radios.

In another embodiment, every wireless link that is established between and among the wireless communication nodes in the different tiers of the wireless mesh network—which as just noted may include wireless links between first-tier and second-tier nodes, wireless links between peer second-tier nodes, wireless links between second-tier and third-tier nodes, wireless links between peer third-tier nodes, and wireless links between third-tier and fourth-tier nodes, among others—may take the form of a bi-directional ptmp wireless link that originates from one wireless communication node's ptmp radio and is established with a respective ptmp radio at each of one or more other wireless communication nodes.

In yet another embodiment, the bi-directional wireless links that are established between and among the wireless communication nodes in certain tiers of the wireless mesh network may take the form of bi-directional ptp wireless links, while the bi-directional wireless links that are established between and among the wireless communication nodes in other tiers of the wireless mesh network may take the form of bi-directional ptmp wireless links.

For instance, as one possible implementation of this embodiment, the wireless links between first-tier and second-tier nodes, between peer second-tier nodes, between second-tier and third-tier nodes, and between peer third-tier nodes may each take the form of a bi-directional ptp wireless link that is established between two nodes' ptp radios, while the wireless links between third-tier and fourth-tier nodes may each take the form of a bi-directional ptmp wireless link that originates from a given third-tier node's ptmp radio and is established with a respective ptmp radio at each of one or more other fourth-tier nodes—which may allow the wireless mesh network to be extended to additional endpoints at a lower cost and may also be well suited for scenarios where there is an expectation that fourth-tier nodes may be added to the wireless mesh network after its initial deployment (among other considerations).

As another possible implementation of this embodiment, the wireless links between first-tier and second-tier nodes and between peer second-tier nodes may each take the form of a bi-directional ptp wireless link that is established between two nodes' ptp radios, while the wireless links between second-tier and third-tier nodes, between peer third-tier nodes, and between third-tier and fourth-tier nodes may each take the form of a bi-directional ptmp wireless link that originates from a given node's ptmp radio and is established with a respective ptmp radio at each of one or more other nodes—which may allow the wireless mesh network to be extended to third-tier nodes and/or fourth-tier nodes at a lower cost and may also be well suited for scenarios where there is an expectation that additional third-tier nodes and/or fourth-tier nodes may be added to the wireless mesh network after its initial deployment (among other considerations).

As yet another possible implementation of this embodiment where the wireless mesh network additionally includes a fifth tier of nodes, the wireless links between first-tier and second-tier nodes, between peer second-tier nodes, between second-tier and third-tier nodes, and between peer third-tier nodes may each take the form of a bi-directional ptp wireless link that is established between two nodes' ptp radios, while the wireless links between third-tier and fourth-tier nodes and between the fourth-tier and fifth-tier nodes may each take the form of a bi-directional ptmp wireless link that originates from a ptmp radio of one node and is established with a respective ptmp radio at each of one or more other nodes—which may allow the wireless mesh network to be extended to multiple tiers of additional endpoints at a lower cost and may also be well suited for scenarios where there is an expectation that multiple tiers of additional endpoints may be added to the wireless mesh network after its initial deployment (among other considerations).

In the foregoing implementations, the wireless mesh network may be considered to have two different “layers” (or “segments”) of bi-directional wireless links: (1) a first layer comprising the bi-directional ptp wireless links, which may be referred to as a “ptp layer,” and (2) a second layer comprising the bi-directional ptmp wireless links, which may be referred to as a “ptmp layer.”

Various other implementations of the embodiment where the wireless mesh network includes both bi-directional ptp wireless links and bi-directional ptmp wireless links are possible as well, including but not limited to implementations where the bi-directional wireless links among the wireless communication nodes within a single tier of the wireless mesh network (e.g., the anchor-to-anchor wireless links) comprise a mix of bi-directional ptp wireless links and bi-directional ptmp wireless and/or implementations where the bi-directional wireless links between wireless communication nodes in two adjacent tiers of the wireless mesh network (e.g., the seed-to-anchor wireless links or the anchor-to-leaf wireless links) comprise a mix of bi-directional ptp wireless links and bi-directional ptmp wireless.

Further, in line with the discussion, the bi-directional ptp and/or ptmp wireless links between and among the different tiers of wireless communication nodes in the foregoing embodiments may also have differing levels of capacity. For instance, in one example implementation, the wireless links between first-tier and second-tier nodes and between peer second-tier nodes (which form the high-capacity pathways extending from the first-tier nodes) may each comprise a high-capacity wireless link having a highest capacity level (e.g., at or near 10 Gbps or perhaps even higher), the wireless links between second-tier and third-tier nodes and between peer third-tier nodes (which may form the discrete sub-meshes for routing aggregated network traffic to and from endpoints in a particular geographic area) may each comprise a high-capacity wireless link having a second highest capacity level (e.g., at or near 2.5 Gbps), and the wireless links between third-tier and fourth-tier nodes may each comprise a high-capacity wireless link having a third highest capacity level (e.g., at or near 1 Gbps). Various other implementations that utilize wireless links having differing levels of capacity at different points within the network arrangement are possible as well.

Returning to the overall architecture of the mesh-based communication system, in at least some implementations, the mesh-based communication system may additionally include a tier of wired communication nodes that are each installed at an infrastructure site and directly connected to at least one wireless communication node of the wireless mesh network via at least one bi-directional wired link, in which case each such wired communication node may function to exchange bi-directional network traffic with the at least one wireless communication node of the wireless mesh network. For instance, a wired communication node could potentially be connected to any of a first-tier node, a second-tier node, a third-tier node, or a fourth-tier node, although in some network arrangements, wired communication nodes may only be directly connected to nodes in certain tiers (e.g., only third-tier and/or fourth-tier nodes). Further, in most implementations, a wired communication node may function to deliver the service being provided by the mesh-based communication system (e.g., a high-speed internet service) to the wired communication node's infrastructure site, such that individuals present at the wired communication node's infrastructure site can utilize that service. A wired communication node may perform other functions as well.

The infrastructure sites at which the wired communication nodes are installed may take any of various forms, and in at least some implementations, a wired communication node's infrastructure site may comprise private property associated with a respective customer of the service being provided by the mesh-based communication system. For instance, as one possibility, a wired communication node's infrastructure site could be a residential building that is associated with a customer of the service being provided by the mesh-based communication system and provides a suitable location for installation of equipment for establishing a wired connection to at least one wireless communication node within the mesh-based communication system. For example, such a residential building could take the form of a detached single-family home, a townhouse, or a MDU where a customer of the service being provided by the mesh-based communication system resides, among other examples. In such an implementation, in addition to exchanging bi-directional network traffic with the at least one wireless communication node to which it is connected, the wired communication node installed at the residential building may also function to deliver the service being provided by the mesh-based communication system (e.g., a high-speed internet service) to the residential building such that the customer (and/or other individuals at the residential building) can make use of that service.

As another possibility, a wired communication node's infrastructure site could be a commercial building that is associated with a customer of the service being provided by the mesh-based communication system and provides a suitable location for installation of equipment for establishing a wired connection to at least one wireless communication node within the mesh-based communication system. For example, such a commercial building could take the form of an office building where a customer of the service being provided by the mesh-based communication system owns or leases office space, among other examples. In such an implementation, in addition to exchanging bi-directional network traffic with the at least one wireless communication node to which it is connected, the wired communication node installed at the commercial building may also function to deliver the service being provided by the mesh-based communication system (e.g., a high-speed internet service) to the commercial building such that the customer (and/or other individuals at the commercial building) can make use of that service.

A wired communication node's infrastructure site could take some other form as well.

Further, the equipment for each wired communication node may take any of various forms. To begin, a wired communication node's equipment may include networking equipment (e.g., one or more modems, routers, switches, or the like) that facilitates communication between (i) any wireless communication node to which the wired communication node is connected via the at least one bi-directional wired link and (ii) other devices or systems located at the second-tier node's infrastructure site. In this respect, a wired communication node's networking equipment may be configured to establish a wired connection with the networking equipment of at least one wireless communication node via a bi-directional wired link, and correspondingly, the networking equipment of each wireless communication node that is connected to a wired communication node may be configured to facilitate communication between the wireless communication node's wireless mesh equipment and the wired communication node's networking equipment via the bi-directional wired link. Additionally, a wired communication node's equipment may include power equipment for supplying power to the networking equipment, such as power and/or battery units. A wired communication node's equipment may take various other forms as well.

Further yet, each bi-directional wired link between a wired communication node and a wireless communication node may take any of various forms. As one possibility, a bi-directional wired link between a wired communication node and a wireless communication node may take the form of a copper-based wired link, such as a coaxial cable or an Ethernet cable (e.g., an unshielded or shielded twisted-pair copper cable designed in accordance with a given Ethernet cable category), among other possibilities. As another possibility, a bi-directional wired link between a wired communication node and a wireless communication node may take the form of a fiber-based wired link, such as a glass optical fiber cable or a plastic optical fiber cable. A bi-directional wired link between a wired communication node and a wireless communication node could take other forms as well.

The communication nodes included within the mesh-based communication system may take various other forms as well.

Along with the communication nodes described above, which comprise equipment installed at infrastructure sites, the mesh-based communication system may further include end-user devices that are each capable of (i) connecting to a wireless or wired communication node of the mesh-based communication system and (ii) exchanging bi-directional network traffic over the connection with the communication node so as to enable the end-user device and its end user to utilize the service being provided by the mesh-based communication system (e.g., a high-speed internet service). These end-user devices may take any of various forms.

As one possibility, an end-user device may take the form of a computer, tablet, mobile phone, or smart home device located at an infrastructure site for a communication node of the mesh-based communication system that is connected to the communication node via networking equipment at the infrastructure site (e.g., a modem/router that provides an interface between the node's wireless mesh equipment and the end-user devices).

As another possibility, an end-user device may take the form of a mobile or customer-premises device that is capable of establishing and communicating over a direct wireless connection (e.g., via a bi-directional ptp or ptmp wireless link) with a wireless communication node of the wireless mesh network. In this respect, an end-user device may establish a direct wireless connection with any of various wireless communication nodes of the wireless mesh network, including but not limited to the wireless communication node of the wireless mesh network with which the end-user device is able to establish the strongest wireless connection regardless of tier (e.g., the wireless communication node that is physically closest to the end-user device) or the wireless communication node in a particular tier or subset of tiers (e.g., the third and/or fourth tiers) with which the end-user device is able to establish the strongest wireless connection, among other possibilities. To facilitate this functionality, at least a subset of the wireless communication nodes of the wireless mesh network may have wireless mesh equipment that, in addition to establishing and communicating over a wireless connection with one or more other wireless communication nodes, is also capable of establishing and communicating over wireless connections with end-user devices. Further, it should be understood that the particular wireless communication node of the wireless mesh network to which an end-user device is wirelessly connected may change over the course of time (e.g., if the end-user device is a mobile device that moves to a different location).

An end-user device may take other forms as well.

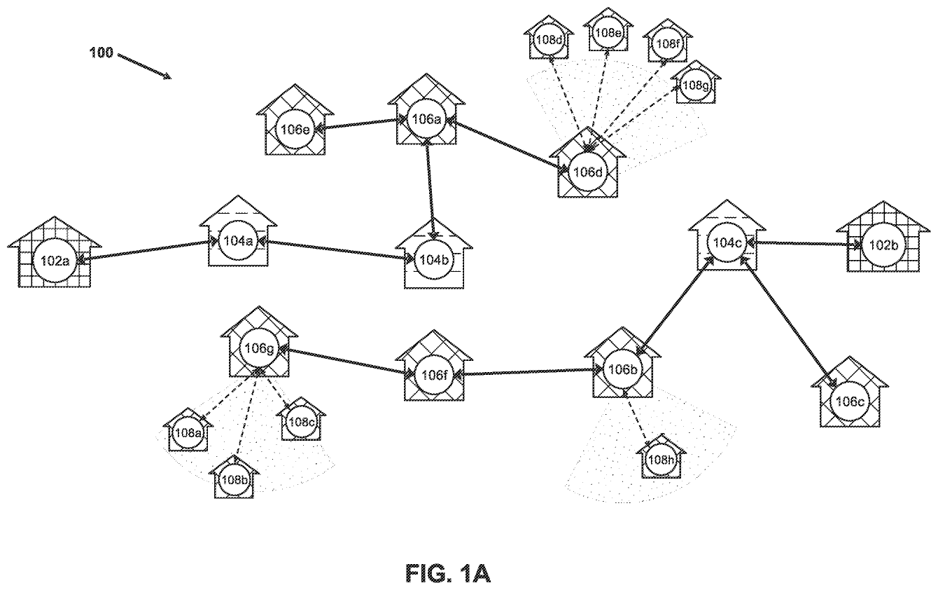

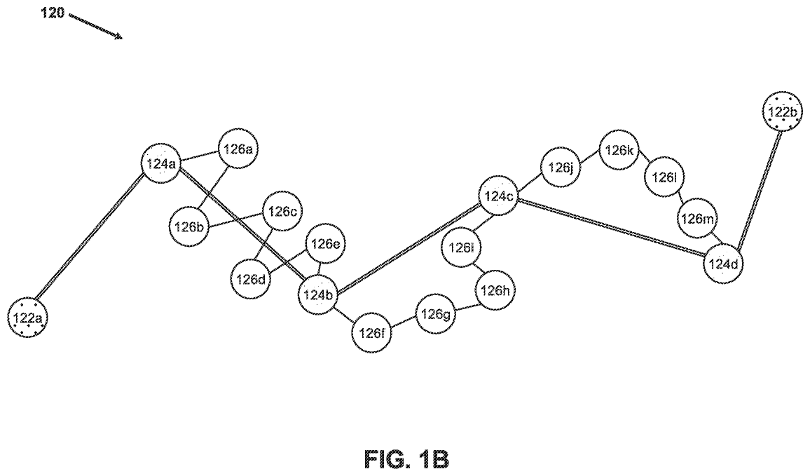

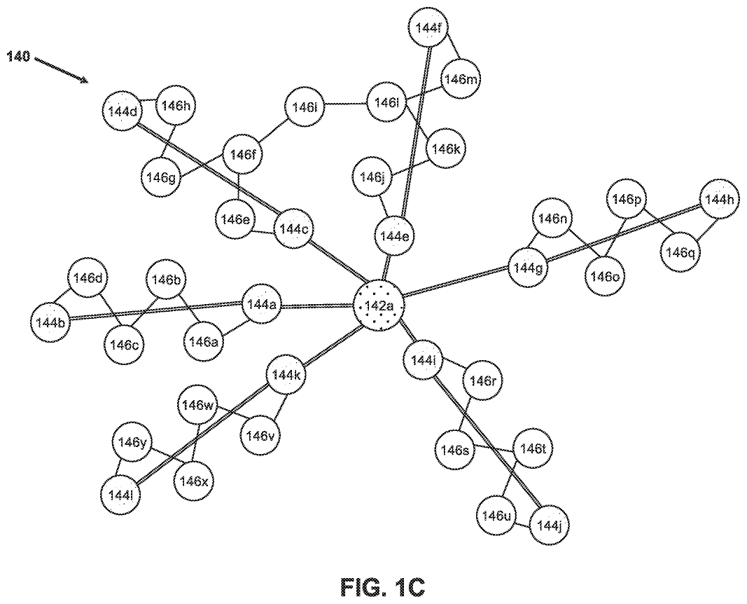

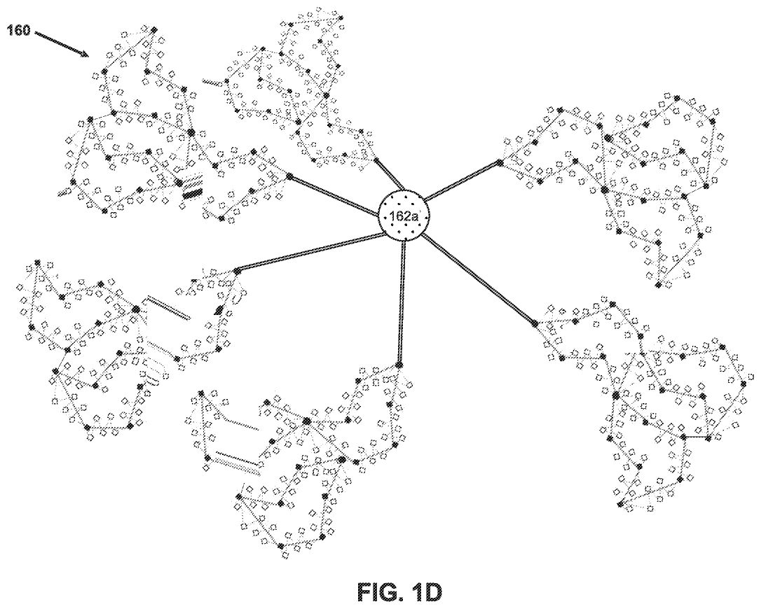

Turning now to FIGS. 1A-D, some simplified examples of portions of mesh-based communication systems designed and implemented in accordance with the present disclosure are shown. It should be understood that these simplified examples are shown for purposes of illustration only, and that in line with the discussion above, numerous other arrangements of mesh-based communication systems designed and implemented in accordance with the present disclosure are possible and contemplated herein.

To begin, FIG. 1A illustrates one simplified example 100 of a portion of a mesh-based communication system designed and implemented in accordance with the present disclosure. In line with the discussion above, this example mesh-based communication system 100 may be utilized to provide a high-speed internet service to end users, although it is possible that the mesh-based communication system could be utilized to deliver some other type of network-based service to end users as well. As shown, the example mesh-based communication system 100 may include four different tiers of wireless communication nodes that are interconnected together in order to form a wireless mesh network: (i) a first tier of nodes 102, (ii) a second tier of nodes 104, (iii) a third tier of nodes 106, and (iv) a fourth tier of nodes 108.

For instance, beginning with the first tier of nodes 102, the example mesh-based communication system 100 of FIG. 1A is shown to include two first-tier nodes 102a and 102b, each of which is installed at a commercial building that has high-capacity fiber connectivity to a core network and is connected downstream to a respective second-tier node 104 via a respective inter-tier wireless link that takes the form of a bi-directional ptp wireless link. In this respect, each of the first-tier nodes 102a and 102b may function to exchange bi-directional network traffic with (i) the core network via the high-capacity fiber connection and (ii) the respective second-tier node 104 to which the first-tier node 102 is connected over the respective wireless link. Further, one or both of the first-tier nodes 102 may function to deliver high-speed internet service to the commercial building(s) hosting the first-tier node(s) 102, which may enable one or more end-user devices at the commercial building(s) to access the high-speed internet service.

While the example mesh-based communication system 100 of FIG. 1A is shown to include two first-tier nodes 102a and 102b, it should also be understood that this is merely for purposes of illustration, and that in practice, the first tier of nodes 102 could include any number of first-tier nodes—including as little as a single first-tier node. Further, while each of the first-tier nodes 102a and 102b is shown to be connected to a single second-tier node 104, it should also be understood that this is merely for purposes of illustration, and that in practice, a first-tier node 102 could be connected to multiple second-tier nodes 104. Further yet, while each of the first-tier nodes 102a and 102b is shown to be connected downstream to a respective second-tier node 104 via a bi-directional ptp wireless link, it should be understood that a first-tier node 102 could alternatively be connected downstream to a second-tier node 104 (or perhaps multiple second-tier nodes 104) via a bi-directional ptmp wireless link.

Turning to the second tier of nodes 104, the example mesh-based communication system 100 of FIG. 1A is shown to include three second-tier nodes 104a, 104b, and 104c, each of which is installed at a residential building associated with a customer of the high-speed internet service and primarily serves to extend the high-capacity access to the core network from the first-tier nodes 102 to other geographic locations by forming high-capacity pathways (e.g., in the range of 10 Gbps) for routing aggregated network traffic that originated from or is destined to the core network. In particular, second-tier nodes 104a and 104b are shown to form a multi-hop pathway extending from first-tier node 102a, and second-tier node 104c is shown to form a single-hop pathway extending from first-tier node 102b. In this respect, (i) second-tier node 104a is connected to (and exchanges bi-directional network traffic with) first-tier node 102a via an inter-tier wireless link that takes the form of a bi-directional ptp wireless link and is connected to (and exchanges bi-directional network traffic with) peer second-tier node 102b via an intra-tier wireless link that takes the form of a bi-directional ptp wireless link, (ii) second-tier node 104b is connected to (and exchanges bi-directional network traffic with) peer second-tier node 104a via an intra-tier wireless link that takes the form of a bi-directional ptp wireless link, and (iii) second-tier node 104c is connected to (and exchanges bi-directional network traffic with) first-tier node 102b via an inter-tier wireless link that takes the form of a bi-directional ptp wireless link.

Additionally, as shown in FIG. 1A, each of at least a subset of the second-tier nodes 104a, 104b, and 104c may be directly connected downstream to one or more third-tier nodes 106. In particular, (i) second-tier node 104b is shown to be connected downstream to third-tier node 106a via an inter-tier wireless link that takes the form of a bi-directional ptmp wireless link and (ii) second-tier node 104c is shown to be connected downstream to third-tier node 106b and third-tier node 106c via respective inter-tier wireless links that each take the form of a bi-directional ptmp wireless link. In this respect, each of third-tier nodes 104b and 104c may additionally function to exchange bi-directional network traffic with one or more third-tier nodes.

Additionally, each of the second-tier nodes 104a, 104b, and 104c (or at least one of them) may function to deliver the high-speed internet service to the residential building hosting the second-tier node, which may enable one or more end-user devices at the residential building to access the high-speed internet service.

While the example mesh-based communication system 100 of FIG. 1A is shown to include three second-tier nodes 104a, 104b, and 104c, it should also be understood that this is merely for purposes of illustration, and that in practice, the second tier of nodes 104 could include any number of second-tier nodes—including as little as a single second-tier node. Further, while each of the second-tier nodes 104a, 104b, and 104c is shown to be connected to a particular set of one or more other wireless communication nodes (e.g., first-tier, second-tier, and/or third-tier nodes), it should also be understood that this is merely for purposes of illustration, and that in practice, a second-tier node 104 could be connected to any combination of one or more first-tier, second-tier, and/or third-tier nodes. Further yet, while each of the second-tier nodes 104a and 104b is shown to be connected to each other wireless communication node via a respective bi-directional ptp wireless link, it should be understood that a second-tier node 104 could alternatively be connected to one or more other wireless communication nodes via a bi-directional ptmp wireless link (or perhaps multiple bi-directional ptmp wireless links). Still further, while the second-tier nodes 104 in example mesh-based communication system 100 of FIG. 1A are shown to form one respective pathway extending from each of the first-tier nodes 102, it should be understood that example mesh-based communication system 100 of FIG. 1A could include additional second-tier nodes 104 that form additional pathways extending from either or both of the first-tier nodes 102.

Turning next to the third tier of nodes 106, the example mesh-based communication system 100 of FIG. 1A is shown to include seven third-tier nodes 106a, 106b, 106c, 106d, 106e, 106f, and 106g, each of which is installed at a residential building associated with a customer of the high-speed internet service and is connected to a second-tier node 104, one or more peer third-tier nodes 106, or a combination thereof. In particular, (i) third-tier node 106a is shown to be connected upstream to second-tier node 104b via an inter-tier wireless link that takes the form of a bi-directional ptp wireless link and is also shown to be connected to peer third-tier nodes 106d and 106e via respective intra-tier wireless links that each take the form of a bi-directional ptp wireless link, (ii) third-tier node 106b is shown to be connected upstream to second-tier node 104c via an inter-tier wireless link that takes the form of a bi-directional ptp wireless link and is also shown to be connected to peer third-tier node 106f via an intra-tier wireless link that takes the form of a bi-directional ptp wireless link, (iii) third-tier node 106c is shown to be connected upstream to second-tier node 104c via an inter-tier wireless link that takes the form of a bi-directional ptp wireless link, (iv) third-tier node 106d is shown to be connected to peer third-tier node 106a via an intra-tier wireless link that takes the form of a bi-directional ptp wireless link, (v) third-tier node 106e is shown to be connected to peer third-tier node 106a via an intra-tier wireless link that takes the form of a bi-directional ptp wireless link, (vi) third-tier node 106f is shown to be connected to peer third-tier node 106b via one intra-tier wireless link that takes the form of a bi-directional ptp wireless link and to peer third-tier node 106g via another intra-tier wireless link that takes the form of a bi-directional ptp wireless link, and (vii) third-tier node 106g is shown to be connected to peer third-tier node 106f via an intra-tier wireless link that takes the form of a bi-directional ptp wireless link. In this respect, each of the third-tier nodes 106a, 106b, 106c, 106d, 106e, 106f, and 106g may function to exchange bi-directional network traffic with a second-tier node 104, one or more peer third-tier nodes 106, or a combination thereof as part of a given sub-mesh for routing aggregated network traffic to and from endpoints within a given geographic area.

Additionally, as shown in FIG. 1A, each of at least a subset of the third-tier nodes 106a, 106b, 106c, 106d, 106e, 106f, and 106g may be directly connected downstream to one or more fourth-tier nodes 108. In particular, (i) third-tier node 106g is shown to be connected downstream to three fourth-tier nodes 108 (fourth-tier nodes 108a, 108b, and 108c) via an inter-tier wireless link that takes the form of a bi-directional ptmp wireless link, (ii) third-tier node 106d is shown to be connected downstream to four fourth-tier nodes 108 (fourth-tier nodes 108d, 108e, 108f, and 108g) via an inter-tier wireless link that takes the form of a bi-directional ptmp wireless link, and (iii) third-tier node 106b is shown to be connected downstream to a single fourth-tier node 108 (fourth-tier node 108h) via an inter-tier wireless link that takes the form of a bi-directional ptmp wireless link. In this respect, each of third-tier nodes 106g, 106d, and 106b may additionally function to exchange bi-directional network traffic with one or more fourth-tier nodes 108, which may take the form of individual network traffic that originates from or is destinated to the one or more fourth-tier nodes 108.

Additionally yet, each of the third-tier nodes 106a, 106b, 106c, 106d, 106e, 106f, and 106g (or at least a subset thereof) may function to deliver the high-speed internet service to the residential building hosting the third-tier node, which may enable one or more end-user devices at the residential building to access the high-speed internet service.

While the example mesh-based communication system 100 of FIG. 1A is shown to include six third-tier nodes 106a, 106b, 106c, 106d, 106e, 106f, and 106g, it should also be understood that this is merely for purposes of illustration, and that in practice, the third tier of third-tier nodes 106 could include any number of third-tier nodes—including as little as a single third-tier node. Further, while each of the third-tier nodes 106a, 106b, 106c, 106d, 106e, 106f, and 106g is shown to be connected to a particular set of one or more other wireless communication nodes (e.g., second-tier, third-tier, and/or fourth-tier nodes), it should also be understood that this is merely for purposes of illustration, and that in practice, a third-tier node 106 could be connected to any combination of one or more second-tier, third-tier, and/or fourth-tier nodes. Further yet, while each of at least a subset of the third-tier nodes 106a, 106b, 106c, 106d, 106e, 106f, and 106g is shown to be connected downstream to one or more fourth-tier nodes 108 via a bi-directional ptmp wireless link, it should be understood that a third-tier node 106 could alternatively be connected downstream to one or more fourth-tier nodes 108 via one or more bi-directional ptp wireless links.

Turning lastly to the fourth tier of nodes 108, the example mesh-based communication system 100 of FIG. 1A is shown to include eight fourth-tier nodes 108a, 108b, 108c, 108d, 108e, 108f, 108g, and 108h, each of which is installed at a residential building associated with a customer of the high-speed internet service and is directly connected upstream to a respective third-tier node 106 via a respective bi-direction ptmp wireless link. In particular, (i) fourth-tier nodes 108a, 108b, and 108c are shown to be connected upstream to the third-tier node 106g via an inter-tier wireless link that takes the form of a bi-direction ptmp wireless link, (ii) fourth-tier nodes 108d, 108e, 108f, and 108g are shown to be connected upstream to the third-tier node 106d via an inter-tier wireless link that takes the form of a bi-direction ptmp wireless link, and (iii) fourth-tier node 108h is shown to be connected upstream to the third-tier node 106b via an inter-tier wireless link that takes the form of a bi-direction ptmp wireless link. In this respect, each of fourth-tier nodes 108a, 108b, 108c, 108d, 108e, 108f, 108g, and 108h may function to exchange bi-directional network traffic with a given third-tier node 106, which may take the form of individual network traffic that originates from or is destinated to the fourth-tier node 108.

Further, each of the fourth-tier nodes 108a, 108b, 108c, 108d, 108e, 108f, 108g, and 108h (or at least a subset thereof) may function to deliver the high-speed internet service to the residential building hosting the fourth-tier node, which may enable one or more end-user devices at the residential building to access the high-speed internet service.

While the example mesh-based communication system 100 of FIG. 1A is shown to include eight fourth-tier nodes 108a, 108b, 108c, 108d, 108e, 108f, 108g, and 108h, it should also be understood that this is merely for purposes of illustration, and that in practice, the fourth tier of fourth-tier nodes 108 could include any number of fourth-tier nodes—including as little as a single fourth-tier node (or perhaps no fourth-tier nodes at all in some implementations). Further, while FIG. 1A shows each of the fourth-tier nodes 108a, 108b, 108c, 108d, 108e, 108f, 108g, and 108h being connected to a single third-tier node and no other wireless communication node, it should also be understood that this is merely for purposes of illustration, and that in practice, a fourth-tier node 108 could be connected to one or more other wireless communication nodes as well (e.g., another third-tier node or a downstream fourth-tier node).

In line with the discussion above, each of the bi-directional ptp and ptmp wireless links established between the wireless communication nodes in FIG. 1A may take any of various forms, and in at least one implementation, each of the bi-directional ptp and ptmp wireless links may take the form of a millimeter-wave wireless link that operates and carries traffic at frequencies in a frequency band within the millimeter-wave spectrum, which as noted above may advantageously provide both a high capacity (e.g., at least 1 Gbps) and a low latency (e.g., less than 1 millisecond for ptp wireless links and less than 4 milliseconds for ptmp wireless links). However, the bi-directional ptp and ptmp wireless links may take other forms as well.

Further, in line with the discussion above, the bi-directional wireless links between and among the different tiers of nodes within the example mesh-based communication system 100 of FIG. 1A may have differing levels of capacity (and perhaps also differing maximum lengths). For instance, the ptp wireless links between first-tier nodes 102 and second-tier nodes 104 as well as between peer second-tier nodes 104 may each comprise a high-capacity wireless link having a highest capacity level (e.g., at or near 10 Gbps or perhaps even higher), the ptp wireless links between second-tier nodes 104 and third-tier nodes 106 as well as between peer third-tier nodes 106 may each comprise a high-capacity wireless link having a second highest capacity level (e.g., at or near 2.5 Gbps), and the ptmp wireless links between third-tier nodes 106 and fourth-tier nodes 108 may each comprise a high-capacity wireless link having a third highest capacity level (e.g., at or near 1 Gbps). However, the bi-directional ptp and ptmp wireless links may have different capacity levels as well.

Further yet, in line with the discussion above, the wireless mesh network of the example mesh-based communication system 100 of FIG. 1A may be considered to have two different “layers” (or “segments”) of bi-directional wireless links: (1) a ptp layer comprising the mesh of bi-directional ptp wireless links between and among the first-tier nodes, second-tier nodes, and third-tier nodes, and (2) a ptmp layer comprising the bi-directional ptmp wireless links between the third tier of nodes and the fourth tier of nodes. In this respect, the ptp layer of the example mesh-based communication system 100 of FIG. 1A may serve as a “backbone” for the wireless mesh network that is configured to carry network traffic that takes the form of aggregated mesh access traffic (e.g., network traffic that originates from or is destined to multiple different endpoints), whereas the ptmp layer of the example mesh-based communication system 100 of FIG. 1A may serve to extend the mesh of bi-directional ptp wireless links by carrying network traffic that takes the form of individual mesh access traffic (e.g., network traffic intended for an individual endpoint node within the wireless mesh network).

The example mesh-based communication system 100 may include various other communication nodes and/or take various other forms as well.

FIG. 1B illustrates another simplified example 120 of a portion of a mesh-based communication system designed and implemented in accordance with the present disclosure. As shown, the example mesh-based communication system 120 may include three different tiers of wireless communication nodes that are interconnected together in order to form a wireless mesh network: (i) a first tier of nodes 122 shown in dark gray, (ii) a second tier of nodes 124 shown in light gray, and (iii) a third tier of nodes 126 shown in white. However, it should be understood that the example mesh-based communication system 120 could be extended to include a fourth tier of wireless communication nodes. In line with the discussion above, each of depicted wireless communication nodes comprises equipment installed at a respective infrastructure site, but to simplify the illustration, the respective infrastructure sites of the nodes are not depicted in FIG. 1B.

As shown in FIG. 1B, this portion of the example mesh-based communication system 120 may include (i) two first-tier nodes 122a and 122b that have high-capacity fiber connectivity to a core network, (ii) a set of four second-tier nodes 124a-d that form a high-capacity, multi-hop pathway comprising a chain of 5 bi-directional ptp wireless links (i.e., a spine) that extends between the two first-tier nodes 122a and 122b and serves to route aggregated network traffic originating from or destined to the core network, where each of the second-tier nodes 124a-d functions to route network traffic in either of two direction along the multi-hop pathway (e.g., either to the left or to the right in FIG. 1B depending on the origin and destination of the network traffic), and (iii) a number of third-tier nodes 126a-m that, together with the second-tier nodes 124a-d, form one or more discrete sub-meshes of bi-directional ptp wireless links for routing aggregated network traffic to and from endpoints in one or more geographic areas, which in FIG. 1B may be co-extensive with the third-tier nodes 126a-m given that the example mesh-based communication system 120 is not shown to include any other downstream nodes such as fourth-tier nodes.

In line with the discussion above, each of the bi-directional ptp wireless links established between the wireless communication nodes in FIG. 1B may take any of various forms, and in at least one implementation, each of the bi-directional ptp wireless links may take the form of a millimeter-wave wireless link that operates and carries traffic at frequencies in a frequency band within the millimeter-wave spectrum. Further, in line with the discussion above, the bi-directional ptp wireless links at different points within the example mesh-based communication system 160 could have differing levels of capacity (and perhaps also differing maximum lengths). For instance, the bi-directional ptp wireless links included in the chain of bi-directional ptp wireless links extending between first-tier nodes 122a and 122b through second-tier nodes 124a-d may each comprise a high-capacity wireless link having a first capacity level (e.g., at or near 10 Gbps or perhaps even higher) and a first maximum length, while the ptp wireless links that form the one or more sub-meshes between and among the second-tier nodes 124 and third-tier nodes 126 may each comprise a high-capacity wireless link having a second capacity level that is lower than the first capacity level (e.g., at or near 2.5 Gbps) and a second maximum length that is lower than the first maximum length. However, the bi-directional wireless links established between the wireless communication nodes in FIG. 1B may take various other forms as well—including but not limited to the possibility that some or all of the bi-directional wireless links between the wireless communication nodes may comprise ptmp wireless links rather than ptp wireless links.

The example mesh-based communication system 120 may include various other communication nodes and/or take various other forms as well.

FIG. 1C illustrates another simplified example 140 of a portion of a mesh-based communication system designed and implemented in accordance with the present disclosure. As shown, similar to the example mesh-based communication system 120 of FIG. 1B, the example mesh-based communication system 140 of FIG. 1C may include three different tiers of wireless communication nodes that are interconnected together in order to form a wireless mesh network: (i) a first tier of nodes 142 shown in dark gray, (ii) a second tier of nodes 144 shown in light gray, and (iii) a third tier of nodes 146 shown in white. However, it should be understood that the example mesh-based communication system 140 could also be extended to include a fourth tier of wireless communication nodes. In line with the discussion above, each of the depicted nodes comprises equipment installed at a respective infrastructure site, but to simplify the illustration, the respective infrastructure sites of the nodes are not depicted in FIG. 1C.

As shown in FIG. 1C, this portion of the example mesh-based communication system 140 may include (i) one first-tier node 142a that has high-capacity fiber connectivity to a core network, (ii) six different subsets of second-tier nodes 144 (e.g., 144a-b, 144c-d, 144e-f, 144g-h, 144i-j, and 144k-1) that form six high-capacity, multi-hop pathways extending from first-tier node 142a (i.e., six “spines”), where each such pathway comprises a chain of bi-directional ptp wireless links, and (iii) a number of third-tier nodes 146a-y that, together with the second-tier nodes 144a-1, form discrete sub-meshes of bi-directional ptp wireless links for routing aggregated network traffic to and from endpoints in one or more geographic areas, which in FIG. 1C may be co-extensive with the third-tier nodes 146a-y given that the example mesh-based communication system 140 is not shown to include any other downstream nodes such as fourth-tier nodes.

As further shown in FIG. 1C, certain of the high-capacity, multi-hop pathways may also be interconnected to one another via a sub-mesh of second-tier 144 and third-tier nodes 146 that extends from second-tier nodes 144 along both pathways. In particular, the two high-capacity, multi-hop pathways formed by second-tier nodes 144c-d and second-tier nodes 144e-f are shown to be interconnected to one another via a sub-mesh comprising those second-tier nodes as well as third-tier nodes 146e-m, which enables bi-directional network traffic originating from or destined to the core network to be exchanged with the third-tier nodes 146e-m in this sub-mesh along either of these two high-capacity pathways and also allows bi-directional network traffic to be exchanged between these two high-capacity pathways, which may provide redundancy, reduce latency, and/or allow load balancing to be applied between the two high-capacity pathways, among other advantages. Although not shown in FIG. 1C, it is also possible that second-tier nodes 144 along different high-capacity pathways may also be directed connected via a ptp wireless link.

In line with the discussion above, each of the bi-directional ptp wireless links established between the wireless communication nodes in FIG. 1C may take any of various forms, and in at least one implementation, each of the bi-directional ptp wireless links may take the form of a millimeter-wave wireless link that operates and carries traffic at frequencies in a frequency band within the millimeter-wave spectrum. Further, in line with the discussion above, the bi-directional ptp wireless links at different points within the example mesh-based communication system 160 could have differing levels of capacity (and perhaps also differing maximum lengths). For instance, the bi-directional ptp wireless links included in each chain of bi-directional ptp wireless links extending from first-tier node 142a through a respective subset of second-tier nodes 144 may each comprise a high-capacity wireless link having a first capacity level (e.g., at or near 10 Gbps or perhaps even higher) and a first maximum length, while the ptp wireless links that form the sub-meshes between and among the second-tier nodes 144 and third-tier nodes 146 may each comprise a high-capacity wireless link having a second capacity level that is lower than the first capacity level (e.g., at or near 2.5 Gbps) and a second maximum length that is lower than the first maximum length. However, the bi-directional wireless links established between the wireless communication nodes in FIG. 1C may take various other forms as well—including but not limited to the possibility that some or all of the bi-directional wireless links between the wireless communication nodes may comprise ptmp wireless links rather than ptp wireless links.

The example mesh-based communication system 140 may include various other communication nodes and/or take various other forms as well.

FIG. 1D illustrates another simplified example 160 of a portion of a mesh-based communication system designed and implemented in accordance with the present disclosure. As shown, similar to the example mesh-based communication systems 120 and 140 of FIGS. 1B-1C, the example mesh-based communication system 160 of FIG. 1D may include three different tiers of wireless communication nodes that are interconnected together in order to form a wireless mesh network: (i) a first tier of nodes shown in dark gray, (ii) a second tier of nodes shown as black circles or squares, and (iii) a third tier of nodes shown as white squares. However, it should be understood that the example mesh-based communication system 160 could also be extended to include a fourth tier of wireless communication nodes. In line with the discussion above, each of the depicted nodes comprises equipment installed at a respective infrastructure site, but to simplify the illustration, the respective infrastructure sites of the nodes are not depicted in FIG. 1D.

As shown in FIG. 1D, this portion of the example mesh-based communication system 120 may include (i) one first-tier node 162a that has high-capacity fiber connectivity to a core network, (ii) six different clusters of second-tier nodes that form six clusters of high-capacity, multi-hop pathways extending from first-tier node 162a, where each such pathway comprises a chain of bi-directional ptp wireless links and may overlap in part with another pathway in the same cluster (e.g., the first portion of two pathways may comprise the same bi-directional ptp wireless links established by the same second-tier nodes but may then branch out into different directions and thereby form separate but overlapping high-capacity pathways for routing aggregated network traffic originating from or destined to the core network), and (iii) six different clusters of third-tier nodes that, together with the second-tier nodes in the respective clusters, form discrete sub-meshes of bi-directional ptp wireless links for routing aggregated network traffic to and from endpoints in one or more geographic areas, which in FIG. 1D may be co-extensive with the third-tier nodes given that the example mesh-based communication system 160 is not shown to include any other downstream nodes such as fourth-tier nodes.

In line with the discussion above, each of the bi-directional ptp wireless links established between the wireless communication nodes in FIG. 1D may take any of various forms, and in at least one implementation, each of the bi-directional ptp wireless links may take the form of a millimeter-wave wireless link that operates and carries traffic at frequencies in a frequency band within the millimeter-wave spectrum.

Further, in line with the discussion above, the bi-directional ptp wireless links at different points within the example mesh-based communication system 160 could have differing levels of capacity (and perhaps also differing maximum lengths). For instance, in one implementation, the ptp wireless links established between first-tier node 162a and a first second-tier node in each subset (shown as a black circle) may each comprise a high-capacity wireless link having a first capacity level (e.g., a capacity greater than 10 Gbps) and a first maximum length (e.g., a length within a range of 1-2 miles), the other ptp wireless links included in each high-capacity pathway extending from first-tier node 162a through a respective subset of second-tier nodes may each comprise a high-capacity wireless link having a second capacity level that is lower than the first capacity level (e.g. at or near 10 Gbps) and perhaps also a second maximum length that is lower than the first maximum length, and the ptp wireless links that form the sub-meshes between and among the second-tier nodes and third-tier nodes may each comprise a high-capacity wireless link having a third capacity level that is lower than the first and second capacity levels (e.g. at or near 2.5 Gbps) and perhaps also a third maximum length that is lower than the first and second maximum lengths. However, in other implementations, the first and second capacity levels and/or the first and second maximum lengths could be the same. The bi-directional wireless links established between the wireless communication nodes in FIG. 1D may take various other forms as well—including but not limited to the possibility that some or all of the bi-directional wireless links between the wireless communication nodes may comprise ptmp wireless links rather than ptp wireless links.

Further yet, although not shown in FIG. 1D, the wireless communication nodes in the example mesh-based communication system 160 may be interconnected in other manners as well. For instance, as one possibility, certain second-tier and/or third-tier nodes from the different clusters could be interconnected together via bi-directional ptp wireless links. As another possibility, first-tier node 162a could be connected to one or more additional second-tier nodes in a given cluster via one or more bi-directional ptp wireless links, such as second-tier node that is situated at different place within the cluster, which may provide redundancy, reduce latency, and/or allow load balancing to be applied for aggregated network traffic between the given cluster and first-tier node 162a, among other advantages. In such an implementation, it is possible that, in order to reach an additional second-tier node in a cluster, the additional bi-directional ptp wireless link between first-tier node 162a and the additional second-tier node may need to exceed a maximum length threshold at which bi-directional ptp wireless link is expected to reliably carry network traffic and may be liable to degrade below and acceptable in certain scenarios (e.g., when certain environmental conditions such as rain or snow are present), in which case first-tier node 162a and a given subset of the second-tier and third-tier nodes in the given cluster may function to exchange network traffic utilizing the bi-directional ptp wireless link with the additional second-tier node in the given cluster when it is available and to exchange network traffic utilizing the bi-directional ptp wireless link with the first second-tier node in the given cluster.

The example mesh-based communication system 160 may include various other communication nodes and/or take various other forms as well.

### II. Wireless Communication Nodes

As discussed above, each wireless communication node in a mesh-based communication system may comprise respective equipment for operating as part of the wireless mesh network that has been installed at a respective infrastructure site. For instance, as discussed above, a wireless communication node may include (i) wireless mesh equipment for establishing and communicating over one or more bi-directional ptp and/or ptmp wireless links with one or more other wireless communication nodes, (ii) networking equipment that facilitates communication between the node's wireless mesh equipment and other devices or systems located at the node's infrastructure site, and (iii) power equipment for supplying power to the node's wireless mesh equipment and/or the node's networking equipment, among other possibilities.

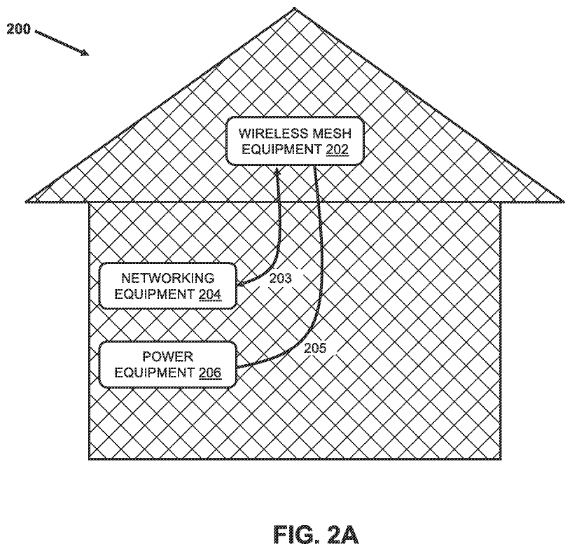

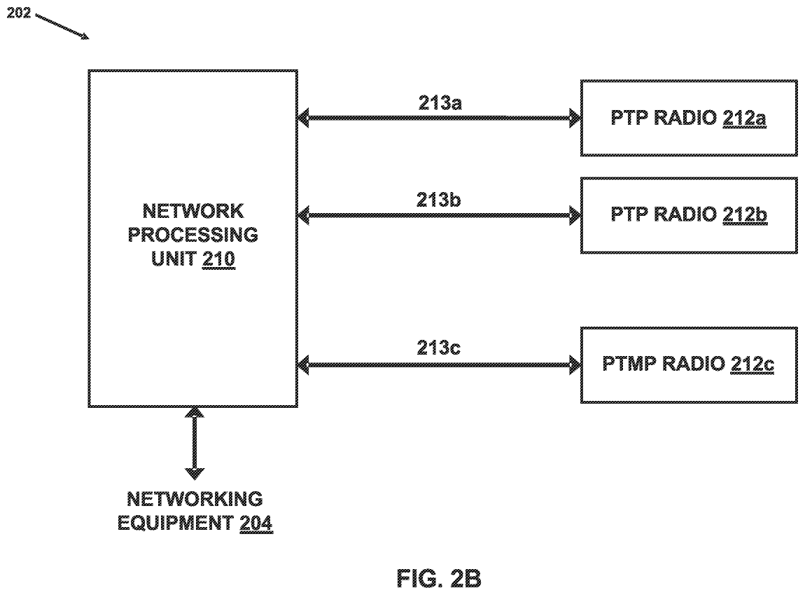

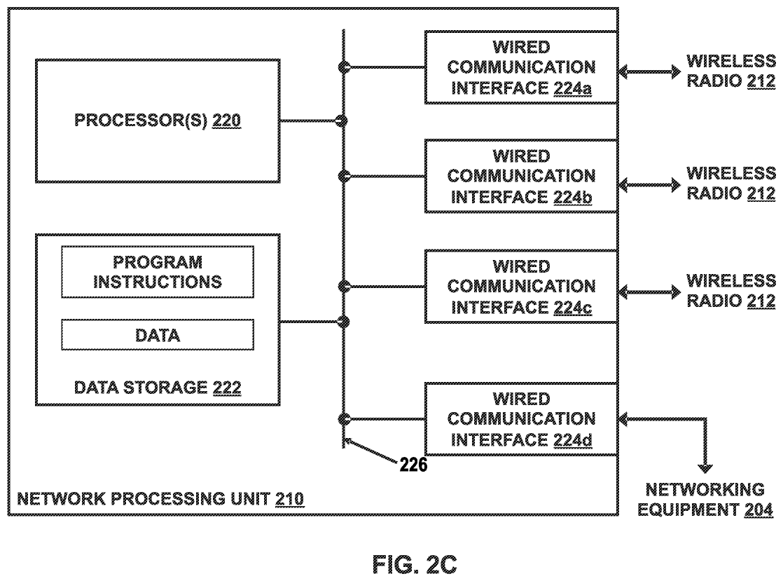

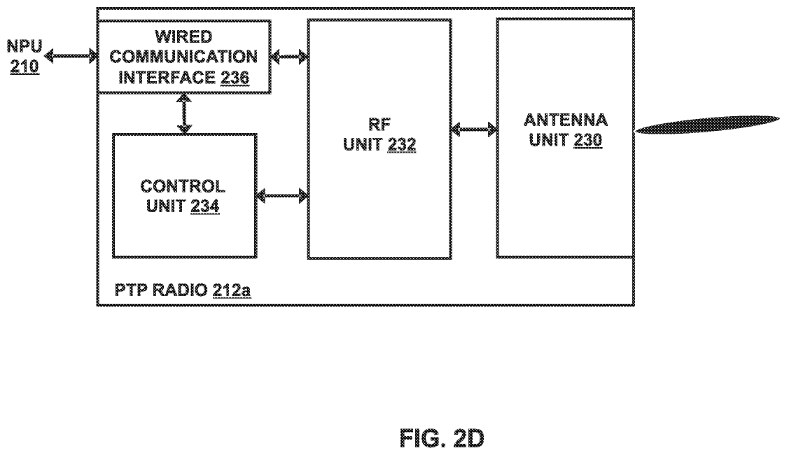

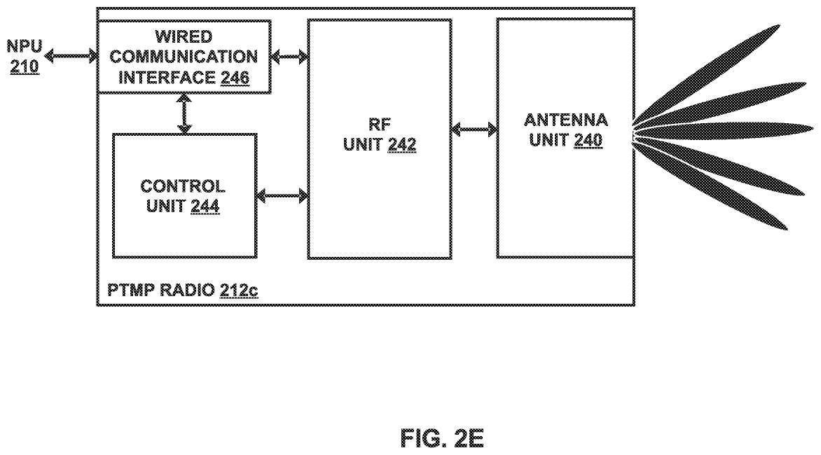

One illustrative example of a wireless communication node 200 in a mesh-based communication system is depicted in FIG. 2A. As shown in FIG. 2A, the example wireless communication node 200 comprises equipment installed at commercial or residential building (among other possible examples of an infrastructure site) that takes the form of (i) wireless mesh equipment 202 installed on a roof of the building, (ii) networking equipment 204 installed inside the building that is connected to wireless mesh equipment 202 via a communication link 203, and (iii) power equipment 206 installed inside the building that is connected to the wireless mesh equipment 202 (and perhaps also the networking equipment 204) via a power cable 205. Although not shown, the example wireless communication node 200 may comprise other types of equipment installed at an infrastructure site as well.

In line with the discussion above, the wireless mesh equipment 202 may generally comprise equipment for establishing and communicating over one or more bi-directional ptp and/or ptmp wireless links with one or more other wireless communication nodes of a wireless mesh network. Such wireless mesh equipment 202 may take any of various forms, which may depend in part on where the wireless communication node 200 is situated within a mesh-based communication system's architecture. However, at a high level, the wireless mesh equipment 202 for each wireless communication node of a mesh-based communication system may include at least (i) one or more wireless radios and (ii) at least one network processing unit (NPU).

The example wireless communication node's one or more wireless radios may each comprise a ptp or ptmp radio that is generally configured to establish a respective bi-directional ptp or ptmp wireless link with at least one other ptp or ptmp radio and then wirelessly transmit and receive network traffic over the respective bi-directional ptp or ptmp wireless link. For instance, the node's one or more wireless radios may comprise (i) one or more ptp radios that are each configured to establish and wirelessly exchange bi-directional network traffic over a respective bi-directional ptp wireless link, (ii) one or more ptmp radios that are each configured to establish and wirelessly exchange bi-directional network traffic over a respective bi-directional ptmp wireless link, or (iii) some combination of one or more ptp radios and one or more ptmp radios.

To illustrate with an example in the context of the example mesh-based communication system 100 of FIG. 1A, (i) a first subset of the wireless communication nodes may be equipped with one or more ptp radios only, including first-tier nodes 102a and 102a (one ptp radio each), second-tier nodes 104a and 104b (two ptp radios each), second-tier node 104c (three ptp radios), and third-tier nodes 106a (three ptp radios), 106c (one ptp radio), 106e (one ptp radio), and 106f (two ptp radios), (ii) a second subset of the wireless communication nodes may be equipped with a combination of one or more ptp radios and one or more ptmp radios, including third-tier node 106b (two ptp radios and one ptmp radio), third-tier node 106d (one ptp radio and one ptmp radio), and third-tier node 106g (one ptp radio and one ptmp radio), and (iii) a third subset of the wireless communication nodes may be equipped with one or more ptmp radios only, including each of the fourth-tier nodes 108.

In turn, the example wireless communication node's at least one NPU may generally be configured to perform various functions in order to facilitate the node's operation as part of the wireless mesh network. For instance, as one possibility, the node's at least one NPU may be configured to process network traffic that is received from one or more other wireless communication nodes via the node's one or more wireless radios (e.g., by performing baseband processing) and then cause that received network traffic to be routed in the appropriate manner. For example, if the received network traffic comprises aggregated network traffic destined for another endpoint, the node's at least one NPU may process the received network traffic and then cause the node's one or more wireless radios to transmit the received network traffic to the one or more other wireless communication nodes. As another example, if the received network traffic comprises individual network traffic destined for an end-user device within the building, the node's at least one NPU may process the received network traffic and then cause it to be delivered to the end-user device via the node's networking equipment 204. As yet another example, if the node 200 comprises a first-tier node and the received network traffic comprises aggregated network traffic that is to be sent over a wired link between the first-tier node and the core network, the node's at least one NPU may process the received network traffic and then cause it to be sent to the core network over the fiber link between the first-tier node and the core network (e.g., via the node's networking equipment 204 or via a core-network interface included within the at least one NPU itself). As still another example, if the received network traffic comprises network traffic destined for a wired communication node connected to the node 200, the node's at least one NPU may process the received network traffic and then cause it to be sent to the wired communication node over the wired link between the node 200 and the wired communication node (e.g., either via the node's networking equipment 204 or via a wired interface included within the at least one NPU itself). The at least one NPU's processing and routing of network traffic that is received from one or more other wireless communication nodes via the node's one or more wireless radios may take other forms as well.

As another possibility, the node's at least one NPU may be configured to process network traffic that is received from the node's networking equipment 204 (e.g., by performing baseband processing) and then cause that received network traffic to be routed in the appropriate manner. For example, if the network traffic received from the node's networking equipment 204 comprises network traffic that originated from an end-user device within the building, the node's at least one NPU may process the received network traffic and then cause the node's one or more wireless radios to transmit the received network traffic to the one or more other wireless communication nodes. As another example, if the node 200 comprises a first-tier node and the network traffic received from the node's networking equipment 204 comprises network traffic that was received over a fiber link with the core network, the node's at least one NPU may process the received network traffic and then cause the node's one or more wireless radios to transmit the received network traffic to the one or more other wireless communication nodes. As yet another example, if the network traffic received from the node's networking equipment 204 comprises network traffic that was received over a wired link with a wired communication link, the node's at least one NPU may process the received network traffic and then cause the node's one or more wireless radios to transmit the received network traffic to the one or more other wireless communication nodes. Other examples are possible as well.

As yet another possibility, the node's at least one NPU may be configured to engage in communication with a centralized computing platform, such as a network management system (NMS) or the like, in order to facilitate any of various network management operations for the mesh-based communication system. For instance, the node's at least one NPU may be configured to transmit information about the configuration and/or operation of the node to the centralized platform via the wireless mesh network and/or receive information about the configuration and/or operation of the node from the centralized platform via the wireless mesh network, among other possibilities.

The example wireless communication node's at least one NPU may be configured to perform other functions in order to facilitate the node's operation as part of the wireless mesh network as well.

In a preferred embodiment, a wireless communication node's at least one NPU may comprise one centralized NPU that is physically separate from the node's one or more wireless radios and interfaces with each of the node's one or more wireless radios via a respective wired link that extends from the centralized NPU to each physically-separate wireless radio, which may take the form of a copper-based wired link (e.g., a coaxial cable, Ethernet cable, a serial bus cable, or the like) or a fiber-based wired link (e.g., a glass optical fiber cable, a plastic optical fiber cable, or the like). To illustrate with an example, if a wireless communication node's wireless mesh equipment 200 includes three wireless radios, such a centralized NPU may connect to a first one of the wireless radios via a first wired link, connect to a second one of the wireless radios via a second wired link, and connect to a third one of the wireless radios via a third wired link. Many other examples are possible as well. In such embodiment, the centralized NPU may be housed in one enclosure, and each of the one or more wireless radios may be housed in a separate enclosure, where each such enclosure may be designed for outdoor placement (e.g., on a roof of a building) and the wired links may likewise be designed for outdoor placement. However, other physical arrangements are possible as well.

In other embodiments, a wireless communication node's at least one NPU may comprise one centralized NPU that is included within the same physical housing as the node's one or more wireless radios and interfaces with each of the node's one or more wireless radios via a respective wired link that extends from the centralized NPU to each wireless radio within the shared housing, which may take the form of a copper-based wired link (e.g., a coaxial cable, Ethernet cable, serial bus cable, or the like) or a fiber-based wired link (e.g., a glass optical fiber cable, a plastic optical fiber cable, or the like). In such an embodiment, the centralized NPU and the one or more wireless radios may all be housed in a single enclosure, which may be designed for outdoor placement (e.g., on a roof of a building). However, other physical arrangements are possible as well.

In still other embodiments, instead of a centralized NPU, a wireless communication node's at least one NPU could comprise a collection of radio-specific NPUs that are each integrated into a respective one of the node's one or more wireless radios, in which case the collection of radio-specific NPUs may be interconnected with one another in some manner (e.g., via wired links) and may coordinate with one another in order to carry out the NPU functionality described above for the wireless communication node 200. In such an embodiment, each of the one or more wireless radios may be housed in a separate enclosure, where each such enclosure may be designed for outdoor placement (e.g., on a roof of a building). However, other physical arrangements are possible as well.

Other embodiments of the example wireless communication node's at least one NPU may be possible as well—including but not limited to embodiments in which the example wireless communication node includes multiple physically-separate, centralized NPUs that collectively interface with the node's one or more wireless radios and are configured to collectively carry out the NPU functionality described above for the wireless communication node 200 (e.g., in scenarios where additional processing power is needed).

One illustrative example of the wireless mesh equipment 202 of FIG. 2A is depicted in FIG. 2B. As shown in FIG. 2B, the example wireless mesh equipment 202 may include a centralized NPU 210 that is connected to multiple physically-separate wireless radios 212 via respective wired links 213, which are shown to include (i) a first ptp radio 212a that is connected to centralized NPU 210 via a first wired link 213a, (ii) a second ptp radio 212b that is connected to centralized NPU 210 via a second wired link 213b, and (iii) a ptmp radio 212c that is connected to centralized NPU 210 via a third wired link 213c. In practice, such an arrangement of wireless radios may be most applicable to a third-tier node that is connected to two second-tier and/or peer third-tier nodes via two bi-directional ptp wireless links and is also connected to one or more fourth-tier nodes via a bi-directional ptmp wireless link. However, as discussed above, the example wireless mesh equipment 202 could include any number of ptp and/or ptmp radios, which may depend in part on where the example wireless communication node 200 is situated with the mesh-based communication system's architecture.

In general, centralized NPU 210 may comprise a set of compute resources (e.g., one or more processors and data storage) that is installed with executable program instructions for carrying out the NPU functions discussed above, along with a set of communication interfaces that are configured to facilitate the centralized NPU's communication with the wireless radios 212 and the node's network equipment 204. One possible example of such a centralized NPU 210 is depicted in FIG. 2C. As shown in FIG. 2C, example centralized NPU 210 may include one or more processors 220, data storage 222, and a set of communication interfaces 224, all of which may be communicatively linked by a communication link 226 that may take the form of a system bus, a communication network such as a public, private, or hybrid cloud, or some other connection mechanism. Each of these components may take various forms.

The one or more processors 220 may each comprise one or more processing components, such as general-purpose processors (e.g., a single- or a multi-core central processing unit (CPU)), special-purpose processors (e.g., a graphics processing unit (GPU), application-specific integrated circuit, or digital-signal processor), programmable logic devices (e.g., a field programmable gate array), controllers (e.g., microcontrollers), and/or any other processor components now known or later developed.

In turn, the data storage 222 may comprise one or more non-transitory computer-readable storage mediums that are collectively configured to store (i) program instructions that are executable by one or more processors 220 such that centralized NPU 210 is configured to perform any of the various NPU functions disclosed herein, and (ii) data that may be received, derived, or otherwise stored, for example, in one or more databases, file systems, repositories, or the like, by centralized NPU 210, in connection with performing any of the various functions disclosed herein. In this respect, the one or more non-transitory computer-readable storage mediums of the data storage 222 may take various forms, examples of which may include volatile storage mediums such as random-access memory, registers, cache, or the like, and non-volatile storage mediums such as read-only memory, a hard-disk drive, a solid-state drive, flash memory, an optical-storage device, or the like, among other possibilities. It should also be understood that certain aspects of the data storage 222 may be integrated in whole or in part with the one or more processors 220.

Turning now to the set of communication interfaces 224, in general, each such communication interface 224 may be configured to facilitate wireless or wired communication with some other aspect of the example wireless communication node's equipment, such as a wireless radio 212 or the node's network equipment 204. For instance, FIG. 2C shows the set of communication interfaces 224 of the centralized NPU 210 to include at least (i) a first wired communication interface 224a for interfacing with a first wireless radio 212 via a first wired link, (ii) a second wired communication interface 224b for interfacing with a second wireless radio 212 via a second wired link, (iii) a third wired communication interface 224c for interfacing with a third wireless radio 212 via a third wired link, and (iv) a fourth wired communication interface 224d for interfacing with the node's networking equipment 204 via a fourth wired link. However, the set of communication interfaces 224 may include various other arrangements of wired interfaces as well, including more or fewer communication interfaces for wireless radios and/or other communication interfaces for networking equipment. In line with the discussion above, each of these wired communication interfaces 224 may take any of various forms, examples of which may include a coaxial interface, an Ethernet interface, a serial bus interface (e.g., PCI/PCIe, Firewire, USB, Thunderbolt, etc.), a glass optical fiber interface, or a plastic optical fiber interface, among other possibilities. Further, in some embodiments, certain of these wired communication interfaces 224 could be replaced with a wireless communication interface, which may take the form of a chipset and antenna adapted to facilitate wireless communication according to any of various wireless protocols (e.g., Wi-Fi or point-to-point protocols). Further yet, if the node 200 is a first-tier node, the set of communication interfaces 224 may include an additional wired interface for communicating with the core network, which may take any of various forms, including but not limited to an SFP/SFP+ interface. The set of communication interfaces 224 may include other numbers of wired communication interfaces and/or may take various other forms as well.

Although not shown in FIG. 2C, centralized NPU 210 may also include or have an interface for connecting to one or more user-interface components that facilitate user interaction with centralized NPU 210, such as a keyboard, a mouse, a trackpad, a display screen, a touch-sensitive interface, a stylus, a virtual-reality headset, and/or one or more speaker components, among other possibilities.

Example centralized NPU 210 may include various other components and/or take various other forms as well.

Returning to FIG. 2B, in general, each ptp radio included within the example wireless communication equipment 202 (e.g., each of ptp radios 212a and 212b) may include components that enable the ptp radio to establish a bi-directional ptp wireless link with another ptp radio and then wirelessly transmit and receive network traffic over the established bi-directional ptp wireless link with another wireless communication node. These components may take any of various forms. One possible example of the components that may be included in an example ptp radio, such as ptp radio 212a, is depicted in FIG. 2D. As shown in FIG. 2D, example ptp radio 212a may include at least (i) an antenna unit 230, (ii) a radio frequency (RF) unit 232, (iii) a control unit 234, and (iv) a wired communication interface 236, among other possible components. Each of these components may take various forms.

The antenna unit 230 of example ptp radio 212a may generally comprise a directional antenna that is configured to transmit and receive directional radio signals having a particular beamwidth, which may take any of various forms in accordance with the present disclosure. For instance, as one possibility, the beamwidth of the directional radio signals that are transmitted and received by the example ptp radio's antenna unit 230 may have a beamwidth considered to be extremely narrow, such as a 3 dB-beamwidth in both the horizontal and vertical directions that is less than 5 degrees, or in some cases, even less than 1 degree. As another possibility, the beamwidth of the directional radio signals that are transmitted and received by the example ptp radio's antenna unit 230 may have a beamwidth that is considered to be narrow, but not necessary extremely narrow, such as a 3 dB-beamwidth in both the horizontal and vertical directions that is within a range of 5 degrees and 10 degrees. As yet another possibility, the beamwidth of the directional radio signals that are transmitted and received by the example ptp radio's antenna unit 230 could have a beamwidth that is wider than these narrower ranges, a 3 dB-beamwidth that is greater than 10 degrees.

Further, the example ptp radio's antenna unit 230 may take any of various forms. For instance, in one implementation, the example ptp radio's antenna unit 230 may take the form of a parabolic antenna that comprises a parabolic reflector (sometimes also referred to as a parabolic dish or mirror). In another implementation, the example ptp radio's antenna unit 230 may take the form of a lens antenna. In yet another implementation, the example ptp radio's antenna unit 230 may take the form of a phased array antenna that comprises multiple individual antenna elements arranged in an array, in which case the antenna unit 230 may also include or be combined with a beam-narrowing unit (e.g., one or more lens or parabolic antennas) that is configured to narrow the beamwidth of the radio signals being output by the phased array antenna by consolidating the radio signals output by the individual antenna elements into a composite radio signal having a narrower beam. In such an implementation, the antenna elements of the phased array antenna could either all have the same polarization, or could comprise different subsets of antenna elements having different polarizations (e.g., a first subset of antenna elements having a first polarization and a second subset of antenna elements having a second polarization). In some implementations, the example ptp radio's antenna unit 230 may also be constructed from metamaterials. The example ptp radio's antenna unit 230 may take various other forms as well.

Further yet, in at least some implementations (e.g., implementations where the antenna unit 230 takes the form of a phased array antenna, the example ptp radio's antenna unit 230 may also have the capability to electronically change the direction of the radio signals being transmitted and received by the antenna unit 230, which is commonly referred to as “beamsteering” or “beamforming.” An antenna unit having beamsteering capability may provide advantages over other types of antenna units that only have the capability to transmit and receive directional radio signals in a fixed direction and thus require physical repositioning in order to change the direction of the radio signals being transmitted and received by the antenna unit 230, but an antenna unit having beamsteering capability may also increase the complexity and cost of the antenna unit 230, so these factors should typically be balanced when deciding whether to employ an antenna unit having beamsteering capability.

The antenna unit 230 could take other forms and/or perform other functions as well.

The RF unit 232 of example ptp radio 212a may generally be configured to serve as the interface between centralized NPU 210 and the antenna unit 232. In this respect, the RF unit 232 may comprise one or more chains of components for performing functions such as digital-analog conversion (DAC), analog-to-digital conversion (ADC), amplification functions (e.g., power amplification, low-noise amplification, etc.), and/or filtering functions (e.g., bandpass filtering), among other possible functions carried out by the example ptp radio's RF unit 232 in order to translate the digital data received from centralized NPU 210 into radio signals for transmission by the antenna unit 230 and translate the radio signals received by the antenna unit 230 into digital data for processing by the centralized NPU 210. The RF unit 232 could take other forms and/or perform other functions as well.

The control unit 234 of example ptp radio 212a may generally comprise a hardware component (e.g., a microcontroller) programmed with executable program instructions for controlling the configuration and operation of the antenna unit 230 via the RF unit 232. For instance, the example ptp radio's control unit 234 may function to control the activation state of the RF unit 232, which may in turn control the activation state of the antenna unit 230, among other possible control functions carried out by the control unit 234. Further, the control functions carried out by the control unit 234 may be based at least in part on instructions that are received from centralized NPU 210 via the example ptp radio's wired communication interface 236. The control unit 234 could take other forms and/or perform other functions as well.

The wired communication interface 236 of example ptp radio 212a may facilitate wired communication between example ptp radio 212a and centralized NPU 210 over a wired link. In line with the discussion above, this wired communication interface 236 may take any of various forms, examples of which may include a coaxial interface, an Ethernet interface, a serial bus interface (e.g., PCI/PCIe, Firewire, USB, Thunderbolt, etc.), a glass optical fiber interface, or a plastic optical fiber interface, among other possibilities. In a scenario where the wired communication interface 236 takes the form of a fiber optic interface, example ptp radio 212a may also further include an optical-to-RF converter (e.g., a high-speed photo detector) for converting optical signals received from centralized NPU 210 into RF signals and an RF-to-optical converter (e.g., a plasmonic modulator) for converting RF signals that are to be sent to centralized NPU 210 into optical signals, each of which may be implemented as an integrated circuit (IC) or the like. Further, in some embodiments, the wired communication interface 236 could be replaced with a wireless communication interface, which may take the form of a chipset and antenna adapted to facilitate wireless communication with centralized NPU 210 according to any of various wireless protocols (e.g., Wi-Fi or point-to-point protocols). The wired communication interface 236 may take other forms and/or perform other functions as well.

Example ptp radio 212a may take various other forms as well, including but not limited to the possibility that example ptp radio 212a may include other components in addition to the illustrated components and/or that certain of the illustrated components could be omitted or replaced with a different type of component.

Returning again to FIG. 2B, in general, each ptmp radio included within the example wireless communication equipment 202 (e.g., ptp radio 212c) may include components that enable the ptmp radio to establish a bi-directional ptmp wireless link with one or more other ptmp radios and then wirelessly transmit and receive network traffic over the established bi-directional ptmp wireless link with one or more other wireless communication. These components may take any of various forms. One possible example of the components that may be included in an example ptmp radio, such as ptmp radio 212c, is depicted in FIG. 2E. As shown in FIG. 2E, example ptmp radio 212c may include at least (i) an antenna unit 240, (ii) an RF unit 242, (iii) a control unit 244, and (iv) a wired communication interface 246, among other possible components. Each of these components may take various forms.

The antenna unit 240 of example ptmp radio 212c may generally comprise a semi-directional antenna that is configured to transmit and receive semi-directional radio signals having a particular beamwidth, which may take any of various forms in accordance with the present disclosure. For instance, as one possibility, the beamwidth of the semi-directional radio signals that are transmitted and received by the example ptmp radio's antenna unit 240 may have a beamwidth in the horizontal direction that is within a range of 60 degrees to 180 degrees (e.g., 120 degrees), which defines a coverage area of example ptmp radio 212c that is sometimes referred to as a “sector.” As another possibility, the beamwidth of the semi-directional radio signals that are transmitted and received by the example ptmp radio's antenna unit 240 may have a beamwidth in the horizontal direction that is either less than 60 degrees (in which case the wireless communication node's ptmp coverage area would be smaller) or greater than 180 degrees (in which case the wireless communication node's ptmp coverage area would be larger).

Further, the example ptmp radio's antenna unit 240 may take any of various forms. For instance, in one implementation, the example ptmp radio's antenna unit 240 may take the form of a phased array antenna that comprises multiple individual antenna elements arranged in an array. In such an implementation, the antenna elements of the phased array antenna could either all have the same polarization, or could comprise different subsets of antenna elements having different polarizations (e.g., a first subset of antenna elements having a first polarization and a second subset of antenna elements having a second polarization). In some implementations, the example ptmp radio's antenna unit 240 may also be constructed from metamaterials. The example ptmp radio's antenna unit 240 may take various other forms as well.

Further yet, in at least some implementations, the example ptmp radio's antenna unit 240 may also have the capability to electronically change the direction of the radio signals being transmitted and received by the antenna unit 240, which as noted above is commonly referred to as “beamsteering” or “beamforming.”

The antenna unit 240 could take other forms and/or perform other functions as well.

The RF unit 242 of example ptmp radio 212c may generally be configured to serve as the interface between centralized NPU 210 and the antenna unit 242. In this respect, the RF unit 242 may comprise one or more chains of components for performing functions such as DAC, ADC, amplification functions (e.g., power amplification, low-noise amplification, etc.), and/or filtering functions (e.g., bandpass filtering), among other possible functions carried out by the example ptmp radio's RF unit 242 in order to translate the digital data received from centralized NPU 210 into radio signals for transmission by the antenna unit 240 and translate the radio signals received by the antenna unit 240 into digital data for processing by the centralized NPU 210. The RF unit 242 could take other forms and/or perform other functions as well.

The control unit 244 of example ptmp radio 212c may generally comprise a hardware component (e.g., a microcontroller) programmed with executable program instructions for controlling the configuration and operation of the antenna unit 240 via the RF unit 242. For instance, the example ptmp radio's control unit 244 may function to control the activation state of the RF unit 242, which may in turn control the activation state of the antenna unit 240, among other possible control functions carried out by the control unit 244. Further, the control functions carried out by the control unit 244 may be based at least in part on instructions that are received from centralized NPU 210 via the example ptp radio's wired communication interface 246. The control unit 244 could take other forms and/or perform other functions as well.

The wired communication interface 246 of example ptmp radio 212c may facilitate wired communication between example ptmp radio 212c and centralized NPU 210 over a wired link. In line with the discussion above, this wired communication interface 246 may take any of various forms, examples of which may include a coaxial interface, an Ethernet interface, a serial bus interface (e.g., PCI/PCIe, Firewire, USB, Thunderbolt, etc.), a glass optical fiber interface, or a plastic optical fiber interface, among other possibilities. In a scenario where the wired communication interface 246 takes the form of a fiber optic interface, example ptmp radio 212c may also further include an optical-to-RF converter (e.g., a high-speed photo detector) for converting optical signals received from centralized NPU 210 into RF signals and an RF-to-optical converter (e.g., a plasmonic modulator) for converting RF signals that are to be sent to centralized NPU 210 into optical signals, each of which may be implemented as an IC or the like. Further, in some embodiments, the wired communication interface 246 could be replaced with a wireless communication interface, which may take the form of a chipset and antenna adapted to facilitate wireless communication with centralized NPU 210 according to any of various wireless protocols (e.g., Wi-Fi or point-to-point protocols). The wired communication interface 246 may take various other forms as well.

Example ptmp radio 212c may include various other components and/or take various other forms as well.

Returning once more to FIG. 2B, in line with the discussion above, the wired links 213a-c between centralized NPU 210 and the wireless radios 212 may take any of various forms. For instance, as one possibility, the wired links 213a-c between centralized NPU 210 and the wireless radios 212 may each comprise a copper-based wired link, such as a coaxial cable, an Ethernet cable, or a serial bus cable, among other examples. As another possibility, the wired links 213a-c between centralized NPU 210 and the wireless radios 212 may each comprise a fiber-based wired link, such as a glass optical fiber cable or a plastic optical fiber cable, among other examples. In line with the discussion above, wired links 213a-c may also be designed for outdoor placement. The wired links 213a-c could take other forms as well.

Further, the wired links 213a-c between centralized NPU 210 and the wireless radios 212 may have any of various capacities, which may depend in part on the type of wired link. In a preferred implementation, the wired links 213a-c may each have a capacity that is at least 1 Gbps and is perhaps even higher (e.g., 2.5 Gbps, 5 Gbps, 10 Gbps, etc.). However, in other implementations, the wired links 213a-c may each have a capacity that is below 1 Gbps.

Further yet, the wired links 213a-c between centralized NPU 210 and the wireless radios 212 may have any of various lengths, which may depend in part on the type of wired link. As examples, the wired links 213a-c could have each a shorter length of less than 1 foot (e.g., 3-6 inches), an intermediate length ranging from 1 foot to a few meters (e.g., 3 meters), or a longer length of 5-10 meters or greater, among various other possibilities.

While FIG. 2B shows one illustrative example of the node's wireless mesh equipment 202, as discussed above, various other implementations of the node's wireless mesh equipment 202 are possible as well.

Now returning to FIG. 2A, the node's networking equipment 204 may generally comprise any one or more networking devices that facilitate network communications between the wireless mesh equipment 202 and other devices or systems, which may include end-user devices within the building and perhaps also wired communication nodes and/or the core network (if the node 200 is a first-tier node and core-network communications are routed through the networking equipment 204). These one or more networking devices may take any of various forms, examples of which may include one or more modems, routers, switches, or the like, among other possibilities.

In turn, the communication link 203 may comprise any suitable link for carrying network traffic between the wireless mesh equipment 202 and the networking equipment 203, examples of which may include a copper-based wired link (e.g., a coaxial cable, Ethernet cable, a serial bus cable, or the like), a fiber-based wired link (e.g., a glass optical fiber cable, a plastic optical fiber cable, or the like), or perhaps even a wireless link.

Further, the node's power equipment 206 may generally comprise any suitable equipment for supplying power to the node's wireless mesh equipment 202 and/or networking equipment 204, such as power and/or battery units. In turn, the power cable 205 may comprise any suitable cable for delivering power from the node's power equipment 206 to the node's wireless mesh equipment 202 and/or networking equipment 204.

### III. Software Tools for Facilitating Deployment of Mesh-Based Communication Systems

The task of deploying a mesh-based communication system, including but not limited to a mesh-based communication system having any of the example architectures described above, presents a number of challenges. For example, once a plan for the mesh-based communication system has been created, technicians must go on site and install the wireless communication nodes at the infrastructure sites. For each such wireless communication node, this involves installing all of the necessary equipment at the node's infrastructure site, including the node's wireless radios, each of which will need to be physically positioned and aligned in way that will ensure that the wireless radio is pointed in a desired direction and has sufficient LOS to other desired wireless radios in the mesh-based communication system. Additionally, along with physically installing all of the necessary equipment at the node's infrastructure site, a technician typically needs to configure certain pieces of equipment at the site, including but not limited to certain pieces of the wireless mesh equipment (e.g., an NPU), the networking equipment, and/or the power equipment. These tasks associated with deploying the wireless communication nodes of a mesh-based communication system can be time consuming and labor intensive.

Disclosed herein is new software technology comprising various software tools that help to facilitate the task of deploying a mesh-based communication system. In at least some implementations, the disclosed software tools may be incorporated into a software application designed according to a client-server model, where the software application comprises back-end software that runs on a back-end computing platform and front-end software that runs on end-user devices (e.g., in the form of a native application such as a mobile application, a web application, and/or a hybrid application, etc.) and can be used to access the back-end computing platform via a data network, such as the Internet. However, it should be understood that the disclosed software tools may also be incorporated into software applications that take other forms as well.

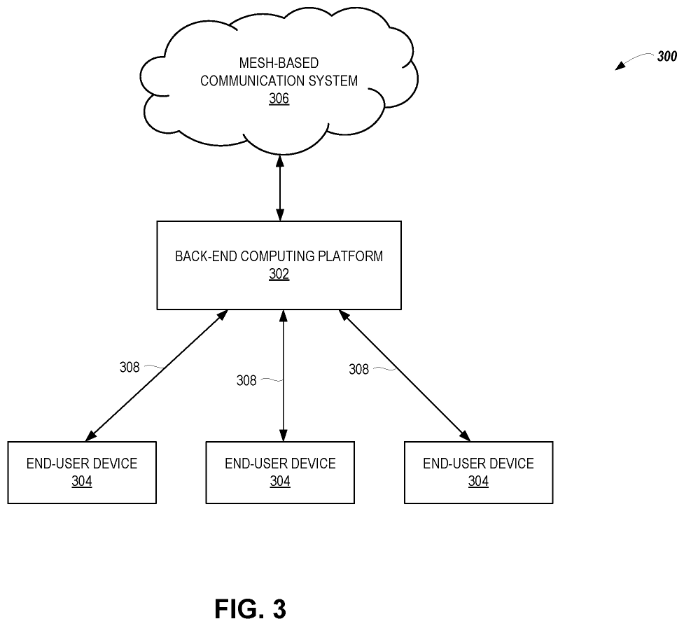

One example of a computing environment 300 in which the disclosed software tools may be run is illustrated in FIG. 3. As shown in FIG. 3, the computing environment 300 may include a back-end computing platform 302 that may be communicatively coupled via a respective communication path 308 to any of various end-user devices, depicted here, for the sake of discussion, as end-user devices 304. (While FIG. 1 shows an arrangement in which three end-user devices 304 are communicatively coupled to back-end computing platform 302, it should be understood that this is merely for purposes of illustration and that any number of end-user devices may communicate with the back-end computing platform 302.) Additionally, as shown in FIG. 3, the back-end computing platform 302 may also be communicatively coupled to any of various communication nodes within a mesh-based communication system 306.

Broadly speaking, the back-end computing platform 302 may comprise one or more computing systems that have been installed with back-end software (e.g., program code) for performing the back-end computing platform functions disclosed herein, including but not limited to the functions associated with providing a software application that incorporates one or more of the disclosed software tools. The one or more computing systems of back-end computing platform 302 may take various forms and be arranged in various manners.

In practice, the example back-end computing platform 302 may generally comprise some set of physical computing resources (e.g., processors, data storage, etc.) that are configured to host and run back-end software for a software application that incorporates one or more of the disclosed software tools. This set of physical computing resources may take any of various forms. As one possibility, the back-end computing platform 302 may comprise computing infrastructure of a public, private, and/or hybrid cloud (e.g., computing and/or storage clusters). In this respect, the organization that operates the back-end computing platform 302 may either supply its own cloud infrastructure or may obtain the cloud infrastructure from a third-party provider of “on demand” cloud computing resources, such as Amazon Web Services (AWS), Amazon Lambda, Google Cloud Platform (GCP), Microsoft Azure, or the like. As another possibility, the back-end computing platform 302 may comprise one or more servers that are owned and operated by the organization that operates the back-end computing platform 302. Other implementations of the back-end computing platform 302 are possible as well.

In turn, end-user devices 304 may each be any computing device that is capable of running front-end software for a software application that incorporates one or more of the disclosed software tools and communicating with the back-end computing platform 302. In this respect, end-user devices 304 may each include hardware components such as a processor, data storage, a communication interface, and user-interface components (or interfaces for connecting thereto), among other possible hardware components, as well as software components such as the front-end software for a software application that incorporates one or more of the disclosed software tools (e.g., a mobile application or a web application running in a web browser). As representative examples, end-user devices 304 may each take the form of a desktop computer, a laptop, a netbook, a tablet, a smartphone, and/or a personal digital assistant (PDA), among other possibilities.

As further depicted in FIG. 3, the back-end computing platform 302 may be configured to communicate with the end-user devices 304 and the communication nodes of the mesh-based communication system 306 over respective communication paths 308. Each of these communication paths 308 may generally comprise one or more data networks and/or data links, which may take any of various forms. For instance, each respective communication path with the back-end computing platform 302 may include any one or more of a Personal Area Network(s) (PAN(s)), a Local Area Network(s) (LAN(s)), a Wide Area Network(s) (WAN(s)) such as the Internet or a cellular network(s), a cloud network(s), and/or a point-to-point data link(s), among other possibilities. Further, the data network(s) and/or link(s) that make up each respective communication path may be wireless, wired, or some combination thereof, and may carry data according to any of various different communication protocols. Although not shown, the respective communication paths may also include one or more intermediate systems, examples of which may include a data aggregation system and host server, among other possibilities. Many other configurations are also possible.

It should be understood that computing environment 300 is one example of a computing environment in which embodiments described herein may be implemented. Numerous other computing environments are possible and contemplated herein. For instance, other network configurations may include additional components not pictured and/or more or fewer of the pictured components.

In accordance with the present disclosure, the software tools for facilitating deployment of a mesh-based communication system may include any one of (i) a first software tool for generating configuration data for a communication node, (ii) a second software tool for provisioning communication node with configuration data, (iii) a third software tool for guiding installation of a communication node, (iv) a fourth software tool for determining direction of ptmp radio, and (v) a fifth software tool for determining channel of wireless links. Within examples, these software tools may be embodied in the form of software executed by the back-end computing platform 302, software executed by an end-user device 304, or a combination thereof (e.g., client-server software).

Each of these software tools will now be described in further detail below.

A. Software Tool for Generating Configuration Data for a Communication Node

As discussed above, each wireless communication node in a mesh-based communication system with the example architecture disclosed herein may communicate with one or more other wireless communication nodes of the mesh-based communication system over one or more bi-directional ptp wireless links and/or one or more bi-directional ptmp wireless links. And as further discussed above, in order to facilitate such wireless links, each wireless communication node may include various equipment, such as the wireless mesh equipment 202, the networking equipment 204, and the power equipment 206 of FIG. 2.

When deploying such a mesh-based communication system, the specific equipment used at each node and the manner in which the equipment interfaces together, both at a particular node and across linked nodes, may be dictated by a set of configuration data for each node. As described in further detail below, the configuration data can take various forms.

In some implementations, the configuration data for a given wireless communication node may include data that identifies the quantity and types of equipment installed at the node, which may vary depending on the node's role in the mesh-based communication system. For instance, with respect to the wireless mesh equipment 202, the configuration data may identify a given number of wireless radios to be installed at a node, which may depend on the number of wireless links that are to be formed between the node and other nodes. Further, the configuration data may identify the types of radios to be installed at the node, which may depend on the types of wireless links (e.g., ptp versus ptmp wireless links) that are to be formed between the node and other nodes (which may in turn depend in part on the tier to which the node belongs). Still further, the configuration data may identify the networking equipment 204 to be installed at a node, which may vary based on whether the node is to act as an access point for any consumers located at the node and, if so, based on the desired bandwidth of the access point. Further yet, the configuration data may identify the type and quantity of power equipment 206 to be installed at a node, which may depend on the wireless mesh equipment 202 and networking equipment 204 installed at the node, as the power equipment 206 should be chosen to sufficiently power the wireless mesh equipment 202 and networking equipment 204.

Further, in at least some implementations, the configuration data for a given wireless communication node may provide information that an installer may use when interconnecting the equipment at the given wireless communication node during installation, such as equipment connection data identifying which pieces of equipment are to be interconnected together and perhaps also which interfaces (i.e., ports) to use when connecting certain pieces of equipment together. For instance, as discussed above, the wireless mesh equipment 202 of a wireless communication node may include a centralized NPU that connects to each of one or more wireless radios via a respective wired link that takes the form of a copper-based link (e.g., a coaxial or Ethernet cable) or a fiber-based link (e.g., a glass or plastic fiber optic cable). In such an implementation, the configuration data may include equipment connection data specifying which wireless radios are to be connected to the NPU, as well as the specific respective interfaces of the centralized NPU and the wireless radios that the installer should utilize to connect the centralized NPU to the wireless radios (e.g., NPU's eth1 port is to be connected to first wireless radio's eth0 port, NPU's eth2 port is to be connected to second wireless radio's eth0 port, etc.).

Further yet, in at least some implementations, the configuration data for a given wireless communication node may include data that the given wireless communication node may use to operate as part of a given wireless mesh network. Such configuration data may include network configuration data that the wireless mesh equipment 202 of a given node may use to communicate with the wireless mesh equipment 202 of one or more other nodes. The network configuration data may include data representing virtual LAN information (e.g., a VXLAN identifier) that the wireless mesh equipment 202 may use to form a virtual LAN that includes the various nodes of the mesh-based communication system, a DNS server address, a host name, a sub-mesh identifier such as a mesh area ID or a mesh domain, and NTP server information, among other information. The network configuration data may further include data specific to each wireless link at a given wireless communication node. For instance, the network configuration data may include data identifying each wireless radio included in the wireless mesh equipment 202 for providing a wireless link and, for each identified radio, a network identifier of its wireless link (e.g., an SSID), an encryption key of its wireless link, a channel of its wireless link, and perhaps also an identifier of the other one or more nodes with which the wireless link is to be established, among other possibilities.

When using some or all of the above-described configuration data to deploy a mesh-based communication system, the amount of configuration data for any given wireless communication node can become quite extensive, such that generating the configuration data for a node may be a complicated and cumbersome task, giving rise to inefficiencies. Further, as the complexity or scale of a mesh-based communication system increases, for instance by increasing the number of wireless communication nodes and/or the number of wireless links between the nodes, this problem can become even more acute.

To help address these issues, the software tools for facilitating deployment of a mesh-based communication system may include a software tool for automatically generating the configuration data for each wireless communication node in the mesh-based communication system.

In one implementation, the software tool for automatically generating the configuration data may be configured to receive, as input, data identifying each planned infrastructure site at which to install a wireless communication node. The data identifying each planned infrastructure site for installation of wireless communication node may take any of various forms and may include, for example, a distinct identifier of the infrastructure site, such as an alphanumeric identifier, as well as information identifying a location of the infrastructure site, such as latitude and longitude coordinates. The software tool may be further configured to receive, as input, data identifying the planned interconnections between the planned infrastructure sites (i.e., the manner in which the planned infrastructure sites are to be interconnected together via wireless links). The input data may identify the planned interconnections between the planned infrastructures sites, for instance, by specifying relationships between infrastructure site identifiers, such as by specifying a “connection list” for each respective infrastructure site that includes identifiers of each other infrastructure site that is to be interconnected with the respective infrastructure site and/or specifying pairwise combinations of infrastructure site identifiers, among other possible examples.

In this way, the input data may define a graph-like structure of planned infrastructure sites and planned infrastructure site interconnections, which may then be utilized by the software tool to define a deployment plan for the wireless communication nodes and wireless links. However, the input data may take other forms as well.

In addition to the input data, the software tool may also have access to certain template data that may be utilized to define a deployment plan for the wireless communication nodes and wireless links, such as template data defining certain network configuration parameters for the nodes to be deployed (e.g., VXLAN, DNS, sub-mesh id, etc.).

After receiving the input data, the software tool may perform one or more validation tests on the input data to verify that the data complies with various constraints. As an example, one constraint may limit the maximum number of wireless links allowed at a given wireless communication node. As such, the software tool may analyze the input data that identifies the planned infrastructure sites and corresponding planned interconnections to identify any planned infrastructure sites with a number of planned interconnections with other infrastructure sites that exceeds the constrained maximum number. If the software tool identifies any such infrastructure site, then the software tool may take action to remedy the constraint violation by removing one of the infrastructure site's planned interconnections and then adding and/or reconfiguring certain other planned interconnections between other infrastructure sites to compensate for the removal. Other constraints are possible as well, including, for instance, constraints on link length, capacity, and/or hop counts, among other possibilities.

Once the software tool has validated the input data that identifies the planned infrastructure sites and corresponding planned interconnections, the software tool may use the input data and any relevant template data to automatically generate a deployment plan for the wireless communication nodes and wireless links, which may include a respective set of configuration data for each wireless communication node to be deployed that includes some or all of the example configuration data discussed above. For instance, in line with the discussion above, the respective set of configuration data that is generated by the software tool for each wireless communication node may include configuration data identifying the quantity and types of equipment at each node, configuration data specifying how the equipment at the node is to be interconnected together, and/or configuration data for operating as part of a given wireless mesh network, among various other possibilities.

In order to generate a node's configuration data identifying the quantity and types of equipment to be deployed at the node, the software tool may identify the particular role of the node within the mesh-based communication system, including a number and type of wireless links to be established by the node and a type of service (if any) to be delivered by the node to end users, and may then generate configuration data identifying the particular type of wireless mesh equipment 202 (and perhaps also the particular type of networking equipment 204 and/or power equipment 206) required to support the node's role within the mesh-based communication system. In examples where the wireless links at a node include one or more ptp wireless links, the software tool may generate configuration data for the node that identifies a separate ptp radio for each ptp wireless link at the node. In examples where the wireless links at a node include one or more ptmp wireless links, the software tool may generate configuration data for the node that identifies a single ptmp radio for multiple wireless links at the node. In some examples, each node may only require a single NPU that interfaces with each of the node's wireless radios, such that the software tool may, by default, generate configuration data identifying a single NPU for each node. However, in other examples, the number of NPUs at each node may depend on the number of radios and/or wireless links at the node, such that the software tool may generate configuration data identifying a number of NPUs based on the number of radios and/or wireless links at the node. Further, the software tool may generate configuration data for the node that identifies the node's power equipment 206 based on the wireless mesh equipment 202 and networking equipment 204, as described above.

In order to generate a node's configuration data specifying how the equipment at the node is to be interconnected together, the software tool may, for each wireless communication node, (i) identify which pieces of equipment are to be installed at the node, (ii) determine a set of connections that are to be established between the identified pieces of equipment, each connection being associated with a pair of the identified equipment pieces (e.g., an NPU and a wireless radio), (iii) determine the available communication interfaces of the identified equipment pieces, and (iv) for each connection in the set of connections, assign to the connection a respective available communication interface on each piece of equipment of the pair of equipment pieces associated with the connection. For example, if a node is to include a centralized NPU, two wireless radios, and a networking device for delivering a mesh-based service to the node's infrastructure site, the software tool may generate configuration data specifying that (i) a first wired interface of the centralized NPU (e.g., an eth1 port) is to be connected to a given wired interface of the first wireless radio (e.g., an eth0 port), (ii) a second wired interface of the centralized NPU (e.g., an eth2 port) is to be connected to a given wired interface of the second wireless radio (e.g., an eth0 port), and (iii) a third wired interface of the centralized NPU (e.g., an eth4 port) is to be connected to a given wired interface of the networking device (e.g., an eth0 port). Many other examples are possible as well.

In order to generate a node's configuration data for operating as part of a given wireless mesh network, the software tool may automatically generate network configuration data, such as any of the network data described above as configuration data, for the node and associate the generated network data with an identifier of the node the data was generated for. Some of the generated network configuration data may be node-level data that applies to an entire node, and the software tool may associate such data with the node's NPU. Examples of such node-level network configuration data may include data representing virtual LAN information (e.g., a VXLAN identifier) that the NPU may use to form or join a virtual LAN with the various other nodes of the mesh-based communication system, a DNS server address, a host name, a sub-mesh identifier such as a mesh area ID or a mesh domain, and/or NTP server information, among other information. Other of the generated network configuration data may be link-level data that applies to a particular wireless link to be established by the node. Examples of such link-level network configuration data may include a wireless link network identifier (e.g., an SSID), a wireless link encryption key, a wireless link channel, and/or an identifier of the other one or more nodes with which the wireless link is to be established, among other information. The software tool may associate the link-level network data with an identifier of the wireless link the data was generated for and/or with an identifier of the wireless radio configured to provide the wireless link.

In line with the discussion above, the software tool may generate this node-level and link-level network configuration data based on a combination of (i) input data identifying the planned infrastructure sites and corresponding interconnections and (ii) template data that is accessible to the software tool. In this respect, the software tool may use the template data alone to generate the values for certain network configuration parameters, and may generate new values for certain other network configuration parameters, which may comprise randomly-generated values for certain parameters (e.g., by using random or pseudorandom character generation processes) and may comprise values that are determined based on an analysis of the input data for other parameters (e.g., channel identifiers may generated by analyzing the input data and determining channels that will minimize channel conflicts at a given infrastructure site). The software tool may generate a node's node-level and link-level network configuration data based on other data and/or in other manners as well.

Once the software tool has generated some or all of the above-described configuration data, the software tool may cause the configuration data to be presented to a user (e.g., an installer or other technician), such as by way of a user interface of the user's end-user device (which may also be referred to herein as a “client device” or “client station”).

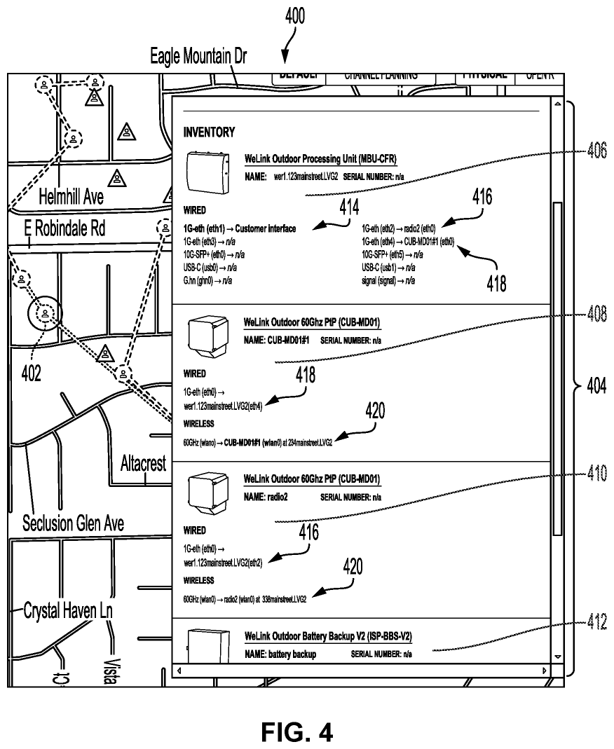

FIG. 4 depicts a display 400 for presenting configuration data identifying the quantity and types of equipment to be deployed at wireless communication nodes for a mesh-based communication system. As shown, the display 400 includes representations of multiple wireless communication nodes 402 to be deployed in the mesh-based communication system that are shown in a map-like interface. Upon receiving a user selection of one of the representations of nodes 402 (e.g., by way of a touch input or mouse click), the display 400 may be updated to present a representation of the quantity and types of equipment 404 to be deployed at the selected node. In the depicted example, the displayed representation of the quantity and types of equipment 404 indicates that the selected node includes (or should include) an NPU 406, two ptp radios including a first ptp radio 408 and a second ptp radio 410, and a battery unit 412 for powering the NPU and radios. However, this example is merely illustrative, and the displayed representation of the quantity and types of equipment 404 could indicate various other quantities and types of equipment in other examples.

As further shown, the display 400 presents configuration data specifying how the equipment 404 at the selected node is to be interconnected together. For instance, in the representation of the NPU 406, the display 400 presents indications of (i) a first connection 414 between an Ethernet port (eth1) of the NPU 406 and a customer interface device (e.g., an access point device, such as a modem or router), (ii) a second connection 416 between another Ethernet port (eth2) of the NPU 406 and an Ethernet port (eth0) of the second ptp radio 410, and (iii) a third connection 4018 between another Ethernet port (eth4) of the NPU 406 and an Ethernet port (eth0) of the first ptp radio 408. Likewise, in the representations of the first ptp radio 408 and the second ptp radio 410, the display 400 presents indications of the second connection 416 and the third connection 418. Further, in the representations of the first ptp radio 408 and the second ptp radio 410, the display 400 presents indications 420 of the ptp wireless links of the radios as well as the other nodes that the wireless links connect to. However, this example is merely illustrative, and the displayed representation of how the equipment 404 at the selected node is to be interconnected together could take various other forms.

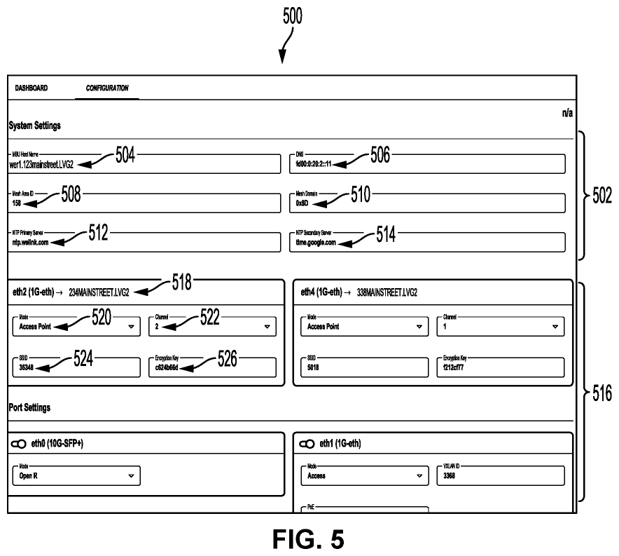

FIG. 5 depicts a display 500 for presenting certain network configuration data for a wireless communication node. As shown, the display 500 includes a representation of certain node-level network data 502, including representations of an NPU host name 504, a DNS server address 506, a mesh area ID 508, a mesh domain 510, a primary NTP server address 512, and a secondary NTP server address 514. As further shown, the display 500 further includes a representation of certain link-level network data 516, including representations of each wireless link 518 at the node and, for each wireless link 518, representations of the link's operating mode 520, channel 522, SSID 524, and encryption key 526. However, this example is merely illustrative, and the displayed representation of the network configuration data for a wireless communication node could take various other forms.

Within examples, the software tool for generating the configuration data for each wireless communication node in the mesh-based communication system may be embodied in the form of software executed by the back-end computing platform 302, software executed by an end-user device 304, or a combination thereof (e.g., client-server software).

B. Software Tool for Provisioning Communication Node with Configuration Data

As discussed above in connection with the software tool for generating configuration data, a wireless communication node's wireless mesh equipment 202 (e.g., the node's NPU) typically needs to be provisioned with network configuration data that enables the node to operate as part of a given wireless mesh network. One way to provision a wireless communication node's wireless mesh equipment 202 with this network configuration data is through manual entry by an installer that is on site at the node's infrastructure site and has connected an end-user device (e.g., a client device) to the wireless mesh equipment 202. For example, after connecting an end-user device to the wireless mesh equipment 202 via a wired or wireless link, the installer may be able to use the end-user device to access a graphical user interface (GUI) that enables the installer to manually input the network configuration data for the node, such as by inputting value for at least some of the network configuration parameters shown and described with reference to FIG. 5. However, this may be a cumbersome task that is subject to human error, which may give rise to a number of inefficiencies.

To help address these issues, disclosed herein a software tool for automatically provisioning a wireless communication node's equipment with configuration data (e.g., network configuration data that has been automatically generated by the first software tool described above). The software tool may provision the communication node with such data by transferring the configuration data to the communication node using an “out-of-band” communication path between the back-end platform and the node's equipment. As used herein, the term “out-of-band” communication path refers to a communication path with the back-end platform that does not traverse the wireless mesh network, but rather exists outside of the wireless mesh network. As such, when the software tool transfers the configuration data to the node's equipment, the configuration data is not sent over the wireless links between the wireless communication nodes of the mesh-based communication system. Rather, the configuration data is sent over an out-of-band communication path, which may comprise a local communication link between the node's equipment and a network-enabled device at the site (e.g., a wireless link with a hotspot device or an installer's end-user device) along with a communication path between the network-enabled device at the site and the back-end computing platform that traverses one or more data networks other than the wireless mesh network (e.g., a cellular network), among other possibilities.

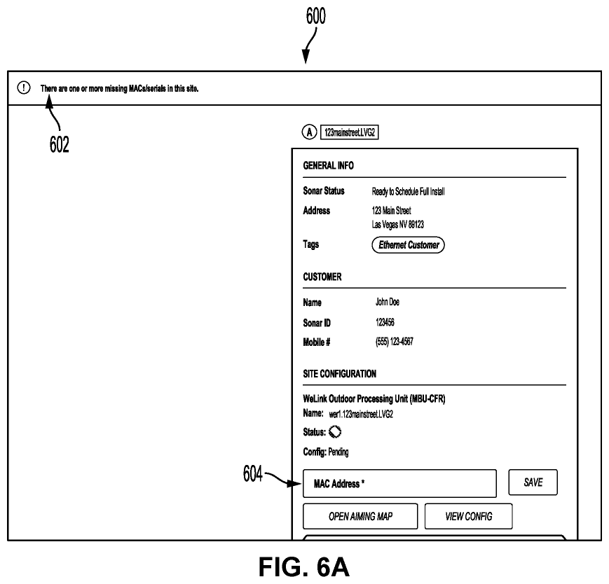

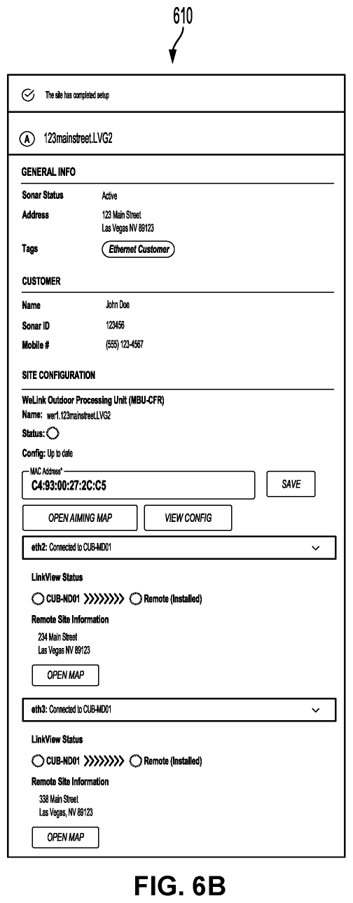

In one implementation, the software tool may include a front-end application running on an installer's end-user device that is connected to a node's NPU and back-end software running on a back-end computing platform. The front-end application running on the end-user device may enable an installer on site to assign a predetermined identifier, such as a MAC address, to the NPU, although in other implementations, the NPU could be pre-programmed with a predetermined identifier such as a MAC address. FIG. 6 shows one example of a GUI that may be provided by the front-end software of this software tool in order to enable assignment of a MAC address for an NPU at a node. As shown this GUI may include an input field 604 in which the installer may input a MAC address.

The NPU may then connect to the back-end computing platform via an out-of-band data communication path in order to obtain its configuration data. For instance, the NPU of the communication node may establish an out-of-band communication path with the back-end platform by connecting a network-enabled device at the site that is capable of connecting to the back-end computing platform via one or more data network, such as a hotspot device or the installer's end-user device. The NPU may then send its assigned MAC address or other identifier to the back-end platform over the out-of-band communication path. In response to receiving the MAC address, the back-end platform may determine a set of configuration data corresponding to the MAC address and send it back to the NPU over the out-of-band communication path. In line with the discussion above, this configuration data may include node-level network configuration data (e.g., VXLAN, DNS, sub-mesh identifier, etc.) and link-level network configuration data (e.g., SSID data, encryption data, and/or channel data) that the NPU may use to establish one or more wireless links connecting the node to one or more other nodes in the mesh-based communication system. The NPU may then update its configuration in accordance with this configuration data, which thereby enables the node to begin operating as part of the wireless mesh network such that it can exchange network traffic with other nodes within the wireless mesh network and perform other functions as part of the wireless mesh network.

After the NPU receives the configuration data from the back-end platform via the out-of-band communication path, an installer may also be able to use an end-user device to connect to the NPU and access a GUI that enables the installer to review and verify the network configuration data for the node. Such a GUI could take a similar form to the GUI shown in FIG. 5.

Within examples, the software tool for provisioning a wireless communication node's equipment with configuration data may be embodied in the form of software executed by the back-end computing platform 302, software executed by an end-user device 304, or a combination thereof (e.g., client-server software).

C. Software Tool for Guiding Installation of a Communication Node

Another disclosed software tool for facilitating deployment of a mesh-based communication system may take the form of a software tool for guiding the installation of a wireless communication node, which may comprise front-end software to be run on an end-user device of an installer during installation of equipment for a wireless communication node (e.g., a mobile app or a web application). While running on an installer's end-user device, this software tool may be configured to present an installer with guidance (e.g., step-by-step instructions) for installing the node's equipment via the end-user device's user interface.

The software tool may generate guidance and feedback for an installer during the process of installing the node's equipment, which may take various forms. For instance, the generated guidance and feedback may relate to assigning a MAC address, physically positioning the node's wireless radios, interconnecting the NPU, the wireless radios, and/or other equipment in the appropriate manner, confirming that the node's wireless links have sufficient signal strength, confirming that the wired connections between the equipment have sufficient throughput, and confirming that the node is considered online, among other possibilities.

The guidance and feedback that is generated by the software tool may be based at least in part on the node's configuration data. The configuration data may include any or all of the configuration data described above in connection with the software tool for generating configuration data. As such, the configuration data may include data identifying the quantity and types of equipment at the node, configuration data specifying how the equipment at the node is to be interconnected, and/or configuration data for operating as part of a given wireless mesh network.

Additionally, the guidance and feedback that is generated by the software tool may also be based on status and/or configuration information that is obtained from the node's NPU (or some other device at the node) during the installation process. In this respect, the software tool running on an installer's end-user device may be configured communicate with a back-end platform, which be capable of obtaining status and/or configuration information from the node's NPU (or some other device at the node) and reporting it to the end-user device, or the software tool running on an installer's end-user device may be configured to obtain status and/or configuration information from the node's NPU over a local connection between the end-user device and the NPU.

The software tool may cause the end-user device to present the guidance to the installer (e.g., via a GUI) so that the installer may follow the instructions to complete the installation of the equipment at the communication node. In some implementations, the software tool may cause the end-user device to present the guidance one step at a time, and may receive verification that the step has been completed before causing the end-user device to present the next step. The verification may take various forms. As one possibility, the verification may be made based on user input provided via the user interface of the end-user device that the step has been completed. As another example, the verification may be made based on interactions between the software tool running on the installer's end-user device and a back-end computing platform, the NPU, or some combination thereof. For instance, one example of guidance that the software tool may cause the end-user device to present to the installer is an instruction to connect a particular wired interface of the NPU to a particular wired interface of a wireless radio. The software tool running on the installer's end-user device may verify whether or not the connection has been made based either on (i) receiving a communication from the back-end computing platform, which may determine whether or not the NPU has been properly connected with the wireless radio by obtaining configuration information from the NPU and then notifying the end-user device whether or not the connection has been made, or (ii) locally querying the NPU to determine whether it has been properly connected with the wireless radio. If the software tool running on the installer's end-user device is unable to verify the connection, then the software tool may cause the end-user device to display an error message or some other prompt that the connection still needs to be made, and the next step of the guidance will not be presented to the installer. On the other hand, if the software tool running on the installer's end-user device verifies the connection, then the software tool may cause the end-user device to display the next installation step.

Along similar lines, by way of communicating with the back-end platform, the NPU, or a combination thereof, the software tool may be capable of determining whether a MAC address has been properly assigned to the NPU, whether the node's wireless links have sufficient signal strength, whether the wired connections between the equipment have sufficient throughput, whether the node is considered online, among other possibilities—which may then facilitate the software tool's functionality of walking an installer through the installation process via the guidance and feedback presented to the installer via the end-user device.

FIG. 6A depicts an example display 600 that an end-user device running the software tool for guiding installation of a communication node may present to an installer. As shown in FIG. 6A, the display 600 includes an error message 602 that the software tool is missing a MAC address for the node's NPU as well as an input field 604 in which the installer may input the missing MAC address. In such an example, the software tool may have determined that the MAC address is missing based on a communication with a back-end computing platform, which may have been unable to verify that the node's NPU had been properly assigned a MAC address.

Further, FIG. 6B depicts another example display 600 that an end-user device running the software tool for guiding installation of a communication node may present to an installer. As shown in FIG. 6B, the display 610 includes an indication that the site has completed setup.

Within examples, the software tool for guiding the installation of a wireless communication node may be embodied in the form of software executed by the back-end computing platform 302, software executed by an end-user device 304, or a combination thereof (e.g., client-server software).

D. Software Tool for Determining Direction of PTMP Radio

Yet another challenge with deploying a mesh-based communication system in accordance with the example architecture disclosed herein is determining a physical direction in which a ptmp radio at a wireless communication node is to face—sometimes also referred to as an azimuth or compass direction—so that the ptmp radio is able to provide a desirable coverage area for downstream nodes (e.g., fourth-tier nodes). To help address this challenge, also disclosed herein is a software tool for determining an azimuth of a ptmp radio to be installed at a given communication node.

In order to facilitate determining an azimuthal direction of a ptmp radio to be installed at a given communication node, the software tool may be configured to receive, as input, data identifying the wireless communication nodes that are to be deployed, including location data for the infrastructure sites at which are nodes are to be installed (e.g., latitude and longitude coordinates) and perhaps other data for the nodes such as type of node (e.g., third-tier, fourth-tier, etc.), as well as data identifying the wireless links that are to be established between the wireless communication nodes. In this respect, the input data may at a minimum include data for nodes that are to be deployed in the near term, but may also additionally include data for nodes that are expected to be deployed in the future—such as location data for the expected infrastructure sites of the future nodes (e.g., residential or commercial buildings associated with expected future customers of a service delivered via the mesh-based communication system) and perhaps also data identifying the wireless links that are expected to be established with these future nodes. Further, in some implementations, the input data may include data for all types of wireless links and all types of nodes—in which case the data for each wireless link may include an indication of the type of wireless link (e.g., ptp vs. ptmp)—while in other implementations, the input data may be pre-filtered to include data only for ptmp wireless links and corresponding nodes that are to establish such ptmp wireless links. In this way, the input data for this software tool may be similar in nature to the input data for the software tool that generates the node configuration data, although in practice, the input data could differ in some ways (e.g., the input data for this software tool may include additional details regarding the types of nodes and wireless links to be deployed that may not be included within the input data for the software tool discussed above).

In addition to foregoing data, the input data may also optionally include LOS profile data for the wireless communication nodes to be deployed, where each such LOS profile provides an indication of the directions in which a given node has a sufficient LOS path for establishing wireless links. Such LOS profile data can be obtained in various ways, including by using software that performs a viewshed analysis. However, the LOS data may be obtained using other techniques as well.

The input data for this software tool may take various other forms as well.

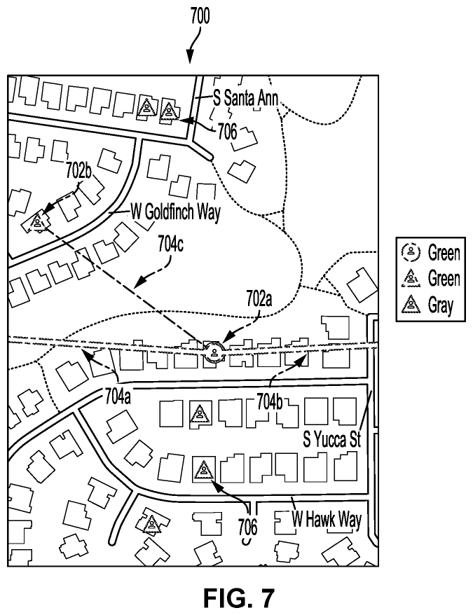

FIG. 7 depicts a graphical representation 700 of input data identifying wireless communication nodes 702 that are to be deployed in a mesh-based communication system as well as data identifying wireless links 704 that are to be established between such nodes 702. As shown, the graphical representation 700 differentiates between ptp and ptmp wireless links by depicting ptp wireless links 704a and 704b as thick lines and ptmp wireless links 704c as thin lines. Further, as shown in FIG. 7, the graphical representation 700 of the input data may also identify nodes 706 that are expected to be deployed in the future, which are shown in a different color (gray instead of green) than nodes 702a and 702b that are planned to be deployed in the near term. Further yet, as shown in FIG. 7, the graphical representation 700 of the input data may also indicate a tier of each of the nodes 702 and 706, specifically, node 702a is represented as a circle to indicate that it is in one tier (e.g., a third tier), while node 702b and the future nodes 706 represented as triangles to indicate that they are in a different tier (e.g., a fourth tier).

Based on the input data, the software tool may identify one or more nodes that are to include a ptmp radio for establishing a ptmp wireless link with one or more other downstream nodes. For each such node that is identified, the software tool may then utilize the location data for the identified node's infrastructure site and the location data for infrastructure sites of downstream nodes with which the identified node is to establish a ptmp wireless link (perhaps including infrastructure sites of nodes that, while not planned for near term deployment, are expected to be deployed in the future) in order to intelligently determine an azimuthal direction for a ptmp radio to be installed at the identified node—or perhaps a respective azimuthal direction for each of two or more ptmp radios to be installed. Additionally, the software tool could use also data to make this determination as well, including LOS profile data if available. The software tool may determine this azimuthal direction information in various ways.

In some implementations, the software tool may determine an azimuthal direction of a node's ptmp radio in a manner that prioritizes providing a ptmp coverage area for downstream nodes that are to be deployed in the near term (e.g., nodes associated with “existing” customers that have already subscribed to the service being provided by the mesh-based communication system), such as node 702b. For instance, the software tool may determine whether there is an azimuthal direction that allows for a single ptmp radio at an identified node to provide a ptmp coverage area for all downstream nodes associated with existing customers that are to be connected to the identified node via a ptmp wireless link. Such a determination may be based on the beamwidth of the ptmp radio. For instance, if the ptmp radio can provide a 120° beamwidth coverage area, then the software tool may determine whether there is an azimuthal direction that would enable the ptmp radio's the 120° coverage area to provide sufficient coverage for all downstream nodes associated with existing customers that are to be connected to the identified node via a ptmp wireless link. If the software tool determines that no such azimuthal direction is possible, then the software tool may determine that an additional ptmp radio may be required at the node in order to provide sufficient coverage for all downstream nodes associated with existing customers that are to be connected to the identified node via a ptmp wireless link. The software tool may then determine whether there are two azimuthal directions of 120° coverage areas originating from the identified node (e.g., one for each ptmp radio) that would enable the ptmp radio's two 120° coverage areas to collectively provide sufficient coverage for all downstream nodes associated with existing customers that are to be connected to the identified node via a ptmp wireless link. Likewise, if the software tool determines that two ptmp are similarly deficient to provide sufficient coverage for all downstream nodes associated with existing customers that are to be connected to the identified node via a ptmp wireless link, then the software tool may determine that a third ptmp radio may be required at the node in order to provide sufficient coverage for all downstream nodes associated with existing customers that are to be connected to the identified node via a ptmp wireless link, which would allow for full 360° coverage in examples where each ptmp radio can cover a 120° area. Other examples are possible as well.

In the above implementation, such a determination may be carried out prior to initial installation of the ptmp radio at an identified node. However, it should be understood such a determination could also be carried out again after initial installation of the ptmp radio, such as when new downstream nodes associated with existing customers are added to the network, and if a new azimuthal direction is determined for the ptmp radio after initial installation, that new azimuthal direction may be used to reposition the ptmp radio.

In other implementations, the software tool may determine an azimuthal direction of a node's ptmp radio in a manner that not only prioritizes providing a ptmp coverage area for downstream nodes that are to be deployed in the near term (e.g., nodes associated with existing customers), but also maximizes ptmp coverage for nodes that are expected to be deployed in the future (e.g., nodes associated with potential future customers), such as nodes 706. In order to determine a specific azimuthal direction for the ptmp radio in such a scenario, the software tool may determine the azimuthal direction to be a direction that (i) provides sufficient ptmp coverage for node 702b and also (ii) maximizes the ptmp coverage for the downstream nodes 706 that are expected to be deployed in the future. The software tool may determine such a direction in various ways. As one example, the software tool may perform a parametric sweep of the radio's coverage area across the entire range of directions that would result in a coverage area that overlaps with node 702b in fixed angular increments (e.g., in 0.1° increments). For each angular increment, the software tool may determine how many potential future downstream nodes 706 are included within the ptmp coverage area. The software tool may then select an azimuthal direction from the parametric sweep that provided ptmp coverage for the largest number of potential future downstream nodes 706. With respect to FIG. 7, for example, the software tool may determine that a ptmp radio at node 702a should be directed at an azimuthal direction of 298.5°, which would provide a coverage area that both (i) provides sufficient ptmp coverage for node 702b and (ii) covers the largest number of potential future downstream nodes 706.

In the above implementation, such a determination may be carried out prior to initial installation of the ptmp radio at an identified node. However, it should be understood such a determination could also be carried out again after initial installation of the ptmp radio, such as when new downstream nodes associated with existing customers are added to the network and/or when additional information becomes available regarding potential future downstream nodes, and if a new azimuthal direction is determined for the ptmp radio after initial installation, that new azimuthal direction may be used to reposition the ptmp radio. For instance, referring to FIG. 7, if the ptmp radio node 702a was initially installed to provide ptmp coverage to node 702b without reference to other nodes and additional information later becomes available regarding potential future downstream nodes 706, the ptmp radio at node 702a could be repositioned in order to maximize the coverage area for the potential future downstream nodes 706, as long as that repositioning keeps node 702b within the ptmp coverage area.

In still other implementations, the software tool may determine an azimuthal direction of a ptmp radio based only on nodes that are expected to be deployed in the future (e.g., nodes associated with potential future customers), such as nodes 706. For instance, if there are at least a threshold number of potential future downstream nodes 706 that could be covered by a ptmp radio's coverage area, then the software tool may determine to include a ptmp radio at the node in a direction that maximizes the ptmp coverage for potential future downstream nodes 706, such as by performing a parametric sweep as described above. With respect to FIG. 7, for example, the software tool may determine to include a ptmp radio directed at an azimuthal direction of 146.2°, which would provide a ptmp coverage area for at least a threshold number of potential future downstream nodes 706, even though there are no downstream nodes of existing customers that would fall within the coverage area.

While carrying out the foregoing functionality, the software tool may also optionally take LOS profile data for the identified node into account to ensure that a determined azimuthal direction of the ptmp radios will have sufficient a LOS path to other downstream nodes.

In addition to determining the azimuthal directions of the ptmp radios, the software tool may be further configured to provide a display to an installer to aid the installer in choosing an appropriate installation location for the ptmp radios and orienting the ptmp radios in the determined azimuthal directions.

In order to provide such functionality, the software tool may additionally determine a specific location at the identified node's infrastructure site where a ptmp radio is to be physically installed, which may be referred to herein as the “installation location” for the ptmp radio. The software tool may make this determination in various manners.

As one possibility, the software tool may make this determination based on elevation data for the identified node's infrastructure site, which may indicate the elevation of different possible installation locations (e.g., different points on a roof). In this respect, the software tool may select whichever possible installation location has the highest elevation (e.g., the highest point on the roof).

As another possibility, the software tool may make this determination based on LOS profile data for the identified node, which as noted above may provide an indication of the directions in which a given node has a sufficient LOS path for establishing wireless links with other nodes (e.g., by indicating the geographic locations and/or other infrastructure sites that can be reached from the identified node). In this respect, the software tool may have access to LOS profiles for multiple possible installation locations at the identified node's infrastructure site (e.g., multiple points on a roof), where each LOS profile indicates the LOS path information for a different installation location, and the software tool may use these LOS profiles as a basis for determination the installation location at the identified node's infrastructure site (e.g., by selecting the location having the broadest extent of LOS coverage and/or the broadest extent of LOS coverage in a particular sector).

The software tool may determine the installation location of the identified node's ptmp radio in other manners as well, including but not limited to the possibility that the software tool may obtain an installation location that was previously determined by another software tool and/or defined based on user input. Further, it is possible that the software tool may determine more than one installation location for the ptmp radio, if there are multiple locations at the infrastructure site that can serve as an installation location.

After determining of an azimuthal direction and installation location(s) for an ptmp radio to be installed at an identified node, the software tool may then cause an installer's end-user device to display a visual representation of the determined azimuthal direction and installation location(s) for the ptmp radio to be installed at the identified node, which may take any of various forms, including a visual representation of such information that is overlaid onto an overhead view of the infrastructure site.

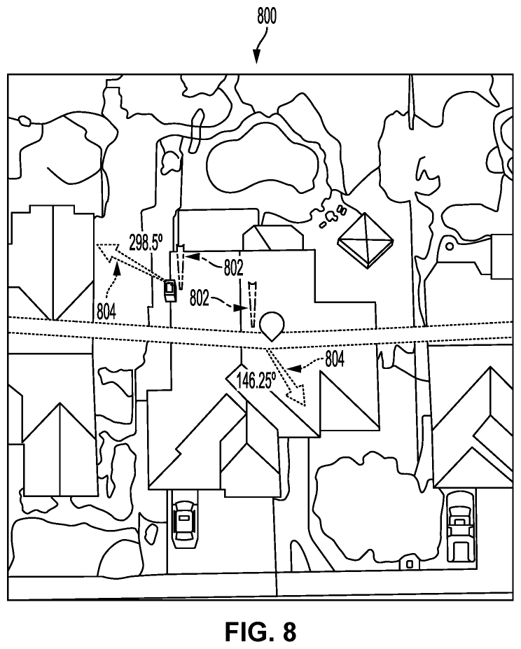

FIG. 8 depicts one example display 800 that an installer's end-user device running this software tool may present to the installer. As shown, the display 800 includes an overhead view of the node's infrastructure site, which may be obtained from a database of satellite images. The software tool may overlay on the image of the infrastructure site: (i) a respective marker 802 corresponding to a respective installation location determined for each ptmp radio to be installed, and (ii a respective directional indicator 804 corresponding to a respective azimuthal direction determined for each ptmp radio to be installed.

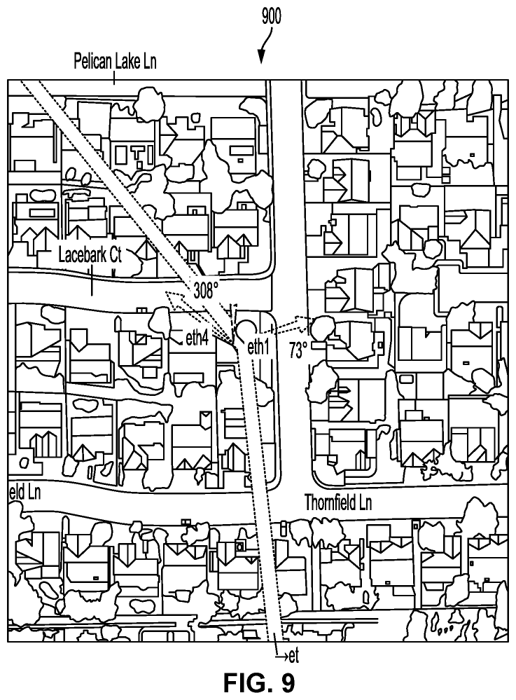

FIG. 9 depicts another example display 900 that an installer's end-user device running this software tool may present to the installer. The display 900 is similar to the display 800, except the overhead view of the node's infrastructure site is zoomed out to show how the determined azimuthal directions are oriented relative to a number of surrounding landmarks, which the installer may find useful when attempting to orient the ptmp radios in the appropriate direction.

Within examples, the software tool for determining an azimuth of a ptmp radio to be installed at a given communication node may be embodied in the form of software executed by the back-end computing platform 302, software executed by an end-user device 304, or a combination thereof (e.g., client-server software).

E. Software Tool for Determining Channel of Wireless Links

As discussed above, the software tool for automatically generating the configuration data for each wireless communication node in the mesh-based communication system may generate configuration data that identifies a channel for each of the wireless links to be established by each wireless communication node. In practice, each wireless link may be capable of operating on a limited number of channels depending on the frequency band of the wireless link and the width of the channels. Given the limited number of channels to select from, it is likely that different wireless links may have to operate on the same channel. However, when communications on different wireless links are physically close to one another, the communications can destructively interfere with one another if the wireless links are operating on the same channel.

To help address these issues, also disclosed herein is a software tool for determining the channel for each wireless link to be established by each wireless communication node in the mesh-based communication system (or at least each of at least a subset of the wireless communication nodes) in an intelligent manner that reduces interference between wireless links in the mesh-based communication system.

In order to facilitate determining the channel for each wireless link to be established by a given wireless communication node, the software tool may be configured to receive, as input, data identifying the wireless communication nodes that are to be deployed, including location data for the infrastructure sites at which are nodes are to be installed (e.g., latitude and longitude coordinates), as well as data identifying the wireless links that are to be established between the wireless communication nodes (perhaps including indications of the types of links). In this respect, the input data for this software tool may be similar in nature to the input data for the software tool that generates the node configuration data and/or the software tool that determines the azimuthal direction of a ptmp radio, although in practice, the input data could differ in some ways from these other sets of input data.

Based on the input data, the software tool may intelligently determine and assign a particular channel for each of the wireless links (or each of at least a subset of wireless links) in a manner that reduces channel-based interference between the wireless links. The software tool may determine and assign the channel information in various ways.

In one implementation, the software tool may begin by randomly or pseudorandomly determining and assigning respective channel information for each of the wireless links, and may then evaluate and revise the assigned channel information to reduce the channel-based interference. For example, after randomly or pseudorandomly assigning the channel information, the software tool may evaluate the assigned channel information to determine whether any wireless links within a threshold distance of one another have been assigned to the same channel. The software tool may make such a determination based on the physical locations of the nodes and/or the wireless links indicated by the input data. The threshold distance may be predefined by the software tool and/or defined based on user input and, in some implementations, may depend on characteristics of the wireless links. For instance, wireless links that have an extremely-narrow beamwidth may operate closer to one another without interfering than wireless links that have a narrow or broader beamwidth. As such, when determining whether two wireless links on the same channel are within the threshold distance of one another, the software tool may apply a smaller threshold distance when the two wireless links have a narrower beamwidth and a larger threshold distance when the two wireless links have a broader beamwidth.

If the software tool determines that two wireless links on the same channel are within the threshold distance of one another, the software tool may reassign the channel information for one or both of the wireless links. As one example, the software tool may determine, for at least one of the links, a distance between the link and the nearest other link for each available channel. The software tool may then reassign the channel of the link to be the available channel that is farthest from the link.

In another implementation, instead of randomly or pseudorandomly determining and assigning respective channel information to each of the wireless links and then evaluating and revising the assigned channel information, the software tool may incrementally assign the channel information in a way that reduces channel-based interference. For example, the software tool may assign a first channel to a first wireless link. Then, the software tool may identify any wireless links within the threshold distance of the first wireless link and assign different channels to those wireless links. The software tool may repeat this process for each wireless link until all channel assignments are made. Then, if necessary, the software tool may perform a similar evaluation and reassignment as described above.

In yet another implementation, the software tool may employ a channel assignment scheme that takes into account parameters including but not limited to a wireless link's channel frequency, channel size, radio transmit power, rain zone of the area, 3 dB beamwidth (˜field of view) of the antennas, antenna polarization, antenna azimuth, and/or type of radio link (ptp or ptmp), among other possibilities. Such a channel assignment scheme may take various forms.

The software tool may attempt to minimize the interference between nodes that originate ptmp links in the wireless mesh network (which may be referred to as ptmp-originating nodes or perhaps “ptmp access points”). As noted above, such ptmp-originating nodes may have a field of view that is within a range of 60 degrees to 180 degrees (e.g., 120 degrees), which enable them to get interference from a neighboring between ptmp-originating nodes operating on the same frequency if the two nodes directly face each other or partially face each other. Typically, if the absolute difference in azimuth of the two ptmp-originating nodes are less than their field of view (e.g., 120 degrees) then they may not interfere with each other's transmission as the interferer node's transmission will be outside the field of view of the impacted node's receiver.

As such, a first step of the channel assignment scheme may involve assigning different frequencies (perhaps along with other parameters as listed above) to adjacent or neighboring ptmp-originating nodes that can potentially cause interference with each other by ensuring that no two adjacent ptmp-originating nodes get assigned to the same channel frequencies. If such assignment is not possible due to lack of unique channels or high density of nodes in a geographical area, then two adjacent ptmp-originating nodes that are outside the field of view of each other as explained above can be assigned the same channel. Moreover, for ptmp-originating nodes where coverage area partially overlaps each other, the same channel can be assigned if the partial overlap area is less than a certain threshold value, one example of which may be 10%.

A next step of the channel assignment scheme may involve attempting to minimize the interference at a node that connects to a ptmp-originating node (which may be referred to as a ptmp-client node). Such a ptmp-client node may be impacted with interference if the node has two or more ptmp-originating nodes operating at the same channel frequency within its field of view and within a certain threshold distance. In such a scenario, the ptmp-client node can be configured to connect with a different ptmp-originating node operating at a different channel frequency than the two interfering ptmp-originating nodes.

Such a channel assignment scheme may take other forms as well.

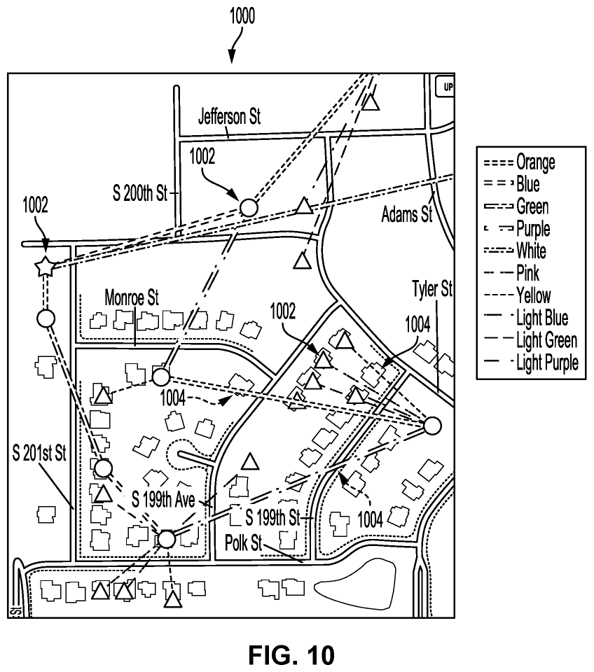

FIG. 10 depicts a graphical representation 1000 of data showing wireless communication nodes 1002 in the mesh-based communication system as well as wireless links 1004 between the nodes 1002 after the software tool has intelligently determined the channels of the wireless links to reduce the channel-based interference between the links. As shown, the nodes 1002 are depicted as different shapes (e.g., stars, circles, or triangles) based on the type or tier (e.g., second-, third-, or fourth-tier) of the node 1002, and the wireless links 1004 are depicted as colored lines with each color corresponding to a particular channel.

Within examples, the software tool for determining the channel for each wireless link to be established by each wireless communication node in the mesh-based communication system (or at least each of at least a subset of the wireless communication nodes) in an intelligent manner that reduces interference between wireless links in the mesh-based communication system may be embodied in the form of software executed by the back-end computing platform 302, software executed by an end-user device 304, or a combination thereof (e.g., client-server software).

### IV. Example Computing Platform

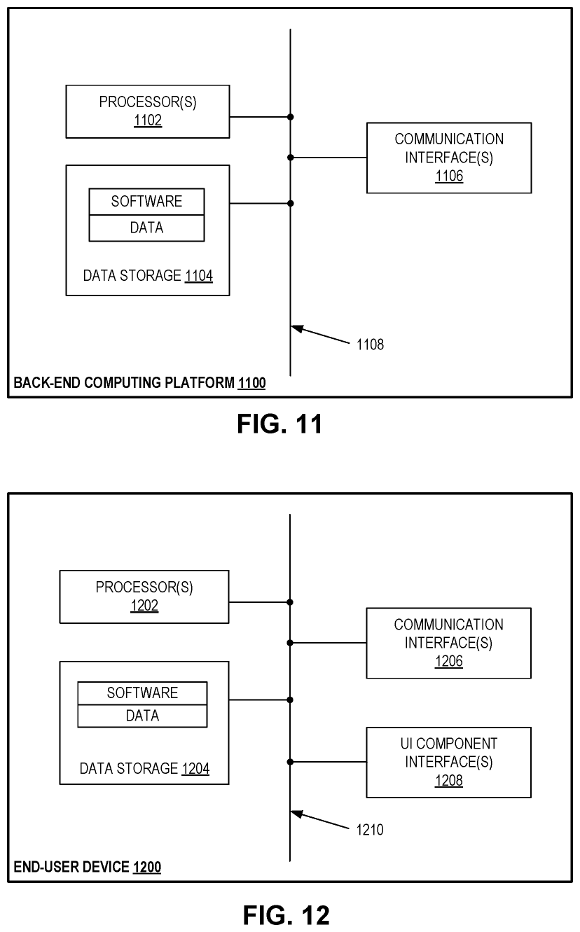

Turning now to FIG. 11, a simplified block diagram is provided to illustrate some structural components that may be included in an example back-end computing platform 1100 that may be configured to carry out any of the various functions disclosed herein, including but not limited to any of the functions described above with reference to FIG. 3 or FIG. 4-10. At a high level, the example back-end computing platform 1100 may generally comprise any one or more computing systems that collectively include one or more processors 1102, data storage 1104, and one or more communication interfaces 1106, all of which may be communicatively linked by a communication link 1108 that may take the form of a system bus, a communication network such as a public, private, or hybrid cloud, or some other connection mechanism. Each of these components may take various forms.

The one or more processors 1102 may each comprise one or more processing components, such as general-purpose processors (e.g., a single- or a multi-core central processing unit (CPU)), special-purpose processors (e.g., a graphics processing unit (GPU), application-specific integrated circuit, or digital-signal processor), programmable logic devices (e.g., a field programmable gate array), controllers (e.g., microcontrollers), and/or any other processor components now known or later developed. In line with the discussion above, it should also be understood that the one or more processors 1102 could comprise processing components that are distributed across a plurality of physical computing systems connected via a network.

In turn, the data storage 1104 may comprise one or more non-transitory computer-readable storage mediums that are collectively configured to store (i) program instructions that are executable by one or more processors 1102 such that back-end computing platform 1100 is configured to perform any of the various functions disclosed herein, and (ii) data that may be received, derived, or otherwise stored, for example, in one or more databases, file systems, repositories, or the like, by back-end computing platform 1100, in connection with performing any of the various functions disclosed herein. In this respect, the one or more non-transitory computer-readable storage mediums of the data storage 1104 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 1104 may comprise computer-readable storage mediums that are distributed across a plurality of physical computing systems connected via a network.

The one or more communication interfaces 1106 may be configured to facilitate wireless and/or wired communication with other systems and/or devices, such as end-user devices (e.g., one or more end-user devices 1200 of FIG. 12). Additionally, in an implementation where the back-end computing platform 1100 comprises a plurality of physical computing systems connected via a network, the one or more communication interfaces 1106 may be configured to facilitate wireless and/or wired communication between these physical computing systems (e.g., between computing and storage clusters in a cloud network). As such, the one or more communication interfaces 1106 may each take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

Although not shown, the back-end computing platform 1100 may additionally include or have an interface for connecting to one or more user-interface components that facilitate user interaction with the back-end computing platform 1100, such as a keyboard, a mouse, a trackpad, a display screen, a touch-sensitive interface, a stylus, a virtual-reality headset, and/or one or more speaker components, among other possibilities.

It should be understood that the back-end computing platform 1100 is one example of a computing platform that may be used with the embodiments described herein. Numerous other arrangements are possible and contemplated herein. For instance, in other embodiments, the back-end computing platform 700 may include additional components not pictured and/or more or fewer of the pictured components.

### V. Example End-User Device

Turning next to FIG. 12, a simplified block diagram is provided to illustrate some structural components that may be included in an example end-user device 1200 that is configured to communicate with the back-end computing platform 1100, such as an end-user device used by an administration of a business organization or an agent of the business organization during any of the processes described above with reference to FIGS. 3 and 4-10. As shown in FIG. 12, the end-user device 1200 may include one or more processors 1202, data storage 1204, one or more communication interfaces 1206, and one or more user-interface components 1208, all of which may be communicatively linked by a communication link 1210 that may take the form of a system bus or some other connection mechanism. Each of these components may take various forms.

The one or more processors 1202 may comprise one or more processing components, such as general-purpose processors (e.g., a single- or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed.

In turn, the data storage 1204 may comprise one or more non-transitory computer-readable storage mediums that are collectively configured to store (i) program instructions that are executable by the processor(s) 1202 such that the end-user device 1200 is configured to perform certain functions related to interacting with and accessing services provided by a computing platform, and (ii) data that may be received, derived, or otherwise stored, for example, in one or more databases, file systems, repositories, or the like, by the end-user device 1200, related to interacting with and accessing services provided by a computing platform. In this respect, the one or more non-transitory computer-readable storage mediums of the data storage 1204 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. The data storage 804 may take other forms and/or store data in other manners as well.

The one or more communication interfaces 1206 may be configured to facilitate wireless and/or wired communication with other computing devices. The communication interface(s) 1206 may take any of various forms, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

The end-user device 1200 may additionally include or have interfaces for one or more user-interface components 1208 that facilitate user interaction with the end-user device 1200, such as a keyboard, a mouse, a trackpad, a display screen, a touch-sensitive interface, a stylus, a virtual-reality headset, and/or one or more speaker components, among other possibilities.

It should be understood that the end-user device 1200 is one example of an end-user device that may be used to interact with an example computing platform as described herein. Numerous other arrangements are possible and contemplated herein. For instance, in other embodiments, the end-user device 1200 may include additional components not pictured and/or more or fewer of the pictured components.

### CONCLUSION

Example embodiments of the disclosed innovations have been described above. At noted above, it should be understood that the figures are provided for the purpose of illustration and description only and that various components (e.g., modules) illustrated in the figures above can be added, removed, and/or rearranged into different configurations, or utilized as a basis for modifying and/or designing other configurations for carrying out the example operations disclosed herein. In this respect, those skilled in the art will understand that changes and modifications may be made to the embodiments described above without departing from the true scope and spirit of the present invention, which will be defined by the claims.

Further, to the extent that examples described herein involve operations performed or initiated by actors, such as humans, operators, users or other entities, this is for purposes of example and explanation only. Claims should not be construed as requiring action by such actors unless explicitly recited in claim language.

What is claimed is:

1. A computing platform comprising:
a network interface;
at least one processor;
a non-transitory computer-readable medium; and
program instructions stored on the non-transitory computer-readable medium that are executable by the at least one processor such that the computing platform is configured to:
receive input data identifying (i) planned infrastructure sites at which to install wireless communication nodes for a wireless mesh network, wherein each planned infrastructure site is associated with a respective wireless communication node to be installed at the planned infrastructure site and (ii) planned interconnections between the planned infrastructure sites that specify a manner in which the wireless communication nodes of the planned infrastructure sites are to be interconnected together via wireless links;
receive template data for defining a deployment plan for wireless communication nodes and wireless communication links; and
based at least on the input data and the template data, generate a deployment plan for the planned infrastructure sites that comprises, for each planned infrastructure site, a respective set of configuration data for the respective wireless communication node to be installed at the planned infrastructure site.

2. The computing platform of claim 1, wherein the respective set of configuration data for the respective wireless communication node to be installed at the planned infrastructure site comprises one or more of the following: (i) configuration data identifying quantity and type of equipment at the respective wireless communication node, (ii) configuration data specifying how equipment at the respective wireless communication node is to be interconnected together, and (iii) configuration data for operating as part of a given wireless mesh network.

3. The computing platform of claim 2, wherein the respective set of configuration data for the respective wireless communication node to be installed at the planned infrastructure site comprises configuration data for operating as part of a given wireless mesh network, and wherein the configuration data for operating as part of the given wireless mesh network comprises (i) node-level data for the respective wireless communication node that applies to the entire respective wireless communication node and (ii) link-level data that applies to a given wireless link to be established by the respective wireless communication node.

4. The computing platform of claim 1, further comprising program instructions stored on the non-transitory computer-readable medium that are executable by the at least one processor such that the computing platform is configured to:
prior to generating the deployment plan for the planned infrastructure sites, perform one or more validation tests to verify that the input data complies with one or more constraints for the wireless mesh network.

5. The computing platform of claim 4, wherein the one or more constraints for the wireless mesh network comprises a maximum number of wireless links allowed at a given wireless communication node, wherein performing one or more validation tests to verify that the input data complies with one or more constraints for the wireless mesh network comprises identifying one or more infrastructure sites that exceed the constrained maximum number, and wherein the computing platform further comprises program instructions stored on the non-transitory computer-readable medium that are executable by the at least one processor such that the computing platform is configured to:
for each of the identified one or more infrastructure sites, remove one or more of the infrastructure site's planned interconnections; and
add or reconfigure one or more other planned interconnections between other infrastructure sites to compensate for the removed infrastructure sites' planned interconnections.

6. The computing platform of claim 1, wherein the program instructions that are executable by the at least one processor such that the computing platform is configured to, based at least on the input data and the template data, generate a deployment plan for the planned infrastructure sites that comprises, for each planned infrastructure site, a respective set of configuration data for the respective wireless communication node to be installed at the planned infrastructure site comprise program instructions that are executable by the at least one processor such that the computing platform is configured to:
for each planned infrastructure site, (i) identify a role within the mesh-based communication system of the respective wireless communication node to be installed at the planned infrastructure site and (ii) generate configuration data identifying at least one of (a) a type of wireless mesh equipment for supporting the identified role, (b) a type of networking equipment for supporting the identified role, and (c) a type of power equipment for supporting the identified role.

7. The computing platform of claim 1, wherein the program instructions that are executable by the at least one processor such that the computing platform is configured to, based at least on the input data and the template data, generate a deployment plan for the planned infrastructure sites that comprises, for each planned infrastructure site, a respective set of configuration data for the respective wireless communication node to be installed at the planned infrastructure site comprise program instructions that are executable by the at least one processor such that the computing platform is configured to:
for each planned infrastructure site, (i) identify pieces of equipment of the respective wireless communication node to be installed at the planned infrastructure site, (ii) determine a set of connections that are to be established between the identified pieces of equipment, wherein each connection of the set of connections is associated with a pair of the identified equipment pieces, (iii) determine available communication interfaces of the identified pieces of equipment, and (iv) for each connection in the set of connections, assign to the connection a respective available communication interface on each piece of equipment of the pair of equipment pieces associated with the connection.

8. The computing platform of claim 1, further comprising program instructions stored on the non-transitory computer-readable medium that are executable by the at least one processor such that the computing platform is configured to:
after generating the deployment plan, transmit, to a client station, a communication related to one or more of the planned infrastructure sites and thereby cause an indication of at least some of the configuration data from the respective sets of configuration data for the one or more planned infrastructure site to be presented at a user interface of the client station.

9. The computing platform of claim 1, further comprising program instructions stored on the non-transitory computer-readable medium that are executable by the at least one processor such that the computing platform is configured to:
receive, via an out-of-band communication path, an identifier associated with one of the respective wireless communication nodes;
determine a set of configuration data from among the sets of configuration data that corresponds to the identifier; and
send, via the out-of-band communication path, the determined set of configuration data to the respective wireless communication node.

10. The computing platform of claim 9, wherein the out-of-band communication path comprises (i) a local communication link between equipment of the respective wireless communication node and a network-enabled device at the planned infrastructure site associated with the respective wireless communication node and (ii) a communication link between the network-enabled device and the computing platform.

11. The computing platform of claim 1, further comprising program instructions stored on the non-transitory computer-readable medium that are executable by the at least one processor such that the computing platform is configured to:
for a given respective wireless communication node, causing, based at least in part on the respective set of configuration data for the given respective wireless communication node to be installed at the planned infrastructure site, a client station associated with an installer to present guidance for installing the given respective wireless communication node at the planned infrastructure site.

12. The computing platform of claim 1, further comprising program instructions stored on the non-transitory computer-readable medium that are executable by the at least one processor such that the computing platform is configured to:
receive second input data identifying (i) wireless communication nodes that are to be deployed, (ii) location data for infrastructure sites at which the wireless communication nodes are to be installed, and (iii) wireless links that are to be established between the wireless communication nodes;
based on the second input data, identify one or more wireless communication nodes that are to include a point-to-multipoint (ptmp) radio for establishing a ptmp wireless link with one or more other downstream wireless communication nodes; and
for each of the identified one or more wireless communication nodes, utilize the location data for the identified node's infrastructure site and the location data for infrastructure sites of downstream nodes with which the identified node is to establish a ptmp wireless link in order to determine an azimuthal direction for a ptmp radio to be installed at the identified node.

13. The computing platform of claim 1, further comprising program instructions stored on the non-transitory computer-readable medium that are executable by the at least one processor such that the computing platform is configured to:
receive second input data identifying (i) wireless communication nodes that are to be deployed, (ii) location data for infrastructure sites at which the wireless communication nodes are to be installed, and (iii) wireless links that are to be established between the wireless communication nodes; and
based on the second input data, for at least a subset of the wireless links, determine and assign a particular channel for each wireless link of the subset of wireless links so as to reduce channel-based interference between the wireless links of the subset of wireless links.

14. A method carried out by a computing platform, the method comprising:
receiving input data identifying (i) planned infrastructure sites at which to install wireless communication nodes for a wireless mesh network, wherein each planned infrastructure site is associated with a respective wireless communication node to be installed at the planned infrastructure site and (ii) planned interconnections between the planned infrastructure sites that specify a manner in which the wireless communication nodes of the planned infrastructure sites are to be interconnected together via wireless links;
receiving template data for defining a deployment plan for wireless communication nodes and wireless communication links; and
based at least on the input data and the template data, generating a deployment plan for the planned infrastructure sites that comprises, for each planned infrastructure site, a respective set of configuration data for the respective wireless communication node to be installed at the planned infrastructure site.

15. The method of claim 14, further comprising:
prior to generating the deployment plan for the planned infrastructure sites, performing one or more validation tests to verify that the input data complies with one or more constraints for the wireless mesh network.

16. The method of claim 15, wherein the one or more constraints for the wireless mesh network comprises a maximum number of wireless links allowed at a given wireless communication node, wherein performing one or more validation tests to verify that the input data complies with one or more constraints for the wireless mesh network comprises identifying one or more infrastructure sites that exceed the constrained maximum number, and wherein the method further comprises:
for each of the identified one or more infrastructure sites, removing one or more of the infrastructure site's planned interconnections; and
adding or reconfiguring one or more other planned interconnections between other infrastructure sites to compensate for the removed infrastructure sites' planned interconnections.

17. The method of claim 14, wherein, based at least on the input data and the template data, generating a deployment plan for the planned infrastructure sites that comprises, for each planned infrastructure site, a respective set of configuration data for the respective wireless communication node to be installed at the planned infrastructure site comprises:
for each planned infrastructure site, (i) identifying a role within the mesh-based communication system of the respective wireless communication node to be installed at the planned infrastructure site and (ii) generating configuration data identifying at least one of (a) a type of wireless mesh equipment for supporting the identified role, (b) a type of networking equipment for supporting the identified role, and (c) a type of power equipment for supporting the identified role.

18. The method of claim 14, wherein, based at least on the input data and the template data, generating a deployment plan for the planned infrastructure sites that comprises, for each planned infrastructure site, a respective set of configuration data for the respective wireless communication node to be installed at the planned infrastructure site comprises:
for each planned infrastructure site, (i) identifying pieces of equipment of the respective wireless communication node to be installed at the planned infrastructure site, (ii) determining a set of connections that are to be established between the identified pieces of equipment, wherein each connection of the set of connections is associated with a pair of the identified equipment pieces, (iii) determining available communication interfaces of the identified pieces of equipment, and (iv) for each connection in the set of connections, assigning to the connection a respective available communication interface on each piece of equipment of the pair of equipment pieces associated with the connection.

19. The method of claim 14, further comprising:
receiving, via an out-of-band communication path, an identifier associated with one of the respective wireless communication nodes;
determining a set of configuration data from among the sets of configuration data that corresponds to the identifier; and
sending, via the out-of-band communication path, the determined set of configuration data to the respective wireless communication node.

20. A non-transitory computer-readable medium, wherein the non-transitory computer-readable medium is provisioned with program instructions that, when executed by at least one processor, cause a computing platform to:
receive input data identifying (i) planned infrastructure sites at which to install wireless communication nodes for a wireless mesh network, wherein each planned infrastructure site is associated with a respective wireless communication node to be installed at the planned infrastructure site and (ii) planned interconnections between the planned infrastructure sites that specify a manner in which the wireless communication nodes of the planned infrastructure sites are to be interconnected together via wireless links;
receive template data for defining a deployment plan for wireless communication nodes and wireless communication links; and
based at least on the input data and the template data, generate a deployment plan for the planned infrastructure sites that comprises, for each planned infrastructure site, a respective set of configuration data for the respective wireless communication node to be installed at the planned infrastructure site.
